(19) United States
(12) Patent Application Publication
(10) Pub. No.: US 2025/0345757 A1
(43) Pub. Date: Nov. 13, 2025

(54) CO2 PURIFICATION WITH ELECTROACTIVE POLYMERS

(71) Applicant: Twelve Benefit Corporation, Berkeley, CA (US)

(72) Inventors: Ziyang Huo, Moraga, CA (US); Chengtian Shen, Irvine, CA (US); Yueshen Wu, Irvine, CA (US); Lihui Wang, Alameda, CA (US)

(73) Assignee: Twelve Benefit Corporation, Berkeley, CA (US)

(21) Appl. No.: 19/219,252

(22) Filed: May 27, 2025

Related U.S. Application Data
(63) Continuation of application No. 18/324,929, filed on May 26, 2023, now abandoned.
(60) Provisional application No. 63/366,901, filed on Jun. 23, 2022.

(51) Int. Cl. B01D 71/72; B01D 53/32; C08G 61/10

(52) U.S. Cl. CPC B01D 71/72; B01D 53/326; C08G 61/10; B01D 2256/22

(57) ABSTRACT

Electroactive polymers having redox activatable moieties pendant from a polymeric backbone, and compositions of the electroactive polymers are disclosed. The polymers are useful in membranes for electrochemical cells, and for facilitation of electrolytically-based carbon dioxide enrichment.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in their entireties and for all purposes.

### FIELD

The present disclosure relates to electroactive polymers, compositions of electroactive polymers, and uses of the polymers in electrochemical cells for carbon dioxide enrichment.

### BACKGROUND

Greenhouse gas emissions such as CO₂ can have a potential impact on the climatic environment if left uncontrolled. The conversion of fossil fuels such as coal or natural gas into energy is a major source of greenhouse gas emissions. There is an urgent need for a system for more effective management of these carbon dioxide emissions. Improvements in carbon capture technology whereby a stream of low-quality and/or low-concentration gas is converted to a stream of higher quality and/or higher concentration of gas are of great interest to manufacturing and energy industries where the gases are generated.

Temperature swing processes have been explored for CO₂ capture utilizing aqueous amine absorbents. However, the methods employed are energy-intensive; so there is a continuing need for better solutions to the ongoing issues with carbon dioxide emissions.

Electrochemical separation methods such as electro-swing adsorption are a possible approach to management of gases such as carbon dioxide. Yet there remains a continuing need to refine the electrochemical systems utilized, particularly with regard to improvements in the polymeric electrolyte membranes for electrochemical cells.

### SUMMARY

The present disclosure relates to electroactive polymers, compositions of electroactive polymers, and uses of the polymers in electrochemical cells for carbon dioxide enrichment.

The electroactive polymers described herein have polymeric backbones and electroactive functional groups which may be substituted directly onto the polymer backbone, and/or append therefrom via linking groups. Thus formed, the polymers are redox-activated, and able to capture CO₂ upon application of a reducing potential. The CO₂ can then be released from the electroactive polymer when polarity is reversed. Electrochemical cell systems employing the electroactive polymers in a polymer electrolyte membrane assembly have the capacity to conveniently convert a dilute or exhaust stream of low concentration carbon dioxide into a more desirable higher CO₂ concentration stream.

Accordingly, in a first aspect, the present disclosure encompasses a polymer formed from moieties of the formula

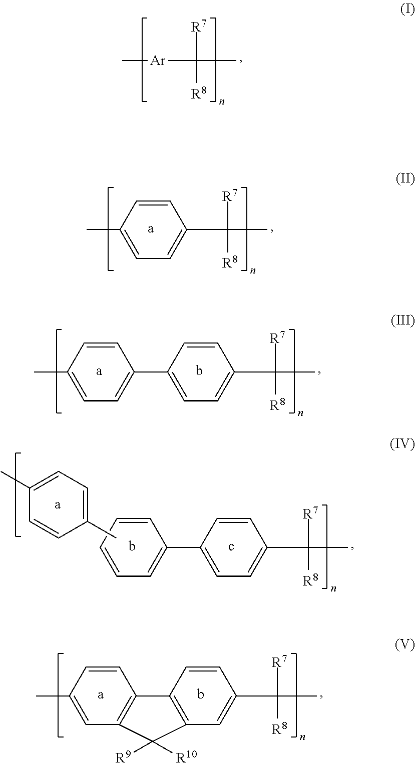

or combinations thereof, wherein
each of R⁷ and R⁸ is, independently, an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene,
wherein at least one of R⁷ or R⁸ is an electron-withdrawing moiety;
each of R⁹ and R¹⁰ is, independently, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R⁹ and R¹⁰ can be taken together to form an optionally substituted cyclic group; Ar is an optionally substituted aromatic or optionally substituted arylene;
n is an integer of 1 or more; each of ring a, ring b, and ring c can be independently optionally substituted; and one or more of R⁷, R⁸, R⁹, and R¹⁰ is optionally an electroactive moiety, wherein the electroactive moiety is a moiety that reversibly reacts with a Lewis acidic gas.

In some embodiments the electron-withdrawing moiety is an optionally substituted haloalkyl, cyano, phosphate, sulfate, sulfonic acid, sulfonyl, difluoroboranyl, borono, or thiocyanato group.

In some embodiments one or more of R₇, R₈, R₉, and R₁₀ includes an electroactive moiety.

In some embodiments R⁷ is the electron-withdrawing moiety and R⁸ includes the electroactive moiety.

In some embodiments the electroactive moiety includes -L^{A}-X, -L^{A}-(L^{A′}-X)_{L2} or -L^{A}-L^{A′}-L^{A″}-X wherein each L^{A}, L^{A′}, and L^{A″} is independently a linking moiety; X is an electroactive group; and L2 is an integer of 1, 2 or 3.

In some embodiments the electroactive group includes optionally substituted 1,4-benzoquinonyl, optionally substituted 1,2-benzoquinonyl, optionally substituted naphthoquinonyl, optionally substituted anthraquinonyl, optionally substituted phenanthrenequinonyl, optionally substituted benzanthraquinonyl, optionally substituted dibenzoanthraquinonyl, and optionally substituted 4,5,9,10-pyrenetetronyl.

In some embodiments the electroactive group is an optionally substituted pyridyl or an optionally substituted thiophenyl group.

In some embodiments each linking moiety is independently an —O—, —SO₂—, —NH—, —C(O)—, —C(O)O—, —OC(O)—, optionally substituted alkyl, optionally substituted alkylene, optionally substituted haloalkylene, optionally substituted hydroxyalkylene, optionally substituted alkyleneoxy, optionally substituted heteroalkylene, optionally substituted arylene, optionally substituted aryleneoxy, or optionally substituted heterocyclyldiyl group.

In some embodiments each of Ar and rings a-c are independently optionally substituted with one or more substituents including alkyl, alkoxy, alkoxyalkyl, amino, aminoalkyl, aryl, arylalkylene, aryloyl, aryloxy, arylalkoxy, cyano, hydroxy, hydroxyalkyl, nitro, halo, or haloalkyl groups.

In a second aspect, the present disclosure encompasses a polymer formed from moieties of the formula

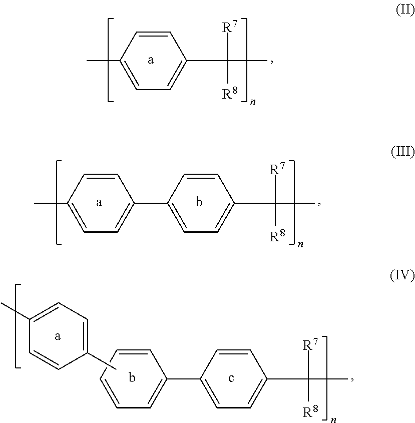

or combinations thereof, wherein
each of R⁷ and R⁸ is independently an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, wherein at least one of R⁷ or R⁸ is an electron-withdrawing moiety; n is an integer of 1 or more; each of ring a, ring b, and ring c can be independently optionally substituted; and one or more of R⁷ and R⁸ optionally is an electroactive moiety, wherein the electroactive moiety is a moiety that reversibly reacts with a Lewis acidic gas.

In a third aspect, the present disclosure encompasses a polymer formed from moieties of the formula

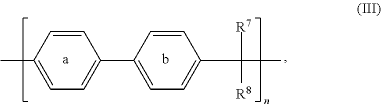

wherein rings a and b are each optionally substituted aryl, R⁷ is trifluoromethyl, and R⁸ is -L^{A}-L^{A′}-L^{A″}-X, wherein L^{A} is optionally substituted alkyl, L^{A′} is —C(O)O—, L^{A″} is optionally substituted alkyl, X is optionally substituted 1,4-benzoquinonyl, and n is an integer of four or more.

In a fourth aspect, the present disclosure encompasses a polymeric composition including at least one polymer formed from moieties of the formula

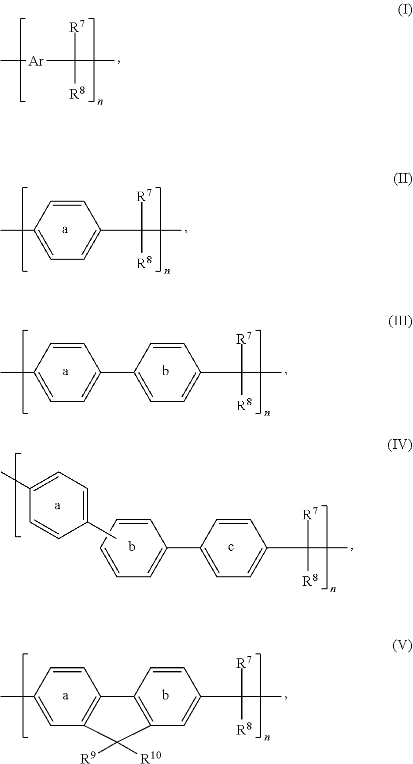

or combinations thereof, wherein
each of R⁷ and R⁸ is independently an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, wherein at least one of R⁷ or R⁸ is an electron-withdrawing moiety; each of R⁹ and R¹⁰ is, independently, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R⁹ and R¹⁰ can be taken together to form an optionally substituted cyclic group; Ar is an optionally substituted aromatic or optionally substituted arylene; n is an integer of 1 or more; each of ring a, ring b, and ring c can be independently optionally substituted; and one or more of R⁷, R⁸, R⁹, and R¹⁰ is optionally an electroactive moiety, wherein the electroactive moiety is a moiety that reversibly reacts with a Lewis acidic gas.

In some embodiments the polymeric composition is in the form of a film, or a membrane.

In some embodiments, the polymeric composition is a cross-linked polymer matrix.

In a fifth aspect, the present disclosure encompasses a polymeric composition including at least one first polymer and at least one second polymer, wherein:
(i) the first polymer is of moieties of the formula

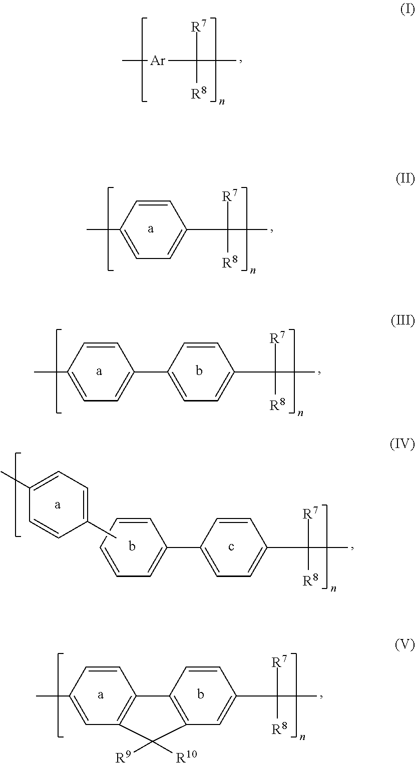

or combinations thereof, wherein
each of R⁷ and R⁸ is independently an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, wherein at least one of R⁷ or R⁸ comprises an electron-withdrawing moiety; each of R⁹ and R¹⁰ is, independently, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R⁹ and R¹⁰ can be taken together to form an optionally substituted cyclic group; Ar is an optionally substituted aromatic or optionally substituted arylene; n is an integer of 1 or more; each of ring a, ring b, and ring c can be independently optionally substituted; and one or more of R⁷, R⁸, R⁹, and R¹⁰ is optionally an electroactive moiety, wherein the electroactive moiety is a moiety that reversibly reacts with a Lewis acidic gas; and
   (ii) the second polymer is of moieties of the formula

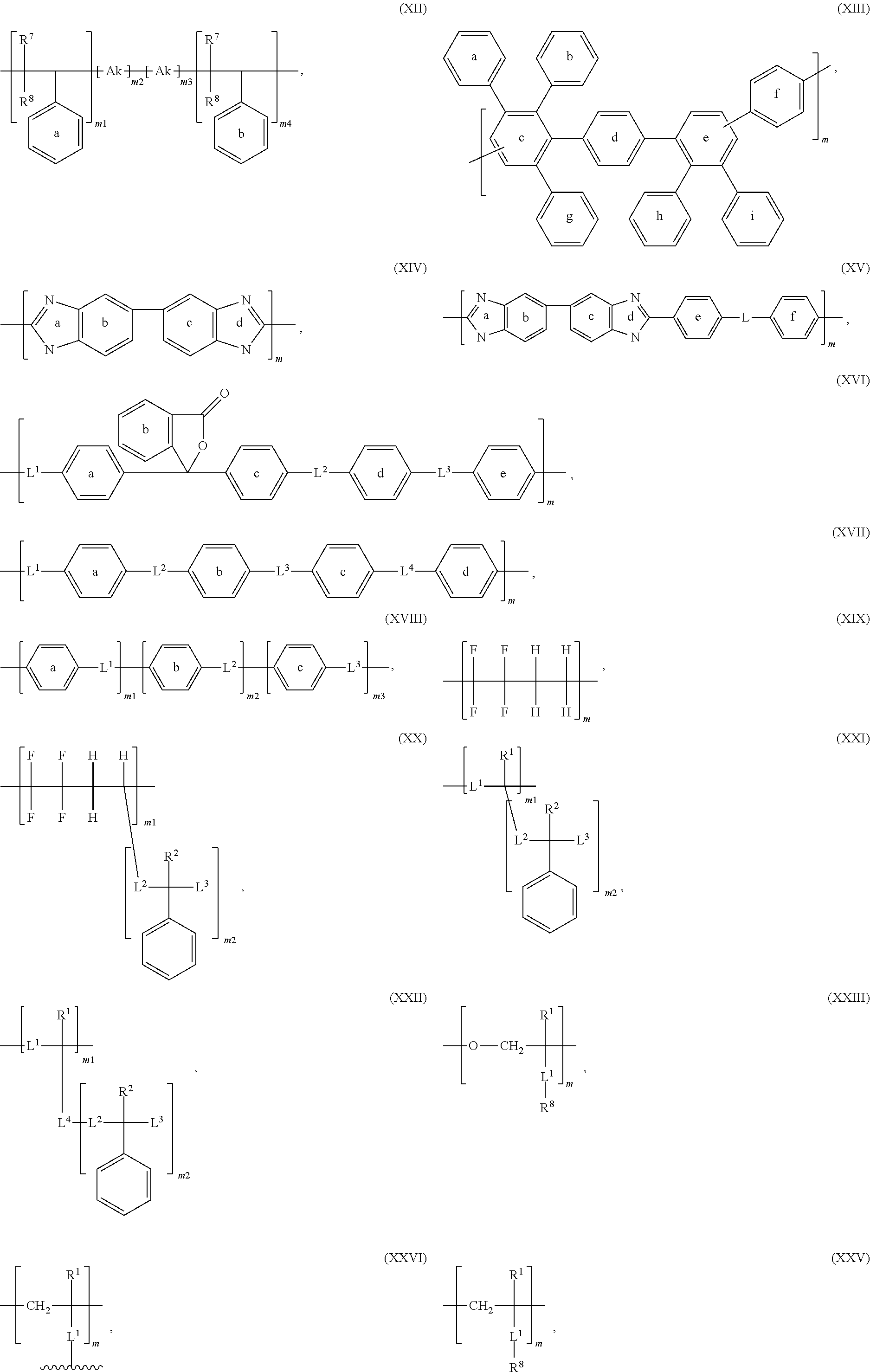

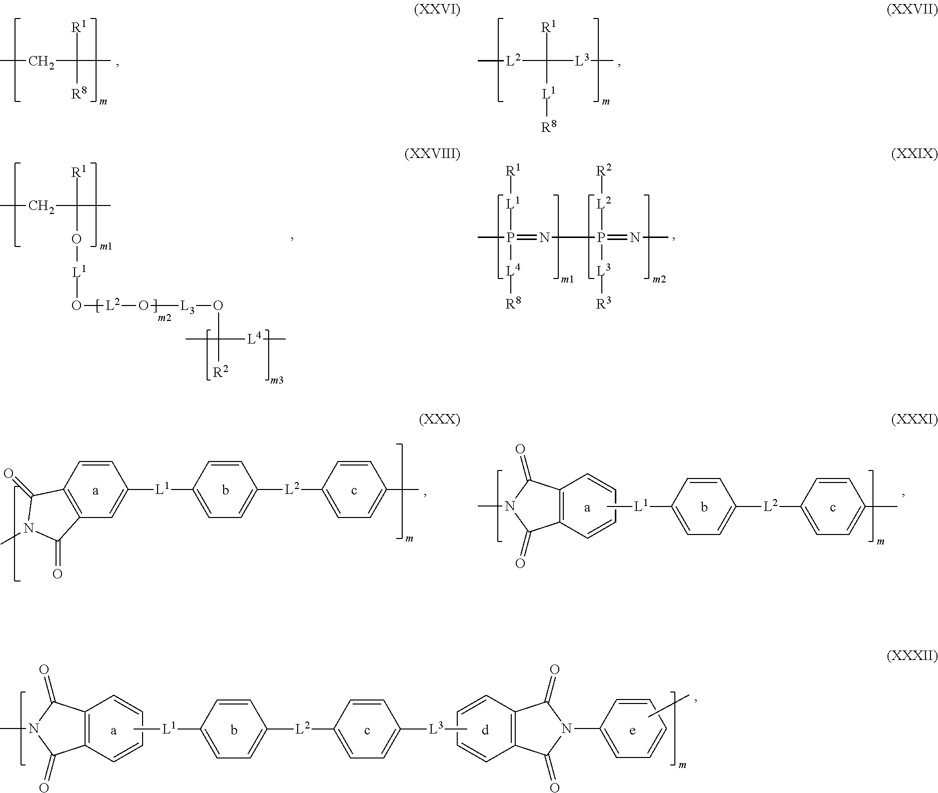

or combinations thereof, wherein
each of R¹, R², R³, R⁷, and R⁸ is independently an electron-withdrawing moiety, H, optionally substituted aliphatic, optionally substituted alkyl, optionally substituted heteroaliphatic, optionally substituted heteroalkyl, optionally substituted aromatic, optionally substituted aryl, optionally substituted aryloxy, or optionally substituted arylalkylene, wherein R⁷ and R⁸ can be taken together to form an optionally substituted cyclic group; each Ak is an optionally substituted alkylene; each of L, L¹, L², L³, and L⁴ is, independently, a linking moiety;
each of m, m1, m2, m3, and m4 is, independently, an integer of 1 or more; each of rings a-i can be optionally substituted; and wherein one or more of rings a-i, R⁷, and R⁸ is optionally an electroactive moiety, wherein the electroactive moiety is a moiety that reversibly reacts with a Lewis acidic gas.

In some embodiments the electron-withdrawing moiety is an optionally substituted haloalkyl, cyano, phosphate, sulfate, sulfonic acid, sulfonyl, difluoroboranyl, borono, or thiocyanato group.

In some embodiments one or more of R⁷, R⁸, R⁹, and R¹⁰ of the first polymer is an electroactive moiety.

In some embodiments R⁷ is the electron-withdrawing moiety and R⁸ is the electroactive moiety.

In some embodiments the electroactive moiety is -L^{A}-X, -L^{A}-(L^{A′}-X)_{L2} or -L^{A}-L^{A′}-L^{A″}-X wherein each L^{A}, L^{A′}, and L^{A″} is independently a linking moiety; X is an electroactive group; and L2 is an integer of 1, 2 or 3.

In some embodiments the electroactive group includes optionally substituted 1,4-benzoquinonyl, optionally substituted 1,2-benzoquinonyl, optionally substituted naphthoquinonyl, optionally substituted anthraquinonyl, optionally substituted phenanthrenequinonyl, optionally substituted benzanthraquinonyl, optionally substituted dibenzoanthraquinonyl, and optionally substituted 4,5,9,10-pyrenetetronyl groups.

In some embodiments the electroactive group is an optionally substituted pyridyl or an optionally substituted thiophenyl group.

In some embodiments linking moiety is a covalent bond, —O—, —SO₂—, —NH—, —C(O)—, —C(O)O—, —OC(O)—, optionally substituted alkylene, optionally substituted haloalkylene, optionally substituted hydroxyalkylene, optionally substituted alkyleneoxy, optionally substituted heteroalkylene, optionally substituted arylene, optionally substituted aryleneoxy, or optionally substituted heterocyclyldiyl group.

In some embodiments one or more of rings a-i, R⁷, and R⁸ of the second polymer is an electroactive moiety.

In some embodiments at least one of rings a-i is an electroactive moiety.

In some embodiments the optionally substituted rings a-i is substituted with one or more substituents, and wherein the substituent is an alkyl, alkoxy, alkoxyalkyl, amino, aminoalkyl, aryl, arylalkylene, aryloyl, aryloxy, arylalkoxy, cyano, hydroxy, hydroxyalkyl, nitro, halo, or haloalkyl group.

In some embodiments the polymeric composition is in the form of a film or a membrane.

In some embodiments, the polymeric composition is a cross-linked polymer matrix.

In a sixth aspect, the present disclosure encompasses an electrochemical cell having an anode; a cathode; and a polymer electrolyte membrane disposed between the anode and the cathode, wherein the polymer electrolyte membrane includes at least one polymer made from moieties of the formula

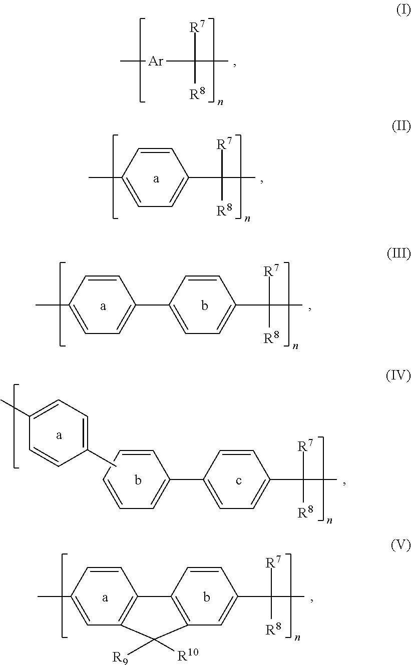

or combinations thereof, wherein
each of R⁷ and R⁸ is, independently, an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, wherein at least one of R⁷ or R⁸ comprises an electron-withdrawing moiety; each of R⁹ and R¹⁰ is, independently, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R⁹ and R¹⁰ can be taken together to form an optionally substituted cyclic group; Ar is an optionally substituted aromatic or optionally substituted arylene; n is an integer of 1 or more; each of ring a, ring b, and ring c can be independently optionally substituted; and one or more of R⁷, R⁸, R⁹, and R¹⁰ is optionally an electroactive moiety, wherein the electroactive moiety is a moiety that reversibly reacts with a Lewis acidic gas.

In a seventh aspect, the present disclosure encompasses an electrochemical cell having an anode; a cathode; and a polymer electrolyte membrane disposed between the anode and the cathode, wherein the polymer electrolyte membrane includes a polymeric composition, wherein said polymeric composition includes at least one polymer made of moieties of the formula

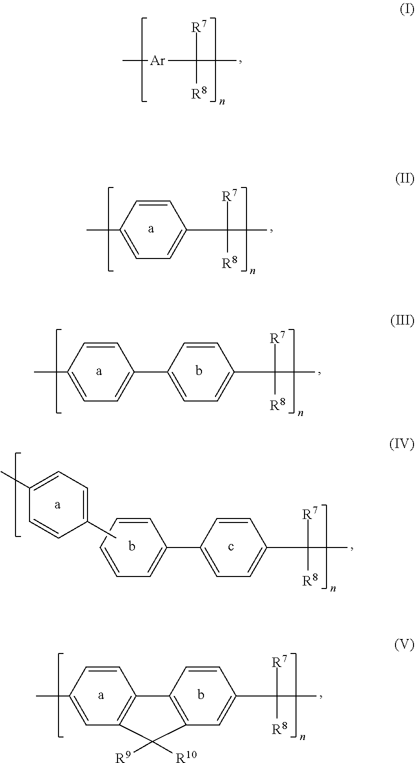

or combinations thereof, wherein
each of R⁷ and R⁸ is independently an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, wherein at least one of R⁷ or R⁸ is an electron-withdrawing moiety; each of R⁹ and R¹⁰ is, independently, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R⁹ and R¹⁰ can be taken together to form an optionally substituted cyclic group; Ar is an optionally substituted aromatic or optionally substituted arylene; n is an integer of 1 or more; each of ring a, ring b, and ring c can be independently optionally substituted; and one or more of R⁷, R⁸, R⁹, and R¹⁰ is optionally an electroactive moiety, wherein the electroactive moiety is a moiety that reversibly reacts with a Lewis acidic gas.

In an eighth aspect, the present disclosure encompasses an electrochemical cell having an anode; a cathode; and a polymer electrolyte membrane disposed between the anode and the cathode, wherein the polymer electrolyte membrane includes a polymeric composition of at least one first polymer and at least one second polymer, wherein
(i) the first polymer comprises moieties of the formula

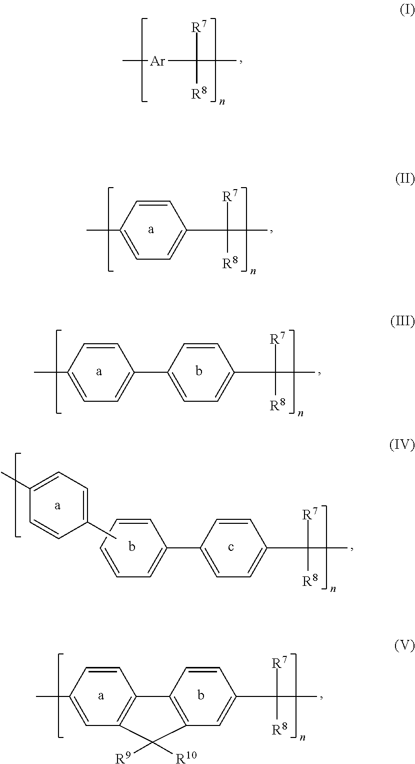

or combinations thereof, wherein
each of R⁷ and R⁸ is independently an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, wherein at least one of R⁷ or R⁸ is an electron-withdrawing moiety; each of R⁹ and R¹⁰ is, independently, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R⁹ and R¹⁰ can be taken together to form an optionally substituted cyclic group; Ar is an optionally substituted aromatic or optionally substituted arylene; n is an integer of 1 or more; each of ring a, ring b, and ring c can be independently optionally substituted; and one or more of R⁷, R⁸, R⁹, and R¹⁰ optionally comprises an electroactive moiety, wherein the electroactive moiety is a moiety that reversibly reacts with a Lewis acidic gas; and (ii) the second polymer comprises moieties of the formula

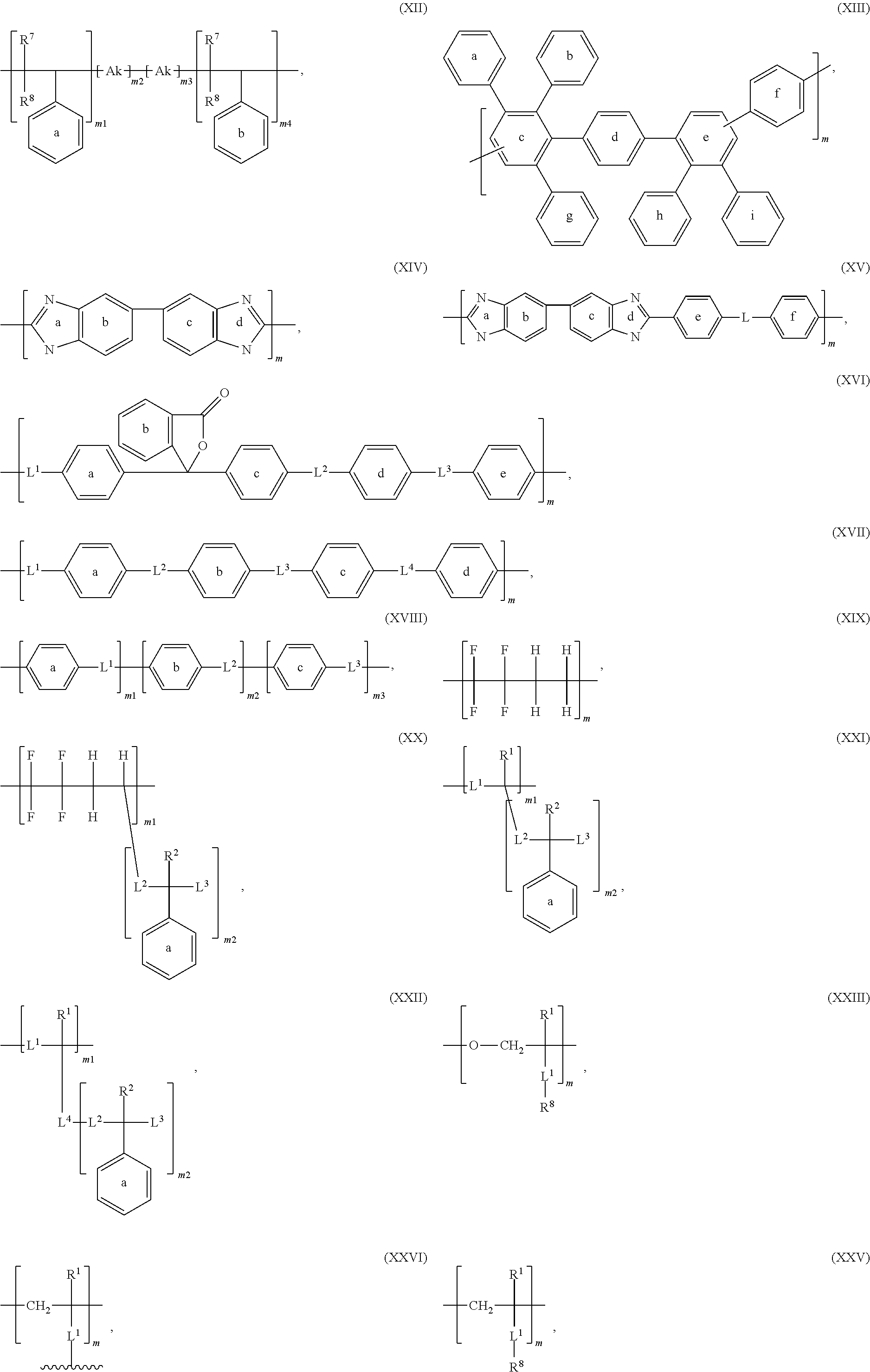

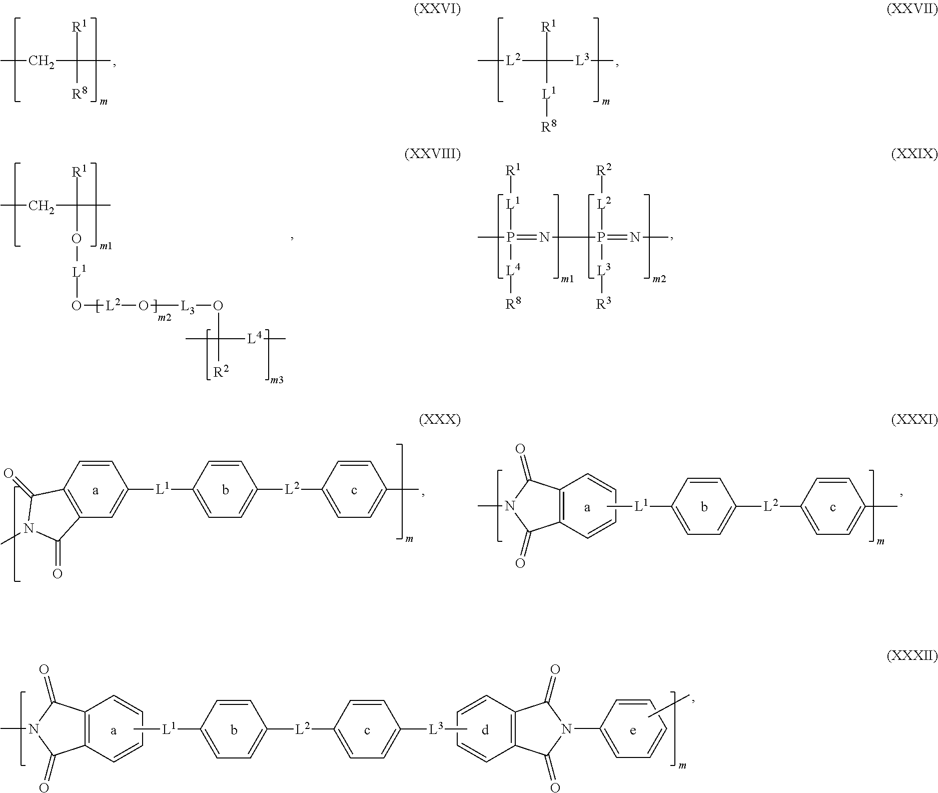

or combinations
thereof, wherein each of R¹, R², R³, R⁷, and R⁸ is independently an electron-withdrawing moiety, H, optionally substituted aliphatic, optionally substituted alkyl, optionally substituted heteroaliphatic, optionally substituted heteroalkyl, optionally substituted aromatic, optionally substituted aryl, optionally substituted aryloxy, or optionally substituted arylalkylene, wherein R⁷ and R⁸ can be taken together to form an optionally substituted cyclic group; each Ak is an optionally substituted alkylene; each of L, L¹, L², L³, and L⁴ is, independently, a linking moiety; each of m, m1, m2, m3, and m4 is, independently, an integer of 1 or more; each of rings a-i can be optionally substituted; and wherein one or more of rings a-i, R⁷, and R⁸ is optionally an electroactive moiety, wherein the electroactive moiety is a moiety that reversibly reacts with a Lewis acidic gas.

In some embodiments, the second polymer includes an electroactive moiety. In yet other embodiments both the first polymer and second polymer include, independently, an electroactive moiety.

In some embodiments, at least one of rings a-i of the second polymer includes an electroactive moiety.

In any embodiment herein, the linking moiety is or includes a covalent bond, —O—, —SO₂—, —NR^{N1}—, —C(O)—, optionally substituted aliphatic, optionally substituted alkylene, optionally substituted haloalkylene, optionally substituted hydroxyalkylene, optionally substituted alkyleneoxy, optionally substituted heteroaliphatic, optionally substituted heteroalkylene, optionally substituted aromatic, optionally substituted arylene, optionally substituted aryleneoxy, optionally substituted heterocycle, or optionally substituted heterocyclyldiyl.

In any embodiment herein, the electron-withdrawing moiety is an optionally substituted haloalkyl, cyano (CN), phosphate (e.g., —O(P═O)(OR¹¹)(OR¹²) or —O—[P(═O)(OR¹¹)—O]_{P3}—R^{P2}), sulfate (e.g., —O—S(═O)₂(OR^{S1})), sulfonic acid (—SO₃H), sulfonyl (e.g., —SO₂—CF₃), difluoroboranyl (—BF₂), borono (—B(OH)₂), or thiocyanato (—SCN) group.

In any embodiment herein, the optionally substituted arylene or optionally substituted rings a-i is substituted with one or more substituents, and wherein the substituent is selected from the group consisting of alkyl, alkoxy, alkoxyalkyl, amino, aminoalkyl, aryl, arylalkylene, aryloyl, aryloxy, arylalkoxy, cyano, hydroxy, hydroxyalkyl, nitro, halo, and haloalkyl.

In any embodiment herein, the composition includes homopolymers and/or copolymers.

In any embodiment herein, the composition includes a film or a membrane.

In any embodiment, the polymeric composition includes a cross-linked polymer matrix.

In a ninth aspect, the present disclosure encompasses an electrochemical method for enrichment of carbon dioxide gas comprising:
(a) providing an electrolysis cell having a cathode layer, an anode layer and a membrane layer arranged between the cathode layer and the anode layer,
wherein the membrane layer is composed of at least one polymer of moieties of the formula

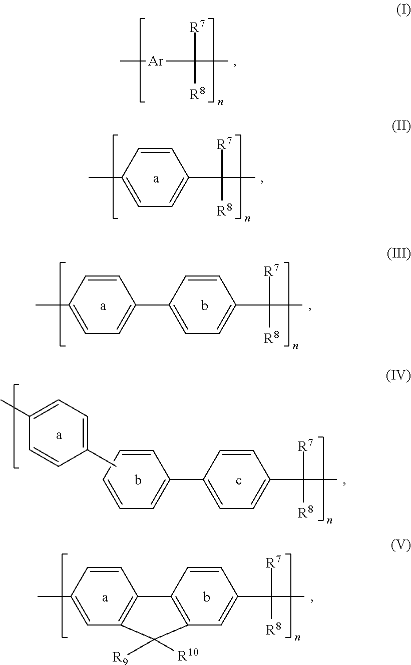

or combinations thereof, wherein
each of R⁷ and R⁸ is, independently, an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, wherein at least one of R⁷ or R⁸ comprises an electron-withdrawing moiety;
each of R⁹ and R¹⁰ is, independently, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R⁹ and R¹⁰ can be taken together to form an optionally substituted cyclic group;
Ar is an optionally substituted aromatic or optionally substituted arylene; n is an integer of 1 or more;
each of ring a, ring b, and ring c can be independently optionally substituted; and one or more of R⁷, R⁸, R⁹, and R¹⁰ optionally comprises an electroactive moiety, wherein the electroactive moiety is a moiety that reversibly reacts with a Lewis acidic gas;
(a) passing carbon dioxide gas through the electrolysis cell whereby the carbon dioxide is captured by the membrane layer, the membrane layer exposed to an electrical current; and then
(b) releasing enriched carbon dioxide from the membrane layer.

Certain aspects of this disclosure pertain to systems that include the following elements: (1) a CO₂ purifier comprising: (a) one or more electrodes, (b) a polymer comprising CO₂-absorbing electroactive moieties, (c) an inlet for receiving impure CO₂, and (d) an outlet for providing purified CO₂; (2) a controller configured to apply cathodic and/or anodic current and/or voltage to the one or more electrodes and cause the polymer to alternately absorb CO₂ from the impure CO₂ stream and release the purified CO₂; and (3) a CO₂ electrolyzer coupled to said CO₂ purifier and allowing the CO₂ electrolyzer to receive the purified CO₂ from the CO₂ purifier, the CO₂ electrolyzer comprising a cathode configured to electrochemically reduce CO₂ to produce a carbon containing product.

In some embodiments, at least a portion of the polymer comprising CO₂ absorbing electroactive moieties is immobilized on a first electrode of the one or more electrodes. In such embodiments, the controller may be configured to alternatively (i) apply the cathodic current and/or voltage to the first electrode to cause the polymer to absorb CO₂ from the impure CO₂ stream and (ii) subsequently apply the anodic current and/or voltage to the first electrode to cause the polymer to release the purified CO₂.

In certain embodiments, the one or more electrodes comprise an anode and a cathode. In such embodiments, the system may additionally include a circulation system configured to transport the polymer between a first space proximate the cathode and a second space proximate the anode. And, during operation, when the polymer is in the first space the polymer absorbs CO₂ from the impure CO₂ stream and when the polymer is in the second space the polymer releases the purified CO₂. In some implementations, the circulation system is configured to continuously flow, during operation, the polymer between the first space and the second space, and wherein the system is configured to continuously produce the purified CO₂. In some such implementations, the first space comprises a cathode compartment and the second space comprises and anode compartment. In some cases, the anode compartment and the cathode compartment are separated by an ionically conductive separator. In some embodiments, the polymer is the form of a melt or a solution comprising a solvent for the polymer.

In some embodiments, the CO₂ electrolyzer is directly coupled to the CO₂ purifier to directly receive the purified CO₂ from the CO₂ purifier. In some embodiments, the controller is further configured to cause electrical energy to be applied to the CO₂ electrolyzer to cause the cathode to electrochemically reduce the CO₂ to produce the carbon containing product.

In certain embodiments, the carbon containing product comprises CO, a hydrocarbon, formic acid, an alcohol, or any combination thereof. In certain embodiments, the CO₂-absorbing electroactive moieties are pendant to a backbone of the polymer. In certain embodiments, the CO₂-absorbing electroactive moieties comprise quinone moieties, thiolate moieties, dipyridinyl moieties, or any combination thereof.

Other aspects of this disclosure pertain to methods that include the following operations:
(a) purifying CO₂ from an impure CO₂ stream by a purification process that includes: (i) contacting the CO₂ stream with a polymer comprising CO₂-absorbing electroactive moieties, while exposing the polymer to a cathodic electrical potential and/or current, and causing the polymer to absorb CO₂ from the impure CO₂ stream, and (ii) subsequently exposing the polymer to an anodic electrical potential and/or current, and causing the polymer to release purified CO₂; and
(b) electrochemically reducing the purified CO₂ by a process comprising: (i) providing the purified CO₂ to a CO₂ electrolyzer, and (ii) electrochemically reducing the purified CO₂ electrolyzer at a cathode of the CO₂ electrolyzer to produce a carbon containing product.

In some cases, at least a portion of the polymer comprising CO₂ absorbing electroactive moieties is immobilized on a first electrode configured to provide the cathodic electrical potential and/or current and/or to provide the anodic electrical potential and/or current. In some such cases, exposing the polymer to the cathodic electrical potential and/or current comprises applying the cathodic electrical potential and/or current to the first electrode, and exposing the polymer to the anodic electrical potential and/or current comprises applying the anodic electrical potential and/or current to the first electrode,

In certain embodiments, exposing the polymer to the cathodic electrical potential and/or current comprises applying the cathodic electrical potential and/or current to a cathode, and exposing the polymer to the anodic electrical potential and/or current comprises applying the anodic electrical potential and/or current to an anode. In such embodiments, the method may additionally include transporting the polymer between a first space proximate the cathode and a second space proximate the anode, wherein when the polymer is in the first space the polymer absorbs CO₂ from the impure CO₂ stream and when the polymer is in the second space the polymer releases the purified CO₂. In some implementations, transporting the polymer comprises continuously flowing the polymer between the first space and the second space. In some implementations, the first space comprises a cathode compartment and the second space comprises and anode compartment. In some implementations, the anode compartment and the cathode compartment are separated by an ionically conductive separator. In certain embodiments, the polymer is the form of a melt or a solution comprising a solvent for the polymer.

In some cases, the method includes directly transporting the purified CO₂ from the CO₂ purifier to an inlet of the CO₂ electrolyzer.

In certain embodiments, the carbon containing product comprises CO, a hydrocarbon, formic acid, an alcohol, or any combination thereof. In certain embodiments, the CO₂-absorbing electroactive moieties are pendant to a backbone of the polymer. In certain embodiments, the CO₂-absorbing electroactive moieties comprise quinone moieties, thiolate moieties, dipyridinyl moieties, or any combination thereof.

Another aspect of the disclosure pertains to systems that include the following features:
(a) a CO₂ purifier comprising an inlet for receiving impure CO₂, a cathode, an anode, one or more flow paths configured transport a compound comprising one or more electroactive CO₂-absorbing moieties between the cathode and the anode, and an outlet for releasing purified CO₂;
(b) a controller configured to (i) apply a cathodic potential and/or flow a cathodic current flow to the first electrode to thereby cause the compound to absorb CO₂ from the impure CO₂, (ii) apply an anodic potential and/or flow an anodic current flow to the second electrode to thereby cause the compound to release CO₂ and produce the purified CO₂, and (iii) cause the compound to move between the cathode and the anode; and
(c) a CO₂ electrolyzer coupled to the outlet of the CO₂ purifier and configured to electrochemically reduce purified CO₂ produced by the CO₂ purifier.

In certain embodiments, the CO₂ electrolyzer is directly coupled to the outlet of the CO₂ purifier. In certain embodiments, the CO₂ electrolyzer is indirectly coupled to the outlet of the CO₂ purifier. In such embodiments, the system may additionally include a storage vessel coupled to the outlet of the CO₂ purifier and configured to store the purified CO₂ before providing the purified CO₂ to the CO₂ electrolyzer.

In certain embodiments, the CO₂ purifier further comprises a separator between the cathode and the anode. In such embodiments, the system may additionally include a pump configured transport the polymer between the cathode and the anode when the polymer is a melt or is dissolved in a solution.

In certain embodiments, the compound comprising one or more electroactive CO₂-absorbing moieties is a polymer. In such embodiments, the one or more CO₂-absorbing moieties may be pendant to a backbone of the polymer. In certain embodiments, the one or more CO₂-absorbing moieties comprise quinone moieties.

In certain embodiments, the controller is further configured to apply current and/or potential to the CO₂ electrolyzer to cause electrolysis of the purified CO₂.

Other aspects of this disclosure pertain to methods characterized by the following operations:
(a) applying a cathodic potential to a first electrode and/or flowing a cathodic current to the first electrode and thereby causing a compound proximate the first electrode and comprising one or more electroactive CO₂-absorbing moieties to undergo a first electrochemical reaction to absorb CO₂ from impure CO₂;
(b) transporting the compound, with absorbed CO₂, to a second electrode;
(c) applying an anodic potential to the second electrode and/or flowing an anodic current to the second electrode and thereby causing the compound to undergo a second electrochemical reaction to release absorbed CO₂; and produce purified CO₂;
(d) providing the purified CO₂ to a CO₂ electrolyzer; and
(e) electrochemically reducing the purified CO₂ at the CO₂ electrolyzer.

In certain embodiments, the method additionally includes storing the purified CO₂ before providing the purified CO₂ to the CO₂ electrolyzer.

In certain embodiments, the impure CO₂ comprises CO₂ in a concentration of about 0.01 to 70% by volume. In certain embodiments, the purified CO₂ comprises CO₂ in a concentration of about 50 to 100% by volume.

In certain embodiments, the compound comprising one or more electroactive CO₂-absorbing moieties is a polymer. In such embodiments, the one or more CO₂-absorbing moieties may be pendant to a backbone of the polymer. In certain embodiments, the one or more CO₂-absorbing moieties comprise quinone moieties. In some embodiments, the polymer is a melt or is dissolved in a solution.

In certain embodiments, the cathodic potential is about −0.3 V versus the SHE or more negative. In certain embodiments, the anodic potential is about −0.2 V versus the SHE or more positive.

Other aspects of this disclosure pertain to systems characterized by the following features:
(1) a CO₂ purifier comprising an electrode having one or more electroactive CO₂-absorbing moieties immobilized thereon and able to undergo a first electrochemical reaction to absorb CO₂ when the electrode is held at a cathodic potential and/or when a cathodic current flows to the electrode and undergo a second electrochemical reaction to release absorbed CO₂ when an anodic potential and/or when an anodic current flows to the electrode;
(2) a controller configured to (i) apply the cathodic potential and/or the cathodic current to the electrode during a CO₂ absorption phase, and (ii) apply the anodic potential and/or the anodic current to the electrode during a CO₂ release phase; and
(3) a CO₂ electrolyzer coupled to an outlet of the CO₂ purifier and configured to electrochemically reduce purified CO₂ produced by the CO₂ purifier.

In certain embodiments, the CO₂ electrolyzer is directly coupled to the outlet of the CO₂ purifier. In certain embodiments, the CO₂ electrolyzer is indirectly coupled to the outlet of the CO₂ purifier. In such embodiments, the system may additionally include a storage vessel coupled to the outlet of the CO₂ purifier and configured to store the purified CO₂ before providing the purified CO₂ to the CO₂ electrolyzer.

In certain embodiments, the CO₂-absorbing moieties are covalently bound to a polymer. In certain embodiments, the CO₂-absorbing moieties are pendant to a polymer backbone. In certain embodiments, the CO₂-absorbing moieties comprise quinone moieties.

In certain embodiments, the CO₂ purifier comprises a second electrode. In such embodiments, the controller may be further configured to reverse electrical polarity between the electrode and the second electrode and thereby cause the CO₂ purifier to transition between the first electrochemical reaction and the second electrochemical reaction. In certain embodiments, the controller is further configured to apply current and/or potential to the CO₂ electrolyzer to cause electrolysis of the purified CO₂.

Still other aspects of this disclosure pertain to methods characterized by the following operations:
(a) applying a cathodic potential to an electrode and/or flowing a cathodic current to the electrode and thereby causing one or more electroactive CO₂-absorbing moieties immobilized on the electrode to undergo a first electrochemical reaction to absorb CO₂ from impure CO₂;
(b) subsequent to (a), applying an anodic potential to the electrode and/or flowing an anodic current to the electrode and thereby causing the one or more electroactive CO₂-absorbing moieties to undergo a second electrochemical reaction to release absorbed CO₂; and produce purified CO₂;
(c) providing the purified CO₂ to a CO₂ electrolyzer; and
(d) electrochemically reducing the purified CO₂ at the CO₂ electrolyzer.

In certain embodiments, the impure CO₂ comprises CO₂ in a concentration of about 0.01 to 70% by volume. In certain embodiments, the purified CO₂ comprises CO₂ in a concentration of about 50 to 100% by volume.

In certain embodiments, the electrode is part of a CO₂ purifier, and the purified CO₂ flows from the CO₂ purifier to the CO₂ electrolyzer. In certain embodiments, the method additionally stores the purified CO₂ before providing the purified CO₂ to the CO₂ electrolyzer.

In certain embodiments, the CO₂-absorbing moieties are covalently bound to a polymer. In certain embodiments, the CO₂-absorbing moieties are pendant to a polymer backbone. In certain embodiments, the CO₂-absorbing moieties comprise quinone moieties.

In certain embodiments, the cathodic potential is about −0.3 V versus the SHE or more negative. In certain embodiments, the anodic potential is about −0.2 V versus the SHE or more positive.

In the above-described aspects of the disclosure, any combination of the one or more dependent features may be implemented together with, or apart from, one another when used with the primary aspect. Additional aspects and features of the disclosure will be presented below, sometimes with reference to associated drawings.

### BRIEF DESCRIPTION OF THE DRAWINGS

FIG. 1A is a block diagram schematically illustrating an absorption phase of a two-phase CO₂ absorption and release process. A CO₂ absorption polymer may be provided on a single electrode.

FIG. 1B is a block diagram schematically illustrating a CO₂ release phase of the two-phase CO₂ absorption and release process partially illustrated in FIG. 1A. Absorption and release may be controlled by periodically switching polarity so that absorption and release alternate. In this embodiment, purified CO₂ may be provided to an electrolyzer intermittently.

FIG. 2 is a block diagram schematically illustrating a CO₂ absorption and release system employing a CO₂ absorption polymer on each of two electrodes. In operation, the system periodically switches the electrodes' polarities so that absorption and release alternate between electrodes but the complete system continuously generates CO₂ for a CO₂ electrolyzer.

FIG. 3A is a block diagram schematically illustrating a CO₂ absorption and release purifier that transports a CO₂ absorbing polymer between a cathode compartment where it captures CO₂ from an impure stream and an anode compartment where it releases purified CO₂.

FIG. 3B is a block diagram of a system employing a CO₂ purifier integrated with a CO₂ electrolyzer.

FIG. 4 depicts an example system for a carbon oxide reduction reactor that may include a cell comprising an MEA (membrane electrode assembly).

FIG. 5 depicts an example MEA for use in COₓ reduction. The MEA has a cathode layer and an anode layer separated by an ion-conducting polymer layer.

### DETAILED DESCRIPTION

### Definitions

As used herein, the term “about” is understood to account for minor increases and/or decreases beyond a recited value, which changes do not significantly impact the desired function the parameter beyond the recited value(s). In some cases, “about” encompasses+/−10% of any recited value. As used herein, this term modifies any recited value, range of values, or endpoints of one or more ranges.

As used herein, the terms “top,” “bottom,” “upper,” “lower,” “above,” and “below” are used to provide a relative relationship between structures. The use of these terms does not indicate or require that a particular structure must be located at a particular location in the apparatus.

By “aliphatic” is meant a hydrocarbon group having at least one carbon atom to 50 carbon atoms (C₁₋₅₀), such as one to 25 carbon atoms (C₁₋₂₅), or one to ten carbon atoms (C₁₋₁₀), and which includes alkanes (or alkyl), alkenes (or alkenyl), alkynes (or alkynyl), including cyclic versions thereof, and further including straight- and branched-chain arrangements, and all stereo and position isomers as well. Such an aliphatic can be unsubstituted or substituted with one or more groups, such as groups described herein for an alkyl group.

The term “acyl,” or “alkanoyl,” as used interchangeably herein, represents an alkyl group, as defined herein, or hydrogen attached to the parent molecular group through a carbonyl group, as defined herein. This group is exemplified by formyl, acetyl, propionyl, butanoyl, and the like. The alkanoyl group can be substituted or unsubstituted. For example, the alkanoyl group can be substituted with one or more substitution groups, as described herein for alkyl. In some embodiments, the unsubstituted acyl group is a C₂₋₇ acyl or alkanoyl group. In particular embodiments, the alkanoyl group is —C(O)-Ak, in which Ak is an alkyl group, as defined herein.

By “alkoxy” is meant —OR, where R is an optionally substituted alkyl group, as described herein. Exemplary alkoxy groups include methoxy, ethoxy, butoxy, trihaloalkoxy, such as trifluoromethoxy, etc. The alkoxy group can be substituted or unsubstituted. For example, the alkoxy group can be substituted with one or more substitution groups, as described herein for alkyl. Exemplary unsubstituted alkoxy groups include C₁₋₃, C₁₋₆, C₁₋₁₂, C₁₋₆, C₁₋₈, C₁₋₂₀, or C₁₋₂₄ alkoxy groups.

By “alkoxyalkyl” is meant an alkyl group, as defined herein, which is substituted with an alkoxy group, as defined herein. Exemplary unsubstituted alkoxyalkyl groups include between 2 to 12 carbons (C₂₋₁₂ alkoxyalkyl), as well as those having an alkyl group with 1 to 6 carbons and an alkoxy group with 1 to 6 carbons (i.e., C₁₋₆ alkoxy-C₁₋₆ alkyl).

By “alkyl” and the prefix “alk” is meant a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic (e.g., C₃₋₂₄ cycloalkyl) or acyclic. The alkyl group can be branched or unbranched. The alkyl group can also be substituted or unsubstituted. For example, the alkyl group can be substituted with one, two, three or, in the case of alkyl groups of two carbons or more, four substituents independently selected from the group consisting of: (1) C₁₋₆ alkoxy (e.g., —O-Ak, wherein Ak is optionally substituted C₁₋₆ alkyl); (2) C₁₋₆ alkylsulfinyl (e.g., —S(O)-Ak, wherein Ak is optionally substituted C₁₋₆ alkyl); (3) C₁₋₆ alkylsulfonyl (e.g., —SO₂-Ak, wherein Ak is optionally substituted C₁₋₆ alkyl); (4) amino (e.g., —NR^{N1}R^{N2}, where each of R^{N1} and R^{N2} is, independently, H or optionally substituted alkyl, or R^{N1} and R^{N2}, taken together with the nitrogen atom to which each are attached, form a heterocyclyl group); (5) aryl; (6) arylalkoxy (e.g., —O-L-Ar, wherein L is a bivalent form of optionally substituted alkyl and Ar is optionally substituted aryl); (7) aryloyl (e.g., —C(O)—Ar, wherein Ar is optionally substituted aryl); (8) azido (e.g., —N₃); (9) cyano (e.g., —CN); (10) carboxyaldehyde (e.g., —C(O)H); (11) C₃₋₈ cycloalkyl (e.g., a monovalent saturated or unsaturated non-aromatic cyclic C₃₋₈ hydrocarbon group); (12) halo (e.g., F, Cl, Br, or I); (13) heterocyclyl (e.g., a 5-, 6- or 7-membered ring, unless otherwise specified, containing one, two, three, or four non-carbon heteroatoms, such as nitrogen, oxygen, phosphorous, sulfur, or halo); (14) heterocyclyloxy (e.g., —O-Het, wherein Het is heterocyclyl, as described herein); (15) heterocyclyloyl (e.g., —C(O)—Het, wherein Het is heterocyclyl, as described herein); (16) hydroxyl (e.g., —OH); (17)N-protected amino; (18) nitro (e.g., —NO₂); (19) oxo (e.g., ═O) or hydroxyimino (e.g., ═N—OH); (20) C₃₋₈ spirocyclyl (e.g., an alkylene or heteroalkylene diradical, both ends of which are bonded to the same carbon atom of the parent group); (21) C₁₋₆ thioalkoxy (e.g., —S-Ak, wherein Ak is optionally substituted C₁₋₆ alkyl); (22) thiol (e.g., —SH); (23) -CO₂R^{A}, where R^{A} is selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); (24) —C(O)NR^{B}R^{C}, where each of R^{B} and R^{C} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); (25) —SO₂R^{D}, where R^{D} is selected from the group consisting of (a) C₁₋₆ alkyl, (b) C₄₋₁₈ aryl, and (c) (C₄₋₁₈ aryl) C₁₋₆ alkyl (e.g., -L-Ar, wherein L is a bivalent form of optionally substituted alkyl group and Ar is optionally substituted aryl); (26) —SO₂NR^{E}R^{F}, where each of R^{E} and R^{F} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); and (27) —NR^{G}R^{H}, where each of R^{G} and R^{H} is, independently, selected from the group consisting of (a) hydrogen, (b) an N-protecting group, (c) C₁₋₆ alkyl, (d) C₂₋₆ alkenyl (e.g., optionally substituted alkyl having one or more double bonds), (e) C₂₋₆ alkynyl (e.g., optionally substituted alkyl having one or more triple bonds), (f) C₄₋₁₈ aryl, (g) (C₄₋₁₈ aryl) C₁₋₆ alkyl (e.g., L-Ar, wherein L is a bivalent form of optionally substituted alkyl group and Ar is optionally substituted aryl), (h) C₃₋₈ cycloalkyl, and (i) (C₃₋₈ cycloalkyl) C₁₋₆ alkyl (e.g., -L-Cy, wherein L is a bivalent form of optionally substituted alkyl group and Cy is optionally substituted cycloalkyl, as described herein), wherein in one embodiment no two groups are bound to the nitrogen atom through a carbonyl group or a sulfonyl group. The alkyl group can be a primary, secondary, or tertiary alkyl group substituted with one or more substituents (e.g., one or more halo or alkoxy). In some embodiments, the unsubstituted alkyl group is a C₁₋₃, C₁₋₆, C₁₋₁₂, C₁₋₆, C₁₋₁₈, C₁₋₂₀, or C₁₋₂₄ alkyl group.

By “alkylene” is meant a multivalent (e.g., bivalent, trivalent, tetravalent, etc.) form of an alkyl group, as described herein. Exemplary alkylene groups include methylene, ethylene, propylene, butylene, etc. In some embodiments, the alkylene group is a C₁₋₃, C₁₋₆, C₁₋₁₂, C₁₋₁₆, C₁₋₁₈, C₁₋₂₀, C₁₋₂₄, C₂₋₃, C₂₋₆, C₂₋₁₂, C₂₋₁₆, C₂₋₁₈, C₂₋₂₀, or C₂₋₂₄ alkylene group. The alkylene group can be branched or unbranched. The alkylene group can be saturated or unsaturated (e.g., having one or more double bonds or triple bonds). The alkylene group can also be substituted or unsubstituted. For example, the alkylene group can be substituted with one or more substitution groups, as described herein for alkyl. In one instance, a substituted alkylene group can include an optionally substituted haloalkylene (e.g., an optionally substituted alkylene substituted with one or more hydroxyl groups, as defined herein), an optionally substituted haloalkylene (e.g., an optionally substituted alkylene substituted with one or more halo groups, as defined herein), and the like.

By “alkyleneoxy” is meant an alkylene group, as defined herein, attached to the parent molecular group through an oxygen atom.

By “amino” is meant —NR^{N1}R^{N2}, where each of R^{N1} and R^{N2} is, independently, H, optionally substituted alkyl, optionally substituted cycloalkyl, or optionally substituted aryl; or R^{N1} and R^{N2}, taken together with the nitrogen atom to which each are attached, form an optionally substituted heterocyclyl group or heterocycle, as defined herein; or R^{N1} iand R^{N2}, taken together, form an optionally substituted alkylene or heteroalkylene (e.g., as described herein).

By “aminoalkyl” is meant an alkyl group, as defined herein, substituted by an amino group, as defined herein. Non-limiting aminoalkyl groups include -L-NR^{N1}R^{N2}, where L is a multivalent alkyl group, as defined herein; each of R^{N1} and R^{N2} is, independently, H, optionally substituted alkyl, or optionally substituted aryl; or R^{N1} and R^{N2}, taken together with the nitrogen atom to which each are attached, form a heterocyclyl group, as defined herein.

By “ammonium” is meant a group including a protonated nitrogen atom N⁺. Exemplary ammonium groups include —N⁺R^{N1}R^{N2}R^{N3} where each of R^{N1}, R^{N2}, and R^{N3} is, independently, H, optionally substituted alkyl, optionally substituted cycloalkyl, or optionally substituted aryl; or R^{N1} and R^{N2}, taken together with the nitrogen atom to which each are attached, form an optionally substituted heterocyclyl group or heterocycle; or R^{N1} and R^{N2}, taken together, form an optionally substituted alkylene or heteroalkylene (e.g., as described herein); or R^{N1} and R^{N2} and R^{N3}, taken together with the nitrogen atom to which each are attached, form an optionally substituted heterocyclyl group or heterocycle, such as a heterocyclic cation.

By “aromatic” is meant a cyclic, conjugated group or moiety of, unless specified otherwise, from 5 to 15 ring atoms having a single ring (e.g., phenyl) or multiple condensed rings in which at least one ring is aromatic (e.g., naphthyl, indolyl, or pyrazolopyridinyl); that is, at least one ring, and optionally multiple condensed rings, have a continuous, delocalized π-electron system. Typically, the number of out of plane π-electrons corresponds to the Huckel rule (4n+2). The point of attachment to the parent structure typically is through an aromatic portion of the condensed ring system. Such an aromatic can be unsubstituted or substituted with one or more groups, such as groups described herein for an alkyl or aryl group. Yet other substitution groups can include aliphatic, haloaliphatic, halo, nitrate, cyano, sulfonate, sulfonyl, or others.

By “aryl” is meant a group that contains any carbon-based aromatic group including, but not limited to, phenyl, benzyl, anthracenyl, anthryl, benzocyclobutenyl, benzocyclooctenyl, biphenylyl, chrysenyl, dihydroindenyl, fluoranthenyl, indacenyl, indenyl, naphthyl, phenanthryl, phenoxybenzyl, picenyl, pyrenyl, terphenyl, and the like, including fused benzo-C₄₋₈ cycloalkyl radicals (e.g., as defined herein) such as, for instance, indanyl, tetrahydronaphthyl, fluorenyl, and the like. The term aryl also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term non-heteroaryl, which is also included in the term aryl, defines a group that contains an aromatic group that does not contain a heteroatom. The aryl group can be substituted or unsubstituted. The aryl group can be substituted with one, two, three, four, or five substituents independently selected from the group consisting of: (1) C₁₋₆ alkanoyl (e.g., —C(O)-Ak, wherein Ak is optionally substituted C₁₋₆ alkyl); (2) C₁₋₆ alkyl; (3) C₁₋₆ alkoxy (e.g., —O-Ak, wherein Ak is optionally substituted C₁₋₆ alkyl); (4) C₁₋₆ alkoxy-C₁₋₆ alkyl (e.g., -L-O-Ak, wherein L is a bivalent form of optionally substituted alkyl group and Ak is optionally substituted C₁₋₆ alkyl); (5) C₁₋₆ alkylsulfinyl (e.g., —S(O)-Ak, wherein Ak is optionally substituted C₁₋₆ alkyl); (6) C₁₋₆ alkylsulfinyl-C₁₋₆ alkyl (e.g., -L-S(O)-Ak, wherein L is a bivalent form of optionally substituted alkyl group and Ak is optionally substituted C₁₋₆ alkyl); (7) C₁₋₆ alkylsulfonyl (e.g., —SO₂-Ak, wherein Ak is optionally substituted C₁₋₆ alkyl); (8) C₁₋₆ alkylsulfonyl-C₁₋₆ alkyl (e.g., -L-SO₂-Ak, wherein L is a bivalent form of optionally substituted alkyl group and Ak is optionally substituted C₁₋₆ alkyl); (9) aryl; (10) amino (e.g., —NR^{N1}R^{N2}, where each of R^{N1} iand R^{N2} is, independently, H or optionally substituted alkyl, or R^{N1} and R^{N2}, taken together with the nitrogen atom to which each are attached, form a heterocyclyl group); (11) C₁₋₆ aminoalkyl (e.g., an alkyl group, as defined herein, substituted by one or more —NR^{N1}R^{N2} groups, as described herein); (12) heteroaryl (e.g., a subset of heterocyclyl groups (e.g., a 5-, 6- or 7-membered ring, unless otherwise specified, containing one, two, three, or four non-carbon heteroatoms), which are aromatic); (13) (C₄₋₁₈ aryl) C₁₋₆ alkyl (e.g., -L-Ar, wherein L is a bivalent form of optionally substituted alkyl and Ar is optionally substituted aryl); (14) aryloyl (e.g., —C(O)—Ar, wherein Ar is optionally substituted aryl); (15) azido (e.g., —N₃); (16) cyano (e.g., —CN); (17) C₁₋₆ azidoalkyl (e.g., an alkyl group, as defined herein, substituted by one or more azido groups, as described herein); (18) carboxyaldehyde (e.g., —C(O)H); (19) carboxyaldehyde-C₁₋₆ alkyl (e.g., an alkyl group, as defined herein, substituted by one or more carboxyaldehyde groups, as described herein); (20) C₃₋₈ cycloalkyl (e.g., a monovalent saturated or unsaturated non-aromatic cyclic C₃₋₈ hydrocarbon group); (21) (C₃₋₈ cycloalkyl) C₁₋₆ alkyl (e.g., an alkyl group, as defined herein, substituted by one or more cycloalkyl groups, as described herein); (22) halo (e.g., F, Cl, Br, or I); (23) C₁₋₆ haloalkyl (e.g., an alkyl group, as defined herein, substituted by one or more halo groups, as described herein); (24) heterocyclyl (e.g., a 5-, 6- or 7-membered ring, unless otherwise specified, containing one, two, three, or four non-carbon heteroatoms, such as nitrogen, oxygen, phosphorous, sulfur, or halo); (25) heterocyclyloxy (e.g., —O-Het, wherein Het is heterocyclyl, as described herein); (26) heterocyclyloyl (e.g., —C(O)—Het, wherein Het is heterocyclyl, as described herein); (27) hydroxyl (e.g., —OH); (28) C₁₋₆ hydroxyalkyl (e.g., an alkyl group, as defined herein, substituted by one or more hydroxyl, as described herein); (29) nitro (e.g., —NO₂); (30) C₁₋₆ nitroalkyl (e.g., an alkyl group, as defined herein, substituted by one or more nitro, as described herein); (31)N-protected amino; (32)N-protected amino-C₁₋₆ alkyl (e.g., an alkyl group, as defined herein, substituted by one or more N-protected amino groups); (33) oxo (e.g., ═O) or hydroxyimino (e.g., =N—OH); (34) C₁₋₆ thioalkoxy (e.g., —S-Ak, wherein Ak is optionally substituted C₁₋₆ alkyl); (35) thio-C₁₋₆ alkoxy-C₁₋₆ alkyl (e.g., -L-S-Ak, wherein L is a bivalent form of optionally substituted alkyl and Ak is optionally substituted C₁₋₆ alkyl); (36) —(CH₂)ᵣCO₂R^{A}, where r is an integer of from zero to four, and R^{A} is selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl and Ar is optionally substituted aryl); (37) —(CH₂)ᵣCONR^{B}R^{C}, where r is an integer of from zero to four and where each R^{B} and R^{C} is independently selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl and Ar is optionally substituted aryl); (38) —(CH₂)ᵣSO₂R^{D}, where r is an integer of from zero to four and where R^{D} is selected from the group consisting of (a) C₁₋₆ alkyl, (b) C₄₋₁₈ aryl, and (c) (C₄₋₁₈ aryl) C₁₋₆ alkyl (e.g., -L-Ar, wherein L is a bivalent form of optionally substituted alkyl and Ar is optionally substituted aryl); (39) —(CH₂)ᵣSO₂NR^{E}R^{F}, where r is an integer of from zero to four and where each of R^{E} and R^{F} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl and Ar is optionally substituted aryl); (40) —(CH₂)ᵣNR^{G}R^{H}, where r is an integer of from zero to four and where each of R^{G} and R^{H} is, independently, selected from the group consisting of (a) hydrogen, (b) an N-protecting group, (c) C₁₋₆ alkyl, (d) C₂₋₆ alkenyl (e.g., optionally substituted alkyl having one or more double bonds), (e) C₂₋₆ alkynyl (e.g., optionally substituted alkyl having one or more triple bonds), (f) C₄₋₁₈ aryl, (g) (C₄₋₁₈ aryl) C₁₋₆ alkyl (e.g., -L-Ar, wherein L is a bivalent form of optionally substituted alkyl and Ar is optionally substituted aryl), (h) C₃₋₈ cycloalkyl, and (i) (C₃₋₈ cycloalkyl) C₁₋₆ alkyl (e.g., -L-Cy, wherein L is a bivalent form of optionally substituted alkyl and Cy is optionally substituted cycloalkyl, as described herein), wherein in one embodiment no two groups are bound to the nitrogen atom through a carbonyl group or a sulfonyl group; (41) thiol (e.g., —SH); (42) perfluoroalkyl (e.g., an alkyl group having each hydrogen atom substituted with a fluorine atom); (43) perfluoroalkoxy (e.g., —OR^{f}, where R^{f} is an alkyl group having each hydrogen atom substituted with a fluorine atom); (44) aryloxy (e.g., —OAr, where Ar is optionally substituted aryl); (45) cycloalkoxy (e.g., —O-Cy, wherein Cy is optionally substituted cycloalkyl, as described herein); (46) cycloalkylalkoxy (e.g., —O-L-Cy, wherein L is a bivalent form of optionally substituted alkyl and Cy is optionally substituted cycloalkyl, as described herein); and (47) arylalkoxy (e.g., —O-L-Ar, wherein L is a bivalent form of optionally substituted alkyl and Ar is optionally substituted aryl). In particular embodiments, an unsubstituted aryl group is a C₄₋₁₈, C₄₋₁₄, C₄₋₁₂, C₄₋₁₀, C₆₋₁₈, C₆₋₁₄, C₆₋₁₂, or C₆₋₁₀ aryl group.

By “arylalkoxy” is meant an arylalkylene group, as defined herein, attached to the parent molecular group through an oxygen atom. In some embodiments, the arylalkoxy group is —O-Ak-Ar, in which Ak is an optionally substituted alkylene, as defined herein, and Ar is an optionally substituted aryl, as defined herein.

By “(aryl)(alkyl)ene” is meant a bivalent form including an arylene group, as described herein, attached to an alkylene or a heteroalkylene group, as described herein. In some embodiments, the (aryl)(alkyl)ene group is -L-Ar— or -L-Ar-L- or —Ar-L-, in which Ar is an arylene group and each L is, independently, an optionally substituted alkylene group or an optionally substituted heteroalkylene group.

By “arylalkylene” is meant an aryl group, as defined herein, attached to the parent molecular group through an alkylene group, as defined herein. In some embodiments, the arylalkylene group is -Ak-Ar, in which Ak is an optionally substituted alkylene, as defined herein, and Ar is an optionally substituted aryl, as defined herein. The arylalkylene group can be substituted or unsubstituted. For example, the arylalkylene group can be substituted with one or more substitution groups, as described herein for aryl and/or alkyl. Exemplary unsubstituted arylalkylene groups are of from 7 to 16 carbons (C₇₋₁₆ arylalkylene), as well as those having an aryl group with 4 to 18 carbons and an alkylene group with 1 to 6 carbons (i.e., (C₄₋₁₈ aryl)C₁₋₆ alkylene).

By “arylene” is meant a multivalent (e.g., bivalent, trivalent, tetravalent, etc.) form of an aryl group, as described herein. Exemplary arylene groups include phenylene, naphthylene, biphenylene, triphenylene, diphenyl ether, acenaphthenylene, anthrylene, or phenanthrylene. In some embodiments, the arylene group is a C₄₋₁₈, C₄₋₁₄, C₄₋₁₂, C₄₋₁₀, C₆₋₁₈, C₆₋₁₄, C₆₋₁₂, or C₆₋₁₀ arylene group. The arylene group can be branched or unbranched. The arylene group can also be substituted or unsubstituted. For example, the arylene group can be substituted with one or more substitution groups, as described herein for aryl.

By “aryleneoxy” is meant an arylene group, as defined herein, attached to the parent molecular group through an oxygen atom.

By “aryloxy” is meant an aryl group, as defined herein, attached to the parent molecular group through an oxygen atom.

By “aryloyl” is meant an aryl group that is attached to the parent molecular group through a carbonyl group. In some embodiments, an unsubstituted aryloyl group is a C₇₋₁₁ aryloyl or C₅₋₁₉ aryloyl group. In particular embodiments, the aryloyl group is —C(O)—Ar, in which Ar is an aryl group, as defined herein.

By “boranyl” is meant a —BR₂ group, in which each R, independently, can be H, halo, or optionally substituted alkyl.

By “borono” is meant a —BOH₂ group.

By “carboxyl” is meant a —CO₂H group.

By “carboxylate anion” is meant a —CO₂ group.

By “covalent bond” is meant a covalent bonding interaction between two components. Non-limiting covalent bonds include a single bond, a double bond, a triple bond, or a spirocyclic bond, in which at least two molecular groups are bonded to the same carbon atom.

By “cyano” is meant a —CN group.

By “cyclic group” is used herein to refer to either aryl groups, non-aryl groups (e.g., cycloalkyl or heterocycloalkyl groups), or both. Cyclic groups have one or more ring systems that can be substituted or unsubstituted. A cyclic group can contain one or more aryl groups, one or more non-aryl groups, or one or more aryl groups and one or more non-aryl groups.

By “cycloalkyl” is meant a monovalent saturated or unsaturated non-aromatic cyclic hydrocarbon group of from three to ten carbons (e.g., C₃₋₈ or C₃₋₁₀), unless otherwise specified, and is exemplified by cyclopropyl, cyclobutyl, cyclopentyl, cyclohexyl, cycloheptyl, bicyclo[2.2.1.]heptyl, and the like. The term cycloalkyl also includes “cycloalkenyl,” which is defined as a non-aromatic carbon-based ring composed of three to ten carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The cycloalkyl group can also be substituted or unsubstituted. For example, the cycloalkyl group can be substituted with one or more groups including those described herein for alkyl.

By “enrichment” is meant that the concentration of a specific gas is higher than the concentration of that gas in an initial, pre-treated state.

By “halo” is meant F, Cl, Br, or I.

By “haloalkyl” is meant an alkyl group, as defined herein, substituted with one or more halo.

By “haloalkylene” is meant an alkylene group, as defined herein, substituted with one or more halo.

By “heteroaliphatic” is meant an aliphatic group, as defined herein, including at least one heteroatom to 20 heteroatoms, such as one to 15 heteroatoms, or one to 5 heteroatoms, which can be selected from, but not limited to oxygen, nitrogen, sulfur, silicon, boron, selenium, phosphorous, and oxidized forms thereof within the group.

By “heteroalkyl” is meant an alkyl group, as defined herein, containing one, two, three, or four non-carbon heteroatoms (e.g., independently selected from the group consisting of nitrogen, oxygen, phosphorous, sulfur, selenium, or halo).

By “heteroalkylene” is meant an alkylene group, as defined herein, containing one, two, three, or four non-carbon heteroatoms (e.g., independently selected from the group consisting of nitrogen, oxygen, phosphorous, sulfur, selenium, or halo). The heteroalkylene group can be saturated or unsaturated (e.g., having one or more double bonds or triple bonds). The heteroalkylene group can be substituted or unsubstituted. For example, the heteroalkylene group can be substituted with one or more substitution groups, as described herein for alkyl.

By “heteroaryl” is meant a subset of heterocyclyl groups, as defined herein, which are aromatic, i.e., they contain 4n+2 pi electrons within the mono- or multicyclic ring system.

The term “heterocycloalkyl” is a type of cycloalkyl group as defined above where at least one of the carbon atoms and its attached hydrogen atoms, if any, are replaced by O, S, N, or NH. The heterocycloalkyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, aldehyde, amino, carboxylic acid, sulfonic acid, sulfinic acid, fluoroacid, phosphonic acid, ester, ether, halide, hydroxy, ketone, nitro, cyano, azido, silyl, sulfonyl, sulfinyl, or thiol, as described herein.

By “heterocycle” is meant a compound having one or more heterocyclyl moieties. Non-limiting heterocycles include optionally substituted imidazole, optionally substituted triazole, optionally substituted tetrazole, optionally substituted pyrazole, optionally substituted imidazoline, optionally substituted pyrazoline, optionally substituted imidazolidine, optionally substituted pyrazolidine, optionally substituted pyrrole, optionally substituted pyrroline, optionally substituted pyrrolidine, optionally substituted tetrahydrofuran, optionally substituted furan, optionally substituted thiophene, optionally substituted oxazole, optionally substituted isoxazole, optionally substituted isothiazole, optionally substituted thiazole, optionally substituted oxathiolane, optionally substituted oxadiazole, optionally substituted thiadiazole, optionally substituted sulfolane, optionally substituted succinimide, optionally substituted thiazolidinedione, optionally substituted oxazolidone, optionally substituted hydantoin, optionally substituted pyridine, optionally substituted piperidine, optionally substituted pyridazine, optionally substituted piperazine, optionally substituted pyrimidine, optionally substituted pyrazine, optionally substituted triazine, optionally substituted pyran, optionally substituted pyrylium, optionally substituted tetrahydropyran, optionally substituted dioxine, optionally substituted dioxane, optionally substituted dithiane, optionally substituted trithiane, optionally substituted thiopyran, optionally substituted thiane, optionally substituted oxazine, optionally substituted morpholine, optionally substituted thiazine, optionally substituted thiomorpholine, optionally substituted cytosine, optionally substituted thymine, optionally substituted uracil, optionally substituted thiomorpholine dioxide, optionally substituted indene, optionally substituted indoline, optionally substituted indole, optionally substituted isoindole, optionally substituted indolizine, optionally substituted indazole, optionally substituted benzimidazole, optionally substituted azaindole, optionally substituted azaindazole, optionally substituted pyrazolopyrimidine, optionally substituted purine, optionally substituted benzofuran, optionally substituted isobenzofuran, optionally substituted benzothiophene, optionally substituted benzisoxazole, optionally substituted anthranil, optionally substituted benzisothiazole, optionally substituted benzoxazole, optionally substituted benzthiazole, optionally substituted benzthiadiazole, optionally substituted adenine, optionally substituted guanine, optionally substituted tetrahydroquinoline, optionally substituted dihydroquinoline, optionally substituted dihydroisoquinoline, optionally substituted quinoline, optionally substituted isoquinoline, optionally substituted quinolizine, optionally substituted quinoxaline, optionally substituted phthalazine, optionally substituted quinazoline, optionally substituted cinnoline, optionally substituted naphthyridine, optionally substituted pyridopyrimidine, optionally substituted pyridopyrazine, optionally substituted pteridine, optionally substituted chromene, optionally substituted isochromene, optionally substituted chromenone, optionally substituted benzoxazine, optionally substituted quinolinone, optionally substituted isoquinolinone, optionally substituted carbazole, optionally substituted dibenzofuran, optionally substituted acridine, optionally substituted phenazine, optionally substituted phenoxazine, optionally substituted phenothiazine, optionally substituted phenoxathiine, optionally substituted quinuclidine, optionally substituted azaadamantane, optionally substituted dihydroazepine, optionally substituted azepine, optionally substituted diazepine, optionally substituted oxepane, optionally substituted thiepine, optionally substituted thiazepine, optionally substituted azocane, optionally substituted azocine, optionally substituted thiocane, optionally substituted azonane, optionally substituted azecine, etc. Optional substitutions include any described herein for aryl. Heterocycles can also include cations and/or salts of any of these (e.g., any described herein, such as optionally substituted piperidinium, optionally substituted pyrrolidinium, optionally substituted pyrazolium, optionally substituted imidazolium, optionally substituted pyridinium, optionally substituted quinolinium, optionally substituted isoquinolinium, optionally substituted acridinium, optionally substituted phenanthridinium, optionally substituted pyridazinium, optionally substituted pyrimidinium, optionally substituted pyrazinium, optionally substituted phenazinium, or optionally substituted morpholinium).

By “heterocyclyl” is meant a 3-, 4-, 5-, 6- or 7-membered ring (e.g., a 5-, 6- or 7-membered ring), unless otherwise specified, containing one, two, three, or four non-carbon heteroatoms (e.g., independently selected from the group consisting of nitrogen, oxygen, phosphorous, sulfur, selenium, or halo). The 3-membered ring has zero to one double bonds, the 4- and 5-membered ring has zero to two double bonds, and the 6- and 7-membered rings have zero to three double bonds. The term “heterocyclyl” also includes bicyclic, tricyclic and tetracyclic groups in which any of the above heterocyclic rings is fused to one, two, or three rings independently selected from the group consisting of an aryl ring, a cyclohexane ring, a cyclohexene ring, a cyclopentane ring, a cyclopentene ring, and another monocyclic heterocyclic ring, such as indolyl, quinolyl, isoquinolyl, tetrahydroquinolyl, benzofuryl, benzothienyl and the like. Heterocyclics include acridinyl, adenyl, alloxazinyl, azaadamantanyl, azabenzimidazolyl, azabicyclononyl, azacycloheptyl, azacyclooctyl, azacyclononyl, azahypoxanthinyl, azaindazolyl, azaindolyl, azecinyl, azepanyl, azepinyl, azetidinyl, azetyl, aziridinyl, azirinyl, azocanyl, azocinyl, azonanyl, benzimidazolyl, benzisothiazolyl, benzisoxazolyl, benzodiazepinyl, benzodiazocinyl, benzodihydrofuryl, benzodioxepinyl, benzodioxinyl, benzodioxanyl, benzodioxocinyl, benzodioxolyl, benzodithiepinyl, benzodithiinyl, benzodioxocinyl, benzofuranyl, benzophenazinyl, benzopyranonyl, benzopyranyl, benzopyrenyl, benzopyronyl, benzoquinolinyl, benzoquinolizinyl, benzothiadiazepinyl, benzothiadiazolyl, benzothiazepinyl, benzothiazocinyl, benzothiazolyl, benzothienyl, benzothiophenyl, benzothiazinonyl, benzothiazinyl, benzothiopyranyl, benzothiopyronyl, benzotriazepinyl, benzotriazinonyl, benzotriazinyl, benzotriazolyl, benzoxathiinyl, benzotrioxepinyl, benzoxadiazepinyl, benzoxathiazepinyl, benzoxathiepinyl, benzoxathiocinyl, benzoxazepinyl, benzoxazinyl, benzoxazocinyl, benzoxazolinonyl, benzoxazolinyl, benzoxazolyl, benzylsultamyl benzylsultimyl, bipyrazinyl, bipyridinyl, carbazolyl (e.g., 4H-carbazolyl), carbolinyl (e.g., β-carbolinyl), chromanonyl, chromanyl, chromenyl, cinnolinyl, coumarinyl, cytdinyl, cytosinyl, decahydroisoquinolinyl, decahydroquinolinyl, diazabicyclooctyl, diazetyl, diaziridinethionyl, diaziridinonyl, diaziridinyl, diazirinyl, dibenzisoquinolinyl, dibenzoacridinyl, dibenzocarbazolyl, dibenzofuranyl, dibenzophenazinyl, dibenzopyranonyl, dibenzopyronyl (xanthonyl), dibenzoquinoxalinyl, dibenzothiazepinyl, dibenzothiepinyl, dibenzothiophenyl, dibenzoxepinyl, dihydroazepinyl, dihydroazetyl, dihydrofuranyl, dihydrofuryl, dihydroisoquinolinyl, dihydropyranyl, dihydropyridinyl, dihydroypyridyl, dihydroquinolinyl, dihydrothienyl, dihydroindolyl, dioxanyl, dioxazinyl, dioxindolyl, dioxiranyl, dioxenyl, dioxinyl, dioxobenzofuranyl, dioxolyl, dioxotetrahydrofuranyl, dioxothiomorpholinyl, dithianyl, dithiazolyl, dithienyl, dithiinyl, furanyl, furazanyl, furoyl, furyl, guaninyl, homopiperazinyl, homopiperidinyl, hypoxanthinyl, hydantoinyl, imidazolidinyl, imidazolinyl, imidazolyl, indazolyl (e.g., 1H-indazolyl), indolenyl, indolinyl, indolizinyl, indolyl (e.g., 1H-indolyl or 3H-indolyl), isatinyl, isatyl, isobenzofuranyl, isochromanyl, isochromenyl, isoindazoyl, isoindolinyl, isoindolyl, isopyrazolonyl, isopyrazolyl, isoxazolidiniyl, isoxazolyl, isoquinolinyl, isoquinolinyl, isothiazolidinyl, isothiazolyl, morpholinyl, naphthindazolyl, naphthindolyl, naphthiridinyl, naphthopyranyl, naphthothiazolyl, naphthothioxolyl, naphthotriazolyl, naphthoxindolyl, naphthyridinyl, octahydroisoquinolinyl, oxabicycloheptyl, oxauracil, oxadiazolyl, oxazinyl, oxaziridinyl, oxazolidinyl, oxazolidonyl, oxazolinyl, oxazolonyl, oxazolyl, oxepanyl, oxetanonyl, oxetanyl, oxetyl, oxtenayl, oxindolyl, oxiranyl, oxobenzoisothiazolyl, oxochromenyl, oxoisoquinolinyl, oxoquinolinyl, oxothiolanyl, phenanthridinyl, phenanthrolinyl, phenazinyl, phenothiazinyl, phenothienyl (benzothiofuranyl), phenoxathiinyl, phenoxazinyl, phthalazinyl, phthalazonyl, phthalidyl, phthalimidinyl, piperazinyl, piperidinyl, piperidonyl (e.g., 4-piperidonyl), pteridinyl, purinyl, pyranyl, pyrazinyl, pyrazolidinyl, pyrazolinyl, pyrazolopyrimidinyl, pyrazolyl, pyridazinyl, pyridinyl, pyridopyrazinyl, pyridopyrimidinyl, pyridyl, pyrimidinyl, pyrimidyl, pyronyl, pyrrolidinyl, pyrrolidonyl (e.g., 2-pyrrolidonyl), pyrrolinyl, pyrrolizidinyl, pyrrolyl (e.g., 2H-pyrrolyl), pyrylium, quinazolinyl, quinolinyl, quinolizinyl (e.g., 4H-quinolizinyl), quinoxalinyl, quinuclidinyl, selenazinyl, selenazolyl, selenophenyl, succinimidyl, sulfolanyl, tetrahydrofuranyl, tetrahydrofuryl, tetrahydroisoquinolinyl, tetrahydroisoquinolyl, tetrahydropyridinyl, tetrahydropyridyl (piperidyl), tetrahydropyranyl, tetrahydropyronyl, tetrahydroquinolinyl, tetrahydroquinolyl, tetrahydrothienyl, tetrahydrothiophenyl, tetrazinyl, tetrazolyl, thiadiazinyl (e.g., 6H-1,2,5-thiadiazinyl or 2H,6H-1,5,2-dithiazinyl), thiadiazolyl, thianthrenyl, thianyl, thianaphthenyl, thiazepinyl, thiazinyl, thiazolidinedionyl, thiazolidinyl, thiazolyl, thienyl, thiepanyl, thiepinyl, thietanyl, thietyl, thiiranyl, thiocanyl, thiochromanonyl, thiochromanyl, thiochromenyl, thiodiazinyl, thiodiazolyl, thioindoxyl, thiomorpholinyl, thiophenyl, thiopyranyl, thiopyronyl, thiotriazolyl, thiourazolyl, thioxanyl, thioxolyl, thymidinyl, thyminyl, triazinyl, triazolyl, trithianyl, urazinyl, urazolyl, uretidinyl, uretinyl, uricyl, uridinyl, xanthenyl, xanthinyl, xanthionyl, and the like, as well as modified forms thereof (e.g., including one or more oxo and/or amino) and salts thereof. The heterocyclyl group can be substituted or unsubstituted. For example, the heterocyclyl group can be substituted with one or more substitution groups, as described herein for aryl.

By “heterocyclyldiyl” is meant a bivalent form of a heterocyclyl group, as described herein. In one instance, the heterocyclyldiyl is formed by removing a hydrogen from a heterocyclyl group. Exemplary heterocyclyldiyl groups include piperdylidene, quinolinediyl, etc. The heterocyclyldiyl group can also be substituted or unsubstituted. For example, the heterocyclyldiyl group can be substituted with one or more substitution groups, as described herein for heterocyclyl.

By “hydroxyl” is meant an —OH group.

By “hydroxyalkyl” is meant an alkyl group, as defined herein, substituted with one or more hydroxyl.

By “hydroxyalkylene” is meant an alkylene group, as defined herein, substituted with one or more hydroxy.

By “homopolymer” is meant a polymer composed of a single type of repeat unit, while a copolymer is formed from different repeating units.

By “nitro” is meant an —NO₂ group.

By “phosphate” is meant a group derived from phosphoric acid. One example of phosphate includes a —O—P(═O)(OR^{P1})(OR^{P2}) or —O—[P(═O)(OR″)—O]_{P3}—R^{P2} group, where each of R^{P1} and R^{P2}, is, independently, H, optionally substituted alkyl, optionally substituted alkenyl, optionally substituted aryl, or optionally substituted arylalkylene, and where P3 is an integer from 1 to 5. Yet other examples of phosphate include orthophosphoric acid, pyrophosphoric acid, tripolyphosphoric acid, tetrapolyphosphoric acid, trimetaphosphoric acid, and/or phosphoric anhydride, or combinations thereof.

By “phosphono” or “phosphonic acid” is meant a —P(O)(OH)₂ group.

By “spirocyclyl” is meant an alkylene diradical, both ends of which are bonded to the same carbon atom of the parent group to form a spirocyclyl group and also a heteroalkylene diradical, both ends of which are bonded to the same atom. Non-limiting alkylene and heteroalkylene groups for use within a spirocyclyl group includes C₂₋₁₂, C₂₋₁₁, C₂₋₁₀, C₂₋₉, C₂₋₈, C₂₋₇, C₂₋₆, C₂₋₅, C₂₋₄, or C₂₋₃ alkylene groups, as well as C₁₋₁₂, C₁₋₁₁, C₁₋₁₀, C₁₋₉, C₁₋₈, C₁₋₇, C₁₋₆, C₁₋₅, C₁₋₄, C₁₋₃, or C₁₋₂ heteroalkylene groups having one or more heteroatoms.

By “sulfate” is meant a group derived from sulfuric acid. One example of sulfate includes a —O—S(═O)₂(OR^{S1}) group, where R^{S1} is H, optionally substituted alkyl, optionally substituted alkenyl, optionally substituted aryl, or optionally substituted arylalkylene.

By “sulfo” or “sulfonic acid” is meant an —S(O)₂OH group.

By “sulfonyl” is meant an —S(O)₂— or —S(O)₂R group, in which R can be H, optionally substituted alkyl, or optionally substituted aryl. Non-limiting sulfonyl groups can include a trifluoromethylsulfonyl group (—SO₂—CF₃ or Tf).

By “thiocyanato” is meant an —SCN group.

By “salt” is meant an ionic form of a compound or structure (e.g., any formulas, compounds, or compositions described herein), which includes a cation or anion compound to form an electrically neutral compound or structure. Salts are well known in the art. For example, non-toxic salts are described in Berge S M et al., “Pharmaceutical salts,” J. Pharm. Sci. 1977 January; 66(1):1-19; and in “Handbook of Pharmaceutical Salts: Properties, Selection, and Use,” Wiley-VCH, April 2011 (2nd rev. ed., eds. P. H. Stahl and C. G. Wermuth. The salts can be prepared in situ during the final isolation and purification of the compounds of the invention or separately by reacting the free base group with a suitable organic acid (thereby producing an anionic salt) or by reacting the acid group with a suitable metal or organic salt (thereby producing a cationic salt). Representative anionic salts include acetate, adipate, alginate, ascorbate, aspartate, benzenesulfonate, benzoate, bicarbonate, bisulfate, bitartrate, borate, bromide, butyrate, camphorate, camphorsulfonate, chloride, citrate, cyclopentanepropionate, digluconate, dihydrochloride, diphosphate, dodecylsulfate, edetate, ethanesulfonate, fumarate, glucoheptonate, gluconate, glutamate, glycerophosphate, hemisulfate, heptonate, hexanoate, hydrobromide, hydrochloride, hydroiodide, hydroxyethanesulfonate, hydroxynaphthoate, iodide, lactate, lactobionate, laurate, lauryl sulfate, malate, maleate, malonate, mandelate, mesylate, methanesulfonate, methylbromide, methylnitrate, methylsulfate, mucate, 2-naphthalenesulfonate, nicotinate, nitrate, oleate, oxalate, palmitate, pamoate, pectinate, persulfate, 3-phenylpropionate, phosphate, picrate, pivalate, polygalacturonate, propionate, salicylate, stearate, subacetate, succinate, sulfate, tannate, tartrate, theophyllinate, thiocyanate, triethiodide, toluenesulfonate, undecanoate, valerate salts, and the like. Representative cationic salts include metal salts, such as alkali or alkaline earth salts, e.g., barium, calcium (e.g., calcium edetate), lithium, magnesium, potassium, sodium, and the like; other metal salts, such as aluminum, bismuth, iron, and zinc; as well as nontoxic ammonium, quaternary ammonium, and amine cations, including, but not limited to ammonium, tetramethylammonium, tetraethylammonium, methylamine, dimethylamine, trimethylamine, triethylamine, ethylamine, pyridinium, and the like. Other cationic salts include organic salts, such as chloroprocaine, choline, dibenzylethylenediamine, diethanolamine, ethylenediamine, methylglucamine, and procaine. Yet other salts include ammonium, sulfonium, sulfoxonium, phosphonium, iminium, imidazolium, benzimidazolium, amidinium, guanidinium, phosphazinium, phosphazenium, pyridinium, etc., as well as other cationic groups described herein (e.g., optionally substituted isoxazolium, optionally substituted oxazolium, optionally substituted thiazolium, optionally substituted pyrrolium, optionally substituted furanium, optionally substituted thiophenium, optionally substituted imidazolium, optionally substituted pyrazolium, optionally substituted isothiazolium, optionally substituted triazolium, optionally substituted tetrazolium, optionally substituted furazanium, optionally substituted pyridinium, optionally substituted pyrimidinium, optionally substituted pyrazinium, optionally substituted triazinium, optionally substituted tetrazinium, optionally substituted pyridazinium, optionally substituted oxazinium, optionally substituted pyrrolidinium, optionally substituted pyrazolidinium, optionally substituted imidazolinium, optionally substituted isoxazolidinium, optionally substituted oxazolidinium, optionally substituted piperazinium, optionally substituted piperidinium, optionally substituted morpholinium, optionally substituted azepanium, optionally substituted azepinium, optionally substituted indolium, optionally substituted isoindolium, optionally substituted indolizinium, optionally substituted indazolium, optionally substituted benzimidazolium, optionally substituted isoquinolinum, optionally substituted quinolizinium, optionally substituted dehydroquinolizinium, optionally substituted quinolinium, optionally substituted isoindolinium, optionally substituted benzimidazolinium, and optionally substituted purinium). Yet other salts can include an anion, such as a halide (e.g., F⁻, Cl⁻, Br⁻, or I⁻), a hydroxide (e.g., OH⁻), a borate (e.g., tetrafluoroborate (BF₄), a carbonate (e.g., CO₃² or HCO₃), or a sulfate (e.g., SO₄²).

By “leaving group” is meant an atom (or a group of atoms) with electron withdrawing ability that can be displaced as a stable species, taking with it the bonding electrons, or an atom (or a group of atoms) that can be replaced by a substitution reaction. Examples of suitable leaving groups include H, halides, and sulfonates including, but not limited to, triflate (—OTf), mesylate (—OMs), tosylate (—OTs), brosylate (—OBs), acetate, Cl, Br, and I.

By “attaching,” “attachment,” or related word forms is meant any covalent or non-covalent bonding interaction between two components. Non-covalent bonding interactions include, without limitation, hydrogen bonding, ionic interactions, halogen bonding, electrostatic interactions, π bond interactions, hydrophobic interactions, inclusion complexes, clathration, van der Waals interactions, and combinations thereof.

An “electrochemical cell” includes electrolyzers such as CO₂ electrolyzers and water electrolyzers. It also includes some forms of CO₂ purifiers, particularly those that employ faradaic reactions at an anode and/or a cathode.

A “carbon oxide” includes carbon dioxide (CO₂), carbon monoxide (CO), carbonate ions (CO₃²⁻), bicarbonate ions (HCO₃⁻), and any combinations thereof.

A “mixture” contains two or more components and unless otherwise stated may contain components other than the identified components.

A “CO₂ purifier” is a device configured to purify CO₂ from an impure CO₂ source or feed stream. There are various types of CO₂ purifier that employ various operating principles. Some purifiers rely on a CO₂ sorbent that selectively binds to CO₂ under a first condition and releases purified CO₂ under second condition. Because these purifiers operate in different phases between which process conditions “swing,” such purifiers are sometimes referred to as “swing” devices. Examples include temperature swing devices, pressure swing devices, and electro-swing devices. Because of its function, a CO₂ purifier is sometimes referred to as a CO₂ separator or as a CO₂ scrubber.

### Introduction and Context

Aspects of this disclosure relate to a CO₂ purifier and integration of a CO₂ purifier with a CO₂ electrolyzer. In operation, the CO₂ purifier selectively concentrates CO₂ in an inlet source. The CO₂ purifier selectively captures CO₂ from a gas stream and then releases purified CO₂ as an output. The purified CO₂ is then provided as an input to the cathode of the CO₂ electrolyzer. The CO₂ electrolyzer can electrochemically reduce the CO₂ to a carbon-containing product (CCP) that may be stored, consumed, used to synthesize a valuable product, etc.

Various types of CO₂ purifier may be employed. In some embodiments, the purifier employs a polymer that selectively absorbs CO₂ and subsequently releases the CO₂. The purifier allows at least some non-CO₂ inlet components to pass through without being absorbed. Depending on the composition of the inlet stream, examples of non-absorbed components include water, nitrogen, carbon monoxide, oxygen, sulfur-containing compounds, and the like.

In some implementations, a CO₂-absorbing polymer is a solid or gel. It may be immobilized or otherwise held stationary in the purifier. As an example, such polymer may form a layer or membrane. In some implementations, a CO₂-absorbing polymer is mobile within a CO₂ purifier. For example, the polymer may be provided as a melt or solution. In some embodiments, during operation of the CO₂ purifier, the mobile polymer moves between a cathode compartment, where it absorbs CO₂, and an anode compartment, where it releases CO₂.

Some polymers employed in CO₂ purifiers contain moieties to selectively capture CO₂ from an inlet stream and release purified carbon dioxide in an outlet stream. The capture and release involve exposing the polymers to different conditions, which may be, for example, different electrical potential. Generally, moieties that, in response to changing electrical environments, capture and release a target compound such as CO₂ are sometimes referred to as “electroactive” moieties.

Processes that capture a target species under one condition and release the species under a different condition may expose CO₂-absorbing moieties to the different conditions and may be implemented in various ways. In one class of purifier the moieties are immobilized or otherwise stationary and they are exposed to alternating conditions. Such processes are sometimes referred to as “swing” processes. One example is an electroswing process.

In some examples, a CO₂ purifier comprises a polymer having CO₂-binding electroactive moieties that can react with CO₂ to form carbonates, carboxylates, or other reduction products. In various implementations, the electroactive moieties do not react with oxygen, nitrogen, water, and/or certain other components of certain CO₂-containing input streams. Subsequently the CO₂-containing moieties can be oxidized to release CO₂ and return the electroactive moieties to their original state. The CO₂-binding reaction may be performed reversibly.

In some implementations, the CO₂-binding moieties reversibly capture and release CO₂ in response to changes in applied electrical potential. The binding and release reactions may be redox reactions. CO₂ purifiers employing such moieties may be operated in a cathodic phase in which CO₂ binds to the electroactive moieties and an anodic phase in which CO₂ releases from the electroactive moieties. This is an example of an electroswing operation. Alternatively, CO₂ purifiers employing such moieties may be operated by transporting the moieties from a first location having a cathodic potential to a second location having an anodic potential.

In some implementations, polymers having CO₂-binding moieties employ a polymer backbone with pendant electroactive moieties. Examples of CO₂-binding electroactive moieties include thiolates, 4,4′-dipyridinyl groups, and quinones. The mechanism for quinone-type moieties involves temporarily forming carbonate groups when CO₂ is captured. And then when CO₂ is released, converting the carbonate groups back to the quinone's characteristic cyclic dione structure.

Polymers with CO₂-binding electroactive moieties

The present disclosure relates to electroactive polymers, and compositions thereof. In some embodiments, the compositions may include at least one polymer including an electroactive moiety.

Accordingly, in one embodiment, the composition includes a polymeric composition including at least one polymer formed from moieties of the formula

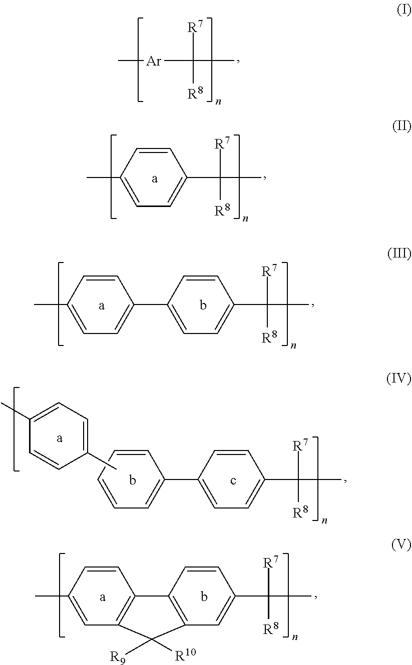

or combinations thereof, wherein
each of R⁷ and R⁸ is independently an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, wherein at least one of R⁷ or R⁸ is an electron-withdrawing moiety; each of R⁹ and R¹⁰ is, independently, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R⁹ and R¹⁰ can be taken together to form an optionally substituted cyclic group; Ar is an optionally substituted aromatic or optionally substituted arylene; n is an integer of 1 or more; each of ring a, ring b, and ring c can be independently optionally substituted; and one or more of R⁷, R⁸, R⁹, and R¹⁰ is optionally an electroactive moiety, wherein the electroactive moiety is a moiety that reversibly reacts with a Lewis acidic gas.

In some embodiments, the compositions may include at least one first polymer and at least one second polymer, in which at least one of the polymers includes an electroactive moiety. In some embodiments, both of the first and second polymers include an electroactive moiety.

In some embodiments, the polymeric composition includes at least one first polymer and at least one second polymer, wherein:
(i) the first polymer is of moieties of the formula

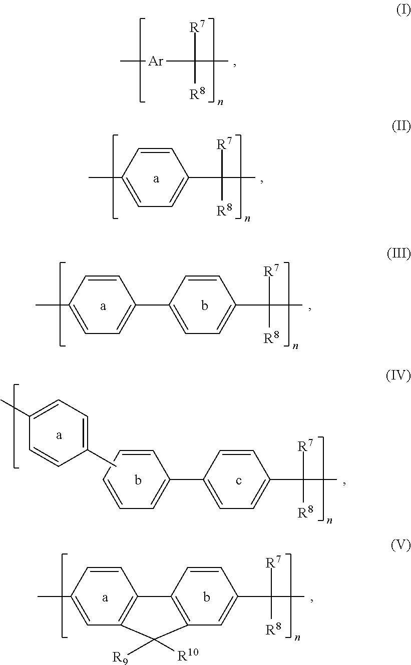

or combinations thereof, wherein
each of R⁷ and R⁸ is independently an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, wherein at least one of R⁷ or R⁸ comprises an electron-withdrawing moiety; each of R⁹ and R¹⁰ is, independently, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R⁹ and R¹⁰ can be taken together to form an optionally substituted cyclic group; Ar is an optionally substituted aromatic or optionally substituted arylene; n is an integer of 1 or more; each of ring a, ring b, and ring c can be independently optionally substituted; and one or more of R⁷, R⁸, R⁹, and R¹⁰ is optionally an electroactive moiety, wherein the electroactive moiety is a moiety that reversibly reacts with a Lewis acidic gas; and
   (ii) the second polymer is of moieties of the formula

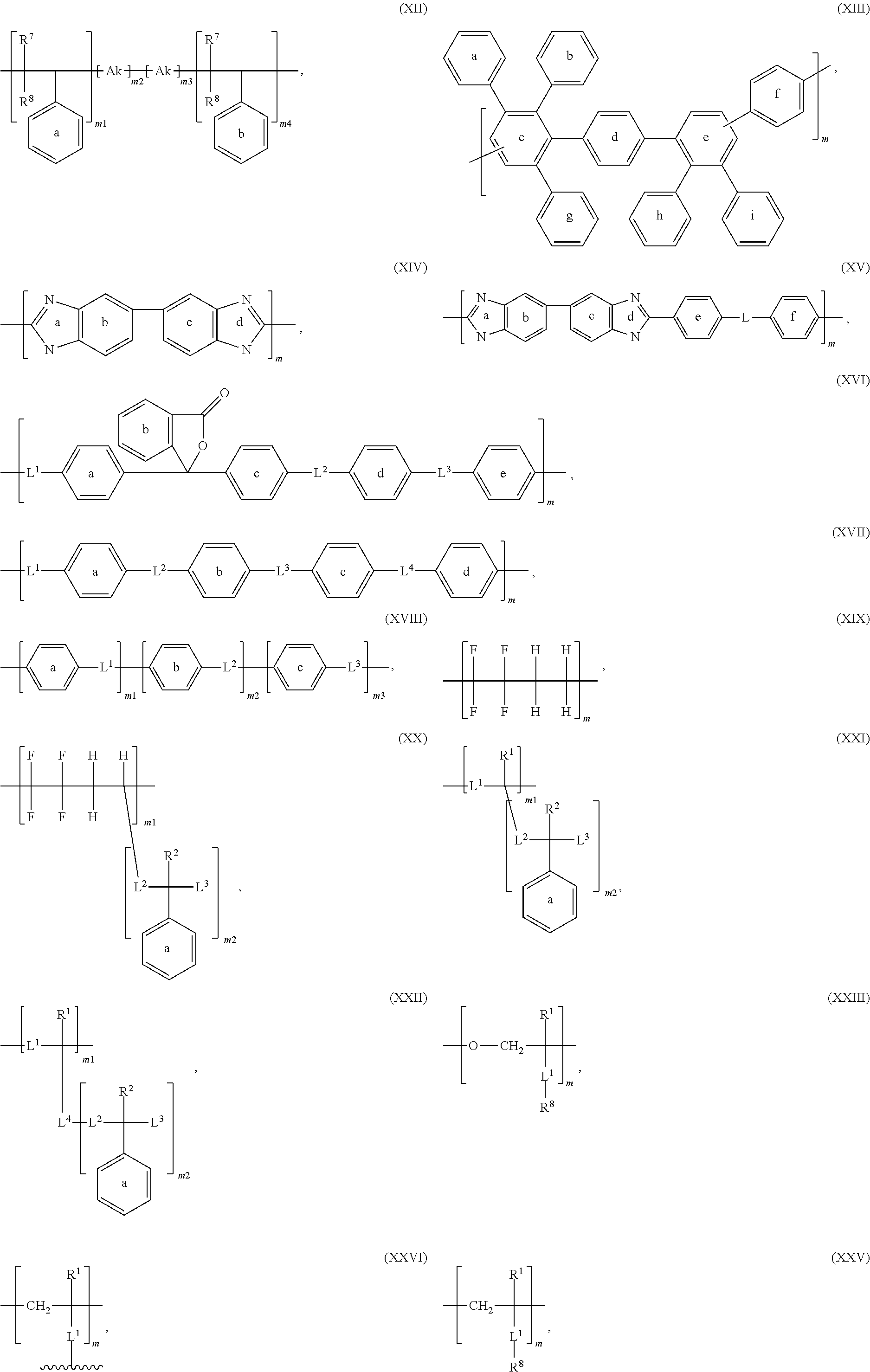

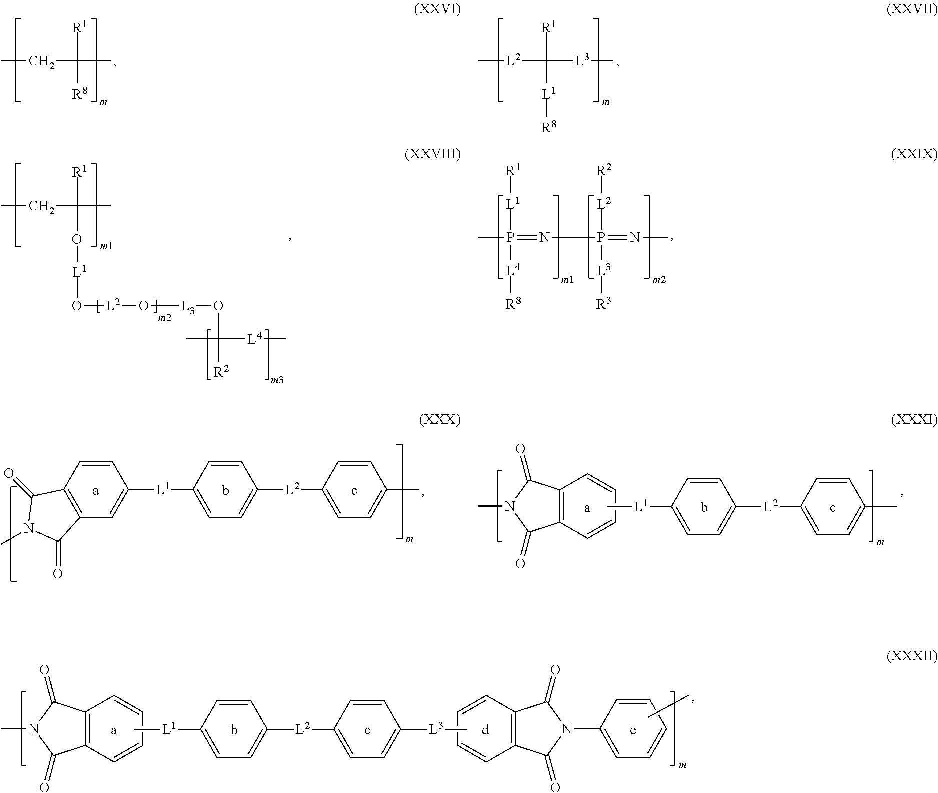

and
combinations thereof, wherein
   each of R¹, R², R³, R⁷, and R⁸ is independently an electron-withdrawing moiety, H, optionally substituted aliphatic, optionally substituted alkyl, optionally substituted heteroaliphatic, optionally substituted heteroalkyl, optionally substituted aromatic, optionally substituted aryl, optionally substituted aryloxy, or optionally substituted arylalkylene, wherein R⁷ and R⁸ can be taken together to form an optionally substituted cyclic group; each Ak is an optionally substituted alkylene; each of L, L¹, L², L³, and L⁴ is, independently, a linking moiety;
   each of m, m1, m2, m3, and m4 is, independently, an integer of 1 or more; each of rings a-i can be optionally substituted; and wherein one or more of rings a-i, R⁷, and R⁸ is optionally an electroactive moiety, wherein the electroactive moiety is a moiety that reversibly reacts with a Lewis acidic gas.

Suitable compositions can include any combination of a first polymer (e.g., one formed from moieties of one or more of formulas (I-V)) and a second polymer (e.g., one formed from moieties of one or more of formulas (XII)-(XXXII)), as described herein. By using two different polymers, the properties of the composition can be tuned to satisfy specific operational parameters. The polymers can be homopolymers, copolymers, block copolymers, or other useful combinations of repeating monomeric units.

The composition can include a polymer formed from moieties (e.g., any described herein, such as one or more of formulas (I-V)). For instance, the composition can include a plurality of first polymers, in which each first polymer is the same (e.g., each Ar, R⁷-R¹⁰, and rings a-c, if present, is identical in each monomeric unit). In another instance, the composition can include a plurality of first polymers, in which at least two of the first polymers are different (e.g., at least one of Ar, R⁷-R¹⁰, and rings a-c, if present, is different between two monomeric units). Accordingly, even if the composition only includes polymers characterized as a first polymer, the composition can be a homopolymer, a copolymer, a block copolymer, or other useful combinations of repeating monomeric units.

The compositions herein can include any useful combination of repeating monomeric units. In one instance, the composition can include -A-A-A- or -[A]-, in which A represent a monomeric unit and [A] represents a block including solely A monomeric units. A can be selected from those provided as a first or a second structure.

In another instance, the composition includes -[A]-[A-combination-B]-[B]-, in which A and B represents different monomeric units. [A] and [B] represent polymer blocks comprised solely of A monomeric units and solely B monomeric units, respectively. The [A-combination-B]block implies a block including some combination of A and B monomeric units. Each of A and B can be selected from those provided as a first and/or a second structure. In some embodiments, A and B are both first polymer types (e.g., selected from formulas (I-V)). In other embodiments, A is a first polymer (e.g., selected from formulas (I-V)), and B is a second polymer (e.g., selected from formulas (XII)-(XXXII)).

In another instance, the composition includes at least one alternating/periodic block, in which the different monomers have an ordered sequence, e.g., -[A-B-A-B- . . . ]-, -[A-B-C-A-B-C- . . . ]-, -[A-A-B-B-A-A-B-B- . . . ]-, -[A-A-B-A-A-B- . . . ]-, -[A-B-A-B-B-A-A-A-A-B-B-B- . . . ]-, etc. A, B, and C represent different monomeric units. The square bracketed examples represent polymer blocks, wherein the monomer sequence is repeated throughout the block. Each of A, B, and C can be selected from those provided as a first and/or a second structure (e.g., each of A, B, and C includes or is, independently, a structure of formulas (I)—(V) or (XII)-(XXXII)). In some embodiments, each of A, B, and C is a first structure (e.g., selected from formulas (I-V)). In other embodiments, A is a first structure (e.g., selected from formulas (I-V)), B is a second structure (e.g., selected from formulas (XII)-(XXXII)), and C is a first or second structure (e.g., selected from formulas (I-V) or (XII)-(XXXII)).

In yet another instance, the composition includes a particular unit that is covalently bonded between at least one pair of blocks, e.g., [A]-D-[B] or [A]-D-[B]—[C], in which D can be a monomeric unit or a linking moiety (e.g., any described herein). More than one D can be present, such as in [A]-D-D-[B] or [A]-D-D-D-[B], in which each C can be the same or different. [A] represents a block comprising solely A monomeric units; [B] represents a block comprising solely B monomeric units; [C] represents a block comprising solely C monomeric units; and D can represent individual monomer units (e.g., any described herein) or linking moieties (any described herein). Each of A, B, and C can be selected from those provided as a first and/or a second structure (e.g., each of A, B, and C includes or is, independently, a structure of formulas (I)—(V) or (XII)-(XXXII)). D can be selected from those provided as a first and/or a second polymer (e.g., selected from formulas (I)—(V) or (XII)-(XXXII)) or provided as a linking moiety (e.g., L).

Other alternative configurations are also encompassed by the compositions herein, such as branched configurations, diblock copolymers, triblock copolymers, random or statistical copolymers, stereoblock copolymers, gradient copolymers, graft copolymers, and combinations of any blocks or regions described herein.

The compositions herein can be characterized by a first molecular weight (MW) of the first polymer, a second MW of the second polymer, or a total MW of the composition. In one embodiment, the first MW, second MW, or total M is a weight-average molecular weight (Mw) of at least 10,000 g/mol, at least 20,000 g/mol, or at least 50,000 g/mol; or from about 5,000 to 2,500,000 g/mol, such as from 10,000 to 2,500,000 g/mol, from 50,000 to 2,500,000 g/mol, from 10,000 to 250,000 g/mol, from 20,000 to 250,000 g/mol, or from 20,000 to 200,000 g/mol. In another embodiment, the first MW, second MW, or total MW is a number average molecular weight (Mn) of at least 20,000 g/mol or at least 40,000 g/mol; or from about 2,000 to 2,500,000 g/mol, such as from 5,000 to 750,000 g/mol or from 10,000 to 400,000 g/mol.

The compositions can include any useful number n, m, m1, m2, m3, or m4 of monomeric units. Non-limiting examples for each of n, m, m1, m2, m3, and m4 is, independently, 1 or more, 20 or more, 50 or more, 100 or more; as well as from 1 to 1,000,000, such as from 10 to 1,000,000, from 100 to 1,000,000, from 200 to 1,000,000, from 500 to 1,000,000, or from 1,000 to 1,000,000. For example, with regard to the structure of formulas (I)—(V), n can be 1 when the polymer is made up of a combination of structures, but when the polymer is a homopolymer, n will be at least 4. Similarly, with regard to the structures of formulas (XII)-(XXXII), n can be 1 when the polymer is made up of a combination of structures, but when the polymer is a homopolymer, m will be at least 4.

### First Polymers

Within the composition, the first polymer can include a monomeric unit, which in turn can include one or more electroactive moieties, wherein the electroactive moiety is a moiety that reversibly reacts with a Lewis acidic gas.

In non-limiting embodiments, the polymer can have an arylene-containing backbone, which provides an organic scaffold upon which electroactive moieties can be added.

Accordingly, in some non-limiting embodiments, the first polymer includes a structure (e.g., any described herein) having an electroactive moiety and an electron-withdrawing group. In some instances, the polymer is formed by using one or more monomeric units. Non-limiting monomeric units can include one or more of the following:

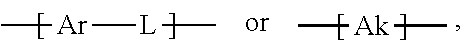

in which Ar is an optionally substituted arylene or optionally substituted aromatic; Ak is an optionally substituted alkylene, optionally substituted haloalkylene, optionally substituted heteroalkylene, optionally substituted aliphatic, or optionally substituted heteroaliphatic; and L is a linking moiety (e.g., any described herein) or can be —C(R⁷)(R⁸)— (e.g., for any R⁷ and R⁸ groups described herein). In particular examples, Ar, L, and/or Ak can be optionally substituted with one or more electroactive moieties and/or one or more electron-withdrawing groups.

Further substitutions for ring a, ring b, ring c, R⁷, and R⁸ can include one or more optionally substituted arylene, as well as any described herein for alkyl or aryl. Non-limiting examples of Ar include, e.g., phenylene (e.g., 1,4-phenylene, 1,3-phenylene, etc.), biphenylene (e.g., 4,4′-biphenylene, 3,3′-biphenylene, 3,4′-biphenylene, etc.), terphenylene (e.g., 4,4′-terphenylene), triphenylene, diphenyl ether, anthracene (e.g., 9,10-anthracene), naphthalene (e.g., 1,5-naphthalene, 1,4-naphthalene, 2,6-naphthalene, 2,7-naphthalene, etc.), tetrafluorophenylene (e.g., 1,4-tetrafluorophenylene, 1,3-tetrafluorophenylene), and the like, as well as others described herein.

The first polymer can include moieties having an electron-withdrawing moiety and a fluorenyl-based backbone. For instance, the first polymer can include a moiety as follows:

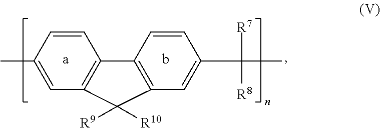

or a salt thereof, wherein:
each of R⁷ and R⁸ is, independently, an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, wherein at least one of R⁷ or R⁸ includes the electron-withdrawing moiety;
each of R⁹ and R¹⁰ is, independently, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R⁹ and R¹⁰ can be taken together to form an optionally substituted cyclic group;
   n is, independently, an integer of 1 or more;
   each of rings a and b can be optionally substituted; and
   wherein one or more of rings a and b, R⁷, R⁸, R⁹, and R¹⁰ can optionally include an electroactive moiety, wherein the electroactive moiety is a moiety that reversibly reacts with a Lewis acidic gas.

In particular embodiments, each of R⁹ and R¹⁰ includes, independently, an electroactive moiety.

In some embodiments (e.g., of formulas (I)—(V)), ring a, ring b, and/or ring c includes an electroactive moiety. In other embodiments, R⁸ includes an electroactive moiety. In particular embodiments, the electroactive moiety includes or is -L^{A}-X, in which L^{A} is a linking moiety (e.g., optionally substituted aliphatic, alkylene, heteroaliphatic, heteroalkylene, aromatic, or arylene); and X is an electroactive group.

In other embodiments (e.g., of formulas (I)—(V)), R⁷ includes the electron-withdrawing moiety. Non-limiting electron-withdrawing moieties can include or be an optionally substituted haloalkyl, cyano (CN), phosphate (e.g., —O(P═O)(OR^{P1})(OR^{P2}) or —O—[P(═O)(OR^{P1})—O]_{P3}—R^{P2}), sulfate (e.g., —O—S(═O)₂(OR^{S1})), sulfonic acid (—SO₃H), sulfonyl (e.g., —SO₂—CF₃), difluoroboranyl (—BF₂), borono (—B(OH)₂), thiocyanato (—SCN), or piperidinium. In further embodiments, R⁷ includes the electron-withdrawing moiety, and R⁸ includes the electroactive moiety. Yet other non-limiting phosphate groups can include derivatives of phosphoric acid, such as orthophosphoric acid, pyrophosphoric acid, tripolyphosphoric acid, tetrapolyphosphoric acid, trimetaphosphoric acid, and/or phosphoric anhydride, or combinations thereof.

In some embodiments (such as in formulas (I)—(V)), R⁷ includes an optionally substituted aliphatic group. In one embodiment, R⁷ includes an optionally alkyl group.

In other embodiments (such as in formulas (I)—(V)), R⁸ includes an optionally substituted aliphatic group or an optionally substituted heteroaliphatic group. In particular embodiments, the aliphatic or heteroaliphatic group is substituted with an oxo group (═O) or an hydroxyimino group (=N—OH). In one embodiment, R⁸ is —C(═X)—R^{8′}, in which X is O or N—OH; and R⁸ is optionally substituted aliphatic, optionally substituted alkyl, optionally substituted heteroaliphatic, optionally substituted heteroalkyl, optionally substituted alkoxy, optionally substituted haloalkyl, or optionally substituted alkanoyl.

In yet other embodiments (e.g., for any structure herein, such as in formulas (I)—(V)), R⁷ and R⁸ are taken together to form an optionally substituted cyclic group. For instance, R⁷ and R¹ can be taken together to form an optionally substituted spirocyclyl group, as defined herein. In particular embodiments, the spirocyclyl group is substituted, independently, with one or more ionizable moieties or ionic moieties (e.g., any described herein). In some embodiments, the formulas of (I)—(V) can be represented as follows:

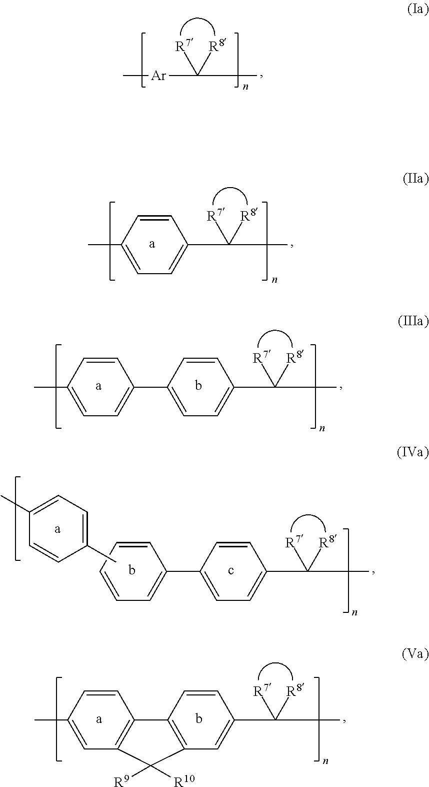

or a salt thereof, wherein R^{7′} and R^{8′} are taken together to form an optionally substituted alkylene group or an optionally substituted heteroalkylene group. In particular embodiments, the optionally substituted alkylene group or the optionally substituted heteroalkylene group is substituted, independently, with one or more electroactive moieties.

Further non-limiting polymeric units can include moieties of any one or more of the following:

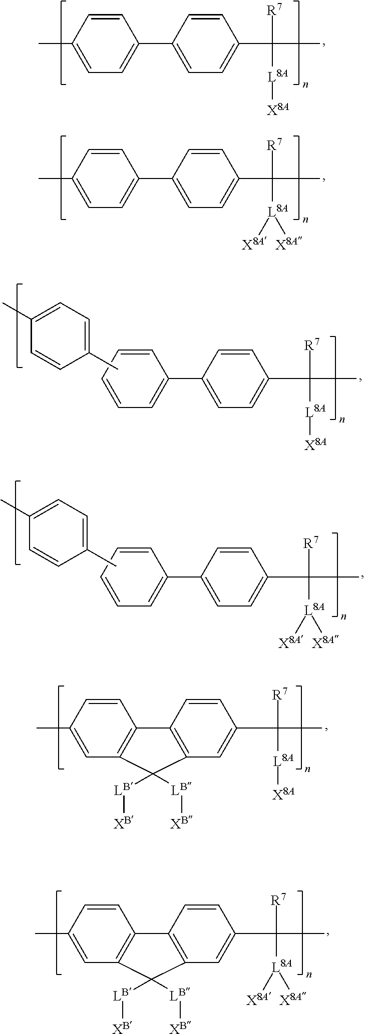

or a salt
thereof, wherein:
n is from 1 or more;
each L^{8A}, L^{B′}, and L^{B″} is, independently, a linking moiety; and
each X^{8A}, X^{8A′}, X^{8A″}, X^{B′}, and X^{B″} is, independently, an electroactive moiety.

In some embodiments, the polymer comprises an electronically conductive polymeric backbone of conjugated bonds from which the electroactive moiety is pendant. In some embodiments, the electronically conductive backbone may be polyacetylene, polyphenylene vinylene, polypyrrole, polythiophene, polyaniline, poly (p-phenylene) or polyphenylene sulfide. In some embodiments, the electronically conductive backbone may be a polyfluorene, a polyphenylene, a polypyrene, a polyazulene, a polynaphthalene, a polycarbazole, a polyindole, a polyanthraquinone, a polyazepine or a poly(3,4-ethylenedioxythiophene).

In any embodiment herein, ring a, ring b, ring c, Ak, R⁷, R⁸, R⁹, and R¹⁰ can optionally be substituted with an electroactive moiety. Further substitutions for ring a, ring b, ring c, R⁷, R⁸, R⁹, and R¹⁰ can include one or more optionally substituted arylene.

In any embodiment herein, the electron-withdrawing moiety can be an optionally substituted haloalkyl (e.g., C₁₋₆ haloalkyl, including halomethyl, perhalomethyl, haloethyl, perhaloethyl, and the like), cyano (CN), phosphate (e.g., —O(P═O)(OR^{P1})(OR^{P2}) or —O—[P(═O)(OR^{P1})—O]_{P3}—R^{P2}), sulfate (e.g., —O—S(═O)₂(OR^{S1})), sulfonic acid (—SO₃H), sulfonyl (e.g., —SO₂—CF₃), difluoroboranyl (—BF₂), borono (B(OH)₂), thiocyanato (—SCN), or piperidinium. Yet other non-limiting phosphate groups can include derivatives of phosphoric acid, such as orthophosphoric acid, pyrophosphoric acid, tripolyphosphoric acid, tetrapolyphosphoric acid, trimetaphosphoric acid, and/or phosphoric anhydride, or combinations thereof.

In some embodiments (e.g., for any structure herein, such as in formulas (I)—(V)), non-limiting haloalkyl groups include fluoroalkyl (e.g., —CₓF_{y}H_{z}), perfluoroalkyl (e.g., —CₓF_{y}), chloroalkyl (e.g., —CₓCl_{y}H_{z}), perchloroalkyl (e.g., —CₓCl_{y}), bromoalkyl (e.g., —CₓBr_{y}H_{z}), perbromoalkyl (e.g., —CₓBr_{y}), iodoalkyl (e.g., —CₓI_{y}H_{z}), or periodoalkyl (e.g., —CₓI_{y}). In some embodiments, x is from 1 to 6, y is from 1 to 13, and z is from 0 to 12. In particular embodiments, z=2x+1−y. In other embodiments, x is from 1 to 6, y is from 3 to 13, and z is 0 (e.g., and y=2x+1).

The moiety can include one or more substitutions to a ring portion of the unit (e.g., as provided by an aromatic or arylene group) or to a linear portion (e.g., as provided by an aliphatic or alkylene group). Non-limiting substitutions can include lower unsubstituted alkyl (e.g., C₁₋₆ alkyl), lower substituted alkyl (e.g., optionally substituted C₁₋₆ alkyl), lower haloalkyl (e.g., C₁₋₆ haloalkyl), halo (e.g., F, Cl, Br, or I), unsubstituted aryl (e.g., phenyl), halo-substituted aryl (e.g., 4-fluoro-phenyl), substituted aryl (e.g., substituted phenyl), and others.

### Second Polymer

The second polymer is typically different than the first polymer. In use, at least one first and at least one second polymer, together, can provide a composition having beneficial chemical and physical properties (e.g., water uptake, swelling degree, specific conductivity, mechanical stability, etc.). In an embodiment, the compositions include more than one of the first polymer types and more than one of the second polymer types.

The selection of particular components of the compositions (e.g., first polymer, second polymer, moieties, electroactive moieties, crosslinkers, etc.) can provide useful properties for the composition. In one instance, polymer components can be selected to minimize water uptake, in which excessive water can result in flooding of an electrochemical cell. In another instance, polymer components can be selected to provide resistance to softening or plasticization.

In one embodiment, the second polymer can include one or more of the following: optionally substituted aliphatic, optionally substituted alkylene, optionally substituted aromatic, optionally substituted arylene, optionally substituted haloalkylene, optionally substituted alkyleneoxy, optionally substituted aryleneoxy, optionally substituted phosphazene (e.g., —P(R^{P1}R^{P2}—)═N—), and combinations thereof.

The second polymer can include one or more of the following monomeric units:

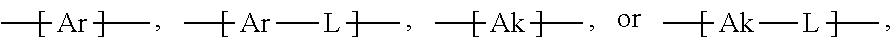

in which Ar is an optionally substituted arylene or optionally substituted aromatic; Ak is an optionally substituted alkylene, optionally substituted haloalkylene, optionally substituted aliphatic, optionally substituted heteroalkylene, or optionally substituted heteroaliphatic; L is a linking moiety (e.g., any described herein); and Ar, L, or Ak can be optionally substituted with one or more ionizable or ionic moieties. Non-limiting examples of Ar include, e.g., phenylene (e.g., 1,4-phenylene, 1,3-phenylene, etc.), biphenylene (e.g., 4,4′-biphenylene, 3,3′-biphenylene, 3,4′-biphenylene, etc.), terphenylene (e.g., 4,4′-terphenylene), triphenylene, diphenyl ether, anthracene (e.g., 9,10-anthracene), naphthalene (e.g., 1,5-naphthalene, 1,4-naphthalene, 2,6-naphthalene, 2,7-naphthalene, etc.), tetrafluorophenylene (e.g., 1,4-tetrafluorophenylene, 1,3-tetrafluorophenylene), and the like, as well as others described herein.

Any portion of the second polymer may optionally include an electroactive moiety. In particular embodiments, the electroactive moiety includes or is -L^{A}-X, in which L^{A} is a linking moiety (e.g., optionally substituted aliphatic, alkylene, heteroaliphatic, heteroalkylene, aromatic, or arylene); and X is an electroactive moiety.

The second polymer can include a combination of soft and hard segments. For instance, the second polymer can include a monomeric unit as follows:

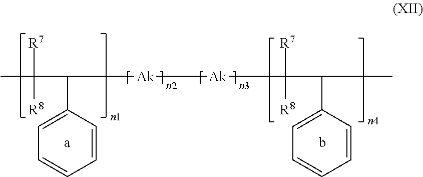

or a salt thereof, wherein:
each of R⁷ and R⁸ is, independently, an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, wherein at least one of R⁷ or R⁸ comprises the electron-withdrawing moiety;
each Ak is an optionally substituted alkylene;
each of n1, n2, n3, and n4 is, independently, an integer of 1 or more;
each of ring a or ring b can be optionally substituted; and
wherein one or more of rings a-b, R⁷, and R⁸ can optionally comprise an electroactive moiety.

In some embodiments (e.g., for any moiety herein, such as in formula (XII), R⁷ includes an optionally substituted aliphatic group. In one embodiment, R⁷ includes an optionally alkyl group.

In some embodiments (e.g., for any moiety herein, such as in formula (XII)), the electron-withdrawing moiety is a haloalkyl group. Non-limiting haloalkyl groups include fluoroalkyl (e.g., —CₓF_{y}H_{z}), perfluoroalkyl (e.g., —CₓF_{y}), chloroalkyl (e.g., —CₓCl_{y}H_{z}), perchloroalkyl (e.g., —CₓCl_{y}), bromoalkyl (e.g., —CₓBr_{y}H_{z}), perbromoalkyl (e.g., —CₓBr_{y}), iodoalkyl (e.g., —CₓI_{y}H_{z}), or periodoalkyl (e.g., —CₓI_{y}). In some embodiments, x is from 1 to 6, y is from 1 to 13, and z is from 0 to 12. In particular embodiments, z=2x+1−y. In other embodiments, x is from 1 to 6, y is from 3 to 13, and z is 0 (e.g., and y=2x+1).

The second polymer can include a polyphenylene. For instance, the second polymer can include a moiety as follows:

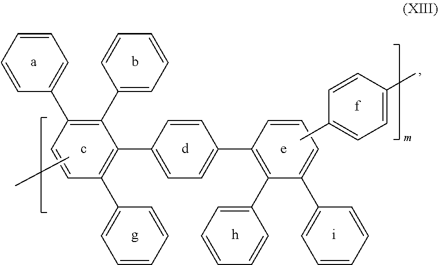

or a salt thereof, wherein:
m is an integer of 1 or more; and
each of rings a-i can be optionally substituted and/or can optionally include an electroactive moiety.

In particular embodiments, the electroactive moiety is present on one or more of rings a, b, f, g, h, or i. In some embodiments, the electroactive moiety includes or is -L^{A}-X, in which L^{A} is a linking moiety (e.g., optionally substituted aliphatic, alkylene, heteroaliphatic, or heteroalkylene); and X is an electroactive group.

The second polymer can include a polybenzimidazole that is optionally combined with other arylene-containing monomeric units. In one instance, the second polymer can include a moiety selected from the following:

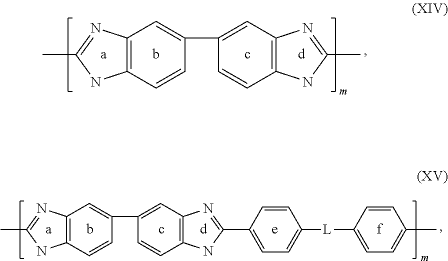

or a salt thereof, wherein:
each L is, independently, a linking moiety;
m is an integer of 1 or more; and
each of rings a-f can be optionally substituted and/or can optionally include an electroactive moiety.

In particular embodiments, each of the nitrogen atoms on rings a and/or b are substituted with optionally substituted aliphatic, optionally substituted alkyl, optionally substituted aromatic, optionally substituted aryl, or an electroactive moiety. In other embodiments, one nitrogen atom in each of rings a and/or b is substituted with optionally substituted aliphatic, optionally substituted alkyl, optionally substituted aromatic, optionally substituted aryl, an electroactive moiety. In particular embodiments, the electroactive moiety includes or is -L^{A}-X, in which L^{A} is a linking moiety (e.g., optionally substituted aliphatic, alkylene, or heteroaliphatic, such as C₁₋₁₂, C₃₋₁₂, C₄₋₁₂, or C₆₋₁₂ forms thereof); and X is an electroactive group.

In yet other embodiments, the linking moiety (e.g., L) is a covalent bond, —O—, —SO₂—, —C(O)—, optionally substituted aliphatic, optionally substituted alkylene (e.g., —CR₂—, in which R is H, alkyl, or haloalkyl), optionally substituted haloalkylene, or any other linking moiety described herein.

Other second polymers include those having a plurality of arylene groups. In some embodiments, the second polymer includes a moiety selected from the following:

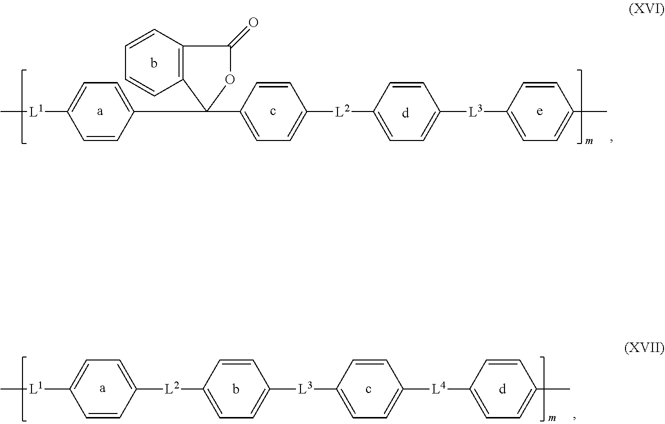

or a salt thereof, wherein:
each of L¹, L², L³, and L4 is, independently, a linking moiety;
m is an integer of 1 or more; and
each of rings a-e can be optionally substituted and/or can optionally include an electroactive moiety.

In particular embodiments, at least one of rings a-e is substituted with optionally substituted aliphatic, optionally substituted alkyl, optionally substituted aromatic, optionally substituted aryl, an electroactive moiety. In some embodiments, at least ring a is substituted with an electroactive moiety. In particular embodiments, the electroactive moiety includes or is -L^{A}-X, in which L^{A} is a linking moiety (e.g., optionally substituted aliphatic, alkylene, heteroaliphatic, or heteroalkylene, such as C₁₋₁₂, C₁₋₆, C₄₋₁₂, or C₆₋₁₂ forms thereof); and X is an electroactive group.

In some embodiments, the linking moiety (e.g., L¹, L², L³, or L⁴) is a covalent bond, —O—, —SO₂—, —C(O)—, optionally substituted aliphatic, optionally substituted alkylene (e.g., —CR₂—, in which R is H, alkyl, or haloalkyl), optionally substituted haloalkylene, optionally substituted alkyleneoxy, optionally substituted heteroaliphatic, optionally substituted heteroalkylene, or any other linking moiety described herein.

Segments of arylene-containing groups can also be employed. For instance, the second polymer can include a moiety as follows:

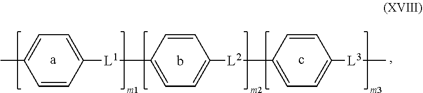

or a salt thereof, wherein:
each of L, L², and L³ is, independently, a linking moiety;
each of m1, m2, and m3 is, independently, an integer of 1 or more; and
each of rings a-c can be optionally substituted and/or can optionally include an electroactive moiety.

In particular embodiments, at least one of rings a-c is substituted with halo, optionally substituted aliphatic, optionally substituted alkyl, optionally substituted aromatic, optionally substituted aryl, or an electroactive moiety. In some embodiments, at least one of rings a-c is substituted with both halo and optionally substituted alkyl. In other embodiments, at least one of rings a-c is substituted with both optionally substituted alkyl and an electroactive moiety. In particular embodiments, the electroactive moiety includes or is -L^{A}-X, in which L^{A} is a linking moiety (e.g., optionally substituted aliphatic, alkylene, heteroaliphatic, or heteroalkylene, such as C₁₋₁₂, C₁₋₆, C₄₋₁₂, or C₆₋₁₂ forms thereof); and X is an electroactive group. In other embodiments, the linking moiety (e.g., L¹, L², or L³) is a covalent bond, —O—, —SO₂—, —C(O)—, optionally substituted alkylene (e.g., —CR₂—, in which R is H, alkyl, or haloalkyl), or any other linking moiety described herein. In yet other embodiments, each linking moiety (e.g., L¹, L², and L³) is —O—.

The second polymer can include halogenated moieties. In some embodiments, the second structure includes a moiety as follows:

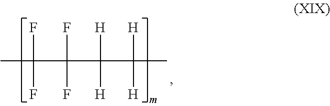

wherein m is an integer of 1 or more. In some embodiments, one or more hydrogen or fluorine atoms can be replaced by an electroactive moiety. In other embodiments, the second polymer includes a moiety selected from the following:

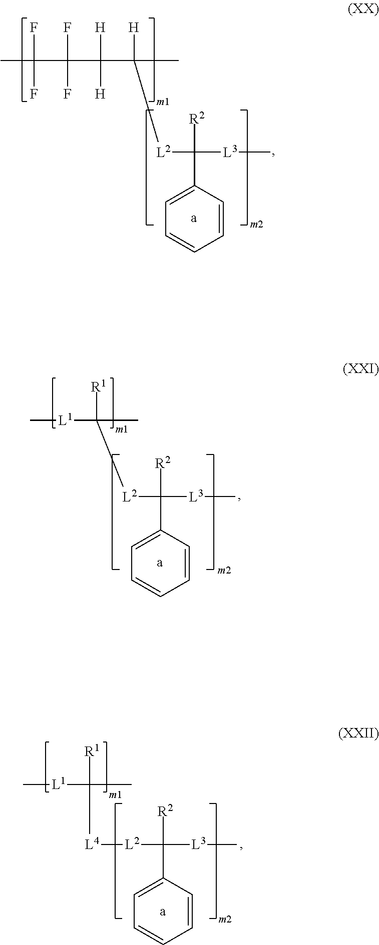

or a salt thereof, wherein:
each of R¹ and R² is, independently, an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene;
   each of L¹, L², L³, and L4 is, independently, a linking moiety;
   each of m1 and m2 is, independently, an integer of 1 or more; and
   ring a can be optionally substituted and/or can optionally comprise an electroactive moiety.

In particular embodiments, ring a is substituted with halo, optionally substituted aliphatic, optionally substituted alkyl, optionally substituted aromatic, optionally substituted aryl, an ionizable moiety, or an ionic moiety. In some embodiments, at least one of ring a is substituted with both optionally substituted alkyl and an ionizable/ionic moiety. In particular embodiments, the electroactive moiety includes or is -L^{A}-X, in which L^{A} is a linking moiety (e.g., optionally substituted aliphatic, alkylene, heteroaliphatic, or heteroalkylene); and X is an electroactive group.

In other embodiments, the linking moiety (e.g., L¹, L², L³, or L⁴) is a covalent bond, —O—, —SO₂—, —C(O)—, optionally substituted alkylene (e.g., —CR₂—, in which R is H, alkyl, or haloalkyl), optionally substituted haloalkylene, or any other linking moiety described herein. In particular embodiments, R² is H; and each of L² and L³ is, independently, a covalent bond, optionally substituted alkylene, or optionally substituted alkyleneoxy. L¹ can be an optionally substituted alkylene or optionally substituted haloalkylene. L⁴, if present, can be a covalent bond, —O—, optionally substituted alkylene, or optionally substituted alkyleneoxy.

The second polymer can include epoxy-derived or vinyl alcohol-derived moieties. In some embodiments, it includes a moiety selected from the following: O—CH₂ CH CH₂

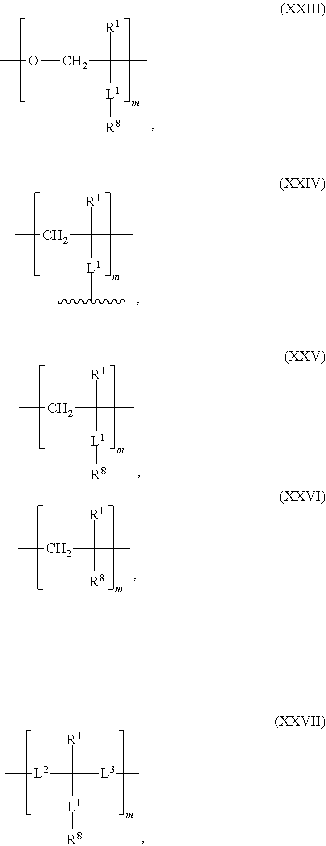

or a salt thereof, wherein:
each of R¹ and R⁸ is, independently, an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene;
each of L¹, L², and L³ is, independently, a linking moiety; and each of m is, independently, an integer of 1 or more;
wherein R⁸ can optionally comprise an electroactive moiety.

In particular embodiments, R⁸ and/or the electroactive moiety includes or is -L^{A}-X, in which L^{A} is a linking moiety (e.g., optionally substituted aliphatic, alkylene, heteroaliphatic, heteroalkylene, aromatic, or arylene); and X is an electroactive group.

In some embodiments, R¹ is H; and L¹ includes a covalent bond, —O—, —C(O)—, optionally substituted alkylene, or optionally substituted heteroalkylene. In some embodiments, R⁸ includes an electroactive moiety. In other embodiments, each of L² and L³ is, independently, a covalent bond, —O—, optionally substituted alkylene, or optionally substituted heteroalkylene.

In some embodiments, the second polymer is formed of moieties as follows:

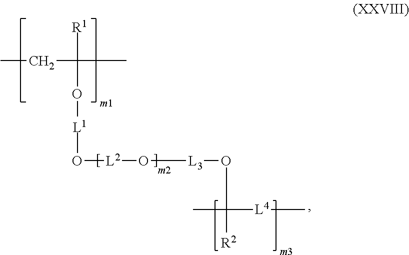

or a salt thereof, wherein:
each of R¹ and R² is, independently, an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene; each of L¹, L², L³, and L⁴ is, independently, a linking moiety; and each of m1, m2, and m3 is, independently, an integer of 1 or more.

In particular embodiments, the oxygen atoms present in the second polymer can be associated with an alkali dopant (e.g., K⁺). In other embodiments, the linking moiety (e.g., L¹, L², L³, or L⁴) is optionally substituted alkylene (e.g., —CR₂—, in which R is H, alkyl, or haloalkyl), optionally substituted hydroxyalkylene, or any other linking moiety described herein.

The second polymer can be a phosphazene-based polymer. In some embodiments, the second polymer is composed of a moiety as follows:

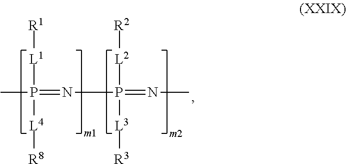

or a salt thereof, wherein:
each of R¹, R², R³, and R⁸ is, independently, an electron-withdrawing moiety, H, optionally substituted aliphatic, optionally substituted alkyl, optionally substituted heteroaliphatic, optionally substituted heteroalkyl, optionally substituted aromatic, optionally substituted aryl, optionally substituted aryloxy, or optionally substituted arylalkylene;
   each of L¹, L², L³, and L⁴ is, independently, a linking moiety; and
   each of m1 and m2 is, independently, an integer of 1 or more;
   wherein R⁸ can optionally comprise an electroactive moiety.

In particular embodiments, R⁸ and/or the electroactive moiety includes or is -L^{A}-X, in which L^{A} is a linking moiety (e.g., optionally substituted aliphatic, alkylene, heteroaliphatic, heteroalkylene, aromatic, or arylene); and X is an electroactive group.

In some embodiments, each of R¹, R², and R³ is optionally substituted aromatic, optionally substituted aryl, optionally substituted aryloxy, or optionally substituted arylalkylene. In other embodiments, the linking moiety (e.g., L¹, L², L³, or L⁴) is a covalent bond, —O—, —SO₂—, —C(O)—, optionally substituted alkylene (e.g., —CR₂—, in which R is H, alkyl, or haloalkyl), optionally substituted haloalkylene, or any other linking moiety described herein.

The second polymer can be a polyimide-based polymer. In some embodiments, the second polymer is composed of moieties selected from the following:

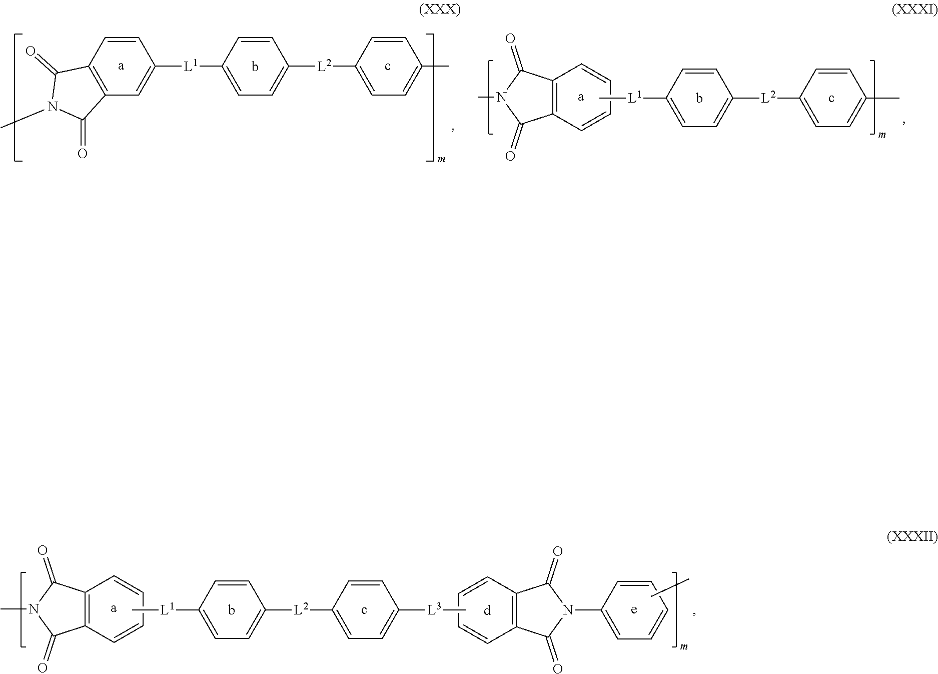

and a salt thereof,
wherein:
each of L¹, L², and L³ is, independently, a linking moiety;
m is an integer of 1 or more; and
each of rings a-e can be optionally substituted and/or can optionally include an electroactive moiety.

In particular embodiments, at least one of rings a-e is substituted with optionally substituted aliphatic, optionally substituted alkyl, optionally substituted aromatic, optionally substituted aryl, an ionizable moiety, or an ionic moiety. In some embodiments, at least ring b or c is substituted with an electroactive moiety. In particular embodiments, the electroactive moiety includes or is -L^{A}-X, in which L^{A} is a linking moiety (e.g., optionally substituted aliphatic, alkylene, heteroaliphatic, or heteroalkylene, such as C₁₋₁₂, C₁₋₆, C₄₋₁₂, or C₆₋₁₂ forms thereof); and X is an electroactive group.

In other embodiments, the linking moiety (e.g., L¹, L², or L³) is a covalent bond, —O—, —SO₂—, —C(O)—, optionally substituted aliphatic, optionally substituted alkylene (e.g., —CR₂—, in which R is H, alkyl, or haloalkyl), optionally substituted haloalkylene, optionally substituted alkyleneoxy, optionally substituted heteroaliphatic, optionally substituted heteroalkylene, or any other linking moiety described herein.

The second polymer can be a polyether. Non-limiting second polymers can be composed of a moiety as follows:

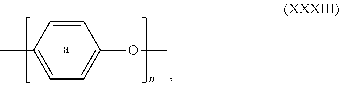

wherein:
n is an integer of 1 or more; and
ring a can be optionally substituted and/or can optionally include an electroactive moiety. Non-limiting substituents for ring a include one or more described herein for aryl, such as alkyl, alkoxy, alkoxyalkyl, amino, aminoalkyl, aryl, arylalkylene, aryloyl, aryloxy, arylalkoxy, cyano, hydroxy, hydroxyalkyl, nitro, halo, and haloalkyl.

The second polymer can be aromatic. Non-limiting second polymers can be formed from a moiety as follows:

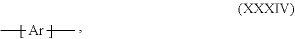

in which Ar is an optionally substituted arylene or optionally substituted aromatic; Ak is an optionally substituted alkylene, optionally substituted haloalkylene, optionally substituted aliphatic, optionally substituted heteroalkylene, or optionally substituted heteroaliphatic; L is a linking moiety (e.g., any described herein); and Ar, L, or Ak can be optionally substituted with one or more electroactive moieties. Non-limiting examples of Ar include, e.g., phenylene (e.g., 1,4-phenylene, 1,3-phenylene, etc.), biphenylene (e.g., 4,4′-biphenylene, 3,3′-biphenylene, 3,4′-biphenylene, etc.), terphenylene (e.g., 4,4′-terphenylene), triphenylene, diphenyl ether, anthracene (e.g., 9,10-anthracene), naphthalene (e.g., 1,5-naphthalene, 1,4-naphthalene, 2,6-naphthalene, 2,7-naphthalene, etc.), tetrafluorophenylene (e.g., 1,4-tetrafluorophenylene, 1,3-tetrafluorophenylene), and the like, as well as others described herein. Non-limiting substituents for Ar include one or more described herein for aryl, such as alkyl, alkoxy, alkoxyalkyl, amino, aminoalkyl, aryl, arylalkylene, aryloyl, aryloxy, arylalkoxy, cyano, hydroxy, hydroxyalkyl, nitro, halo, and haloalkyl.

For any second polymer described herein, each of m, m1, m2, and m3 is, independently, an integer of 1 or more. In any embodiment herein (e.g., for a second structure), the linking moiety (e.g., L, L¹, L², L³, and L⁴) is or comprises a covalent bond, —O—, —SO₂—, —NRN—, —C(O)—, optionally substituted aliphatic, optionally substituted alkylene (e.g., —CR₂—, in which R is H, alkyl, or haloalkyl), optionally substituted haloalkylene, optionally substituted hydroxyalkylene, optionally substituted alkyleneoxy, optionally substituted heteroaliphatic, optionally substituted heteroalkylene, optionally substituted aromatic, optionally substituted arylene, optionally substituted aryleneoxy, optionally substituted heterocycle, or optionally substituted heterocyclyldiyl.

For any first or second polymer described herein, one or more haloalkyl groups may be present (e.g., attached to the backbone group, an aryl group, or another portion of the structure). Non-limiting haloalkyl groups include fluoroalkyl (e.g., —CₓF_{y}H_{z}), perfluoroalkyl (e.g., —CₓF_{y}), chloroalkyl (e.g., —CₓCl_{y}H_{z}), perchloroalkyl (e.g., —CₓCl_{y}), bromoalkyl (e.g., —CₓBr_{y}H_{z}), perbromoalkyl (e.g., —CₓBr_{y}), iodoalkyl (e.g., —CₓI_{y}H_{z}), or periodoalkyl (e.g., —CₓI_{y}). In some embodiments, x is from 1 to 6, y is from 1 to 13, and z is from 0 to 12. In particular embodiments, z=2x+1−y. In other embodiments, x is from 1 to 6, y is from 3 to 13, and z is 0 (e.g., and y=2x+1).

### Further Polymeric Units

The compositions, polymer(s), and second polymer(s) herein can include two or more polymers, which are attached directly or indirectly (e.g., by way of a linking moiety) to each other. The polymer can be a homopolymer, a copolymer, a block copolymer, a polymeric blend, or other useful combinations of repeating monomeric units. The following provides further monomeric and polymeric units that can be employed within the first and/or second polymers.

Monomeric units can include an optionally substituted aliphatic group, an optionally substituted aromatic group, and combinations thereof. Non-limiting monomeric units can include optionally substituted arylene, optionally substituted aryleneoxy, optionally substituted alkylene, or combinations thereof, such as optionally substituted (aryl)(alkyl)ene (e.g., -Ak-Ar—or -Ak-Ar-Ak- or —Ar-Ak-, in which Ar is an optionally substituted arylene and Ak is an optionally substituted alkylene).

Yet other monomeric units can include:

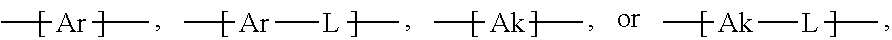

in which Ar is an optionally substituted arylene or optionally substituted aromatic; Ak is an optionally substituted alkylene or optionally substituted haloalkylene, optionally substituted heteroalkylene, optionally substituted aliphatic, or optionally substituted heteroaliphatic; and L is a linking moiety (e.g., any described herein) or can be —C(R⁷)(R⁸)—. One or more monomeric units can be optionally substituted with one or more ionizable or ionic moieties (e.g., as described herein). In particular embodiments, at least one monomeric unit is substituted with one or more electroactive moieties.

One or more monomeric units can be combined to form a polymeric unit. Non-limiting polymeric units include any of the following:

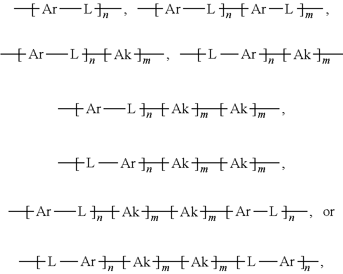

in which Ar is an optionally substituted arylene or an optionally substituted aromatic, Ak is an optionally substituted alkylene or optionally substituted aliphatic, L is a linking moiety (e.g., any described herein), each n is independently an integer of 1 or more, and each m is independently 0 or an integer of 1 or more. Any number and type of monomeric units can be combined to form the polymeric unit.

In particular embodiments, the polymeric unit includes more than one arylene group. For instance, in a polymeric unit having this structure:

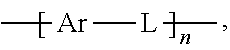

n, n can be greater than 1 and/or Ar can include two or more aromatic or arylene groups. The presence of such aromatic groups may be used to build linear chains within the composition.

In other embodiments, L is an optionally substituted C₁₋₆ aliphatic, optionally substituted C₁₋₆ alkylene, optionally substituted C₁₋₆ heteroalkylene. The use of short linkers could provide more extensive polymeric networks, as shorter linkers could minimize self-cyclization reactions.

The polymeric unit can include one or more substitutions to a ring portion of the unit (e.g., as provided by an aromatic or arylene group) or to a linear portion (e.g., as provided by an aliphatic or alkylene group). Non-limiting substitutions can include lower unsubstituted alkyl (e.g., C₁₋₆ alkyl), lower substituted alkyl (e.g., optionally substituted C₁₋₆ alkyl), lower haloalkyl (e.g., C₁₋₆ haloalkyl), halo (e.g., F, Cl, Br, or I), unsubstituted aryl (e.g., phenyl), halo-substituted aryl (e.g., 4-fluoro-phenyl), substituted aryl (e.g., substituted phenyl), and others.

In some embodiments of the polymeric unit, L is a covalent bond, —O—, —NR^{N1}—, —C(O)—, —SO₂—, optionally substituted alkylene (e.g., —CH₂— or —C(CH₃)₂—), optionally substituted alkyleneoxy, optionally substituted haloalkylene (e.g., —CF₂— or —C(CF₃)₂—), optionally substituted heteroalkylene, optionally substituted arylene, optionally substituted aryleneoxy, optionally substituted heterocyclyldiyl, —SO₂—NR^{N1}-Ak-, —(O-Ak)_{L1}-SO₂—NR^{N1}-Ak-, -Ak-, -Ak-(O-Ak)_{L1}-, —(O-Ak)_{L1}-, -(Ak-O)_{L1}—, —C(O)O-Ak-, —Ar—, or —Ar—O—, as well as combinations thereof. In particular embodiments, Ak is an optionally substituted alkylene or optionally substituted haloalkylene; R^{N1} is H or optionally substituted alkyl or optionally substituted aryl; Ar is an optionally substituted arylene; and L1 is an integer from 1 to 3.

In one instance, a polymeric subunit can lack electroactive moieties. Alternatively, the polymeric subunit can include an electroactive moiety on the Ar group, the L group, both the Ar and L groups, or be integrated as part of the L group.

Yet other polymeric units can include poly(benzimidazole) (PBI), polyphenylene (PP), polyimide (PI), poly(ethyleneimine) (PEI), sulfonated polyimide (SPI), polysulfone (PSF), sulfonated polysulfone (SPSF), poly(ether ether ketone) (PEEK), PEEK with cardo groups (PEEK-WC), polyethersulfone (PES), sulfonated polyethersulfone (SPES), sulfonated poly(ether ether ketone) (SPEEK), SPEEK with cardo groups (SPEEK-WC), poly(p-phenylene oxide) (PPO), sulfonated polyphenylene oxide (SPPO), ethylene tetrafluoroethylene (ETFE), polytetrafluoroethylene (PTFE), poly(epichlorohydrin) (PECH), poly(styrene) (PS), sulfonated poly(styrene) (SPS), hydrogenated poly(butadiene-styrene) (HPBS), styrene divinyl benzene copolymer (SDVB), styrene-ethylene-butylene-styrene (SEBS), sulfonated bisphenol-A-polysulfone (SPSU), poly(4-phenoxy benzoyl-1,4-phenylene) (PPBP), sulfonated poly(4-phenoxy benzoyl-1,4-phenylene) (SPPBP), poly(vinyl alcohol) (PVA), poly(phosphazene), poly(aryloxyphosphazene), polyetherimide, as well as combinations thereof.

### Crosslinkers

Further crosslinking within the material of the composition can be promoted by use of crosslinking reagents. For instance, the composition can include polymeric units, and a crosslinking reagent can be used to provide crosslinking between polymeric units. For instance, if the polymeric units (P1 and P2) include a leaving group, then a diamine crosslinking reagent (e.g., H₂N-Ak-NH₂) can be used to react with the polymeric units by displacing the leaving group and forming an amino-containing crosslinker within the composition (e.g., thereby forming P1-NH-Ak-NH—P2). Such crosslinkers can be formed between a combination of first and second structures (e.g., between two first structures, between two second structures, between a first and a second structure, etc.). Crosslinkers can be introduced by forming a polymer composition and then exposing the composition to a crosslinking reagent to form crosslinker.

In some instances, the crosslinking reagent is a multivalent amine, such as diamine, triamine, tetraamine, pentaamine, etc. Non-limiting amine-containing crosslinking reagents can include:

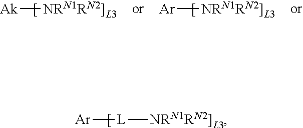

in which Ak is an optionally substituted aliphatic or an optionally substituted alkylene, Ar is an optionally substituted aromatic or an optionally substituted arylene, L is a linking moiety (e.g., any herein, such as a covalent bond, optionally substituted alkylene, optionally substituted aliphatic, etc.), L3 is an integer that is 2 or more (e.g., 2, 3, 4, 5, 6, or more), and each of R^{N1} and R^{N2} is, independently, H or optionally substituted alkyl. Yet further examples of amine-containing linkers include 1,6-diaminohexane (hexanediamine), 1,4-diaminobutane, 1,8-diaminooctane, propane-1,2,3-triamine, [1,1′:3′,1″-terphenyl]-4,4″,5′-triamine, and others.

Depending on the functional group present in the material, the crosslinking reagent can include a nucleophilic group (e.g., an amine or a hydroxyl) or an electrophilic group (e.g., a carbonyl). Thus, non-limiting crosslinking reagents can include amine-containing reagents, hydroxyl-containing reagents, carboxylic acid-containing reagents, acyl halide-containing reagents, or others. Further crosslinking reagents can include:

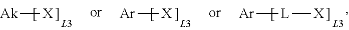

in which Ak is an optionally substituted aliphatic or an optionally substituted alkylene, Ar is an optionally substituted aromatic or an optionally substituted arylene, L is a linking moiety (e.g., any herein, such as a covalent bond, optionally substituted alkylene, optionally substituted aliphatic, etc.), L3 is an integer that is 2 or more (e.g., 2, 3, 4, 5, 6, or more), and X is halo, hydroxyl, optionally substituted amino, hydroxyl, carboxyl, acyl halide (e.g., —C(O)—R, in which R is halo), carboxyaldehyde (e.g., —C(O)H), or optionally substituted alkyl. Non-limiting crosslinking reagents can include terephthalaldehyde, glutaraldehyde, ortho-xylene, para-xylene, or meta-xylene.

After reacting the crosslinking reagent, the composition can include one or more crosslinkers within the composition. If the crosslinking reagent is bivalent, then a crosslinker can be present between two of any combination of first structure(s), second structure(s), polymeric units, and electroactive moieties (e.g., between two polymeric units, between two electroactive moieties, etc.). If the crosslinking reagent is trivalent or of higher n valency, then the crosslinker can be present between any n number of polymeric units, linking moieties and/or electroactive moieties. Non-limiting crosslinkers present in the composition include those formed after reacting a crosslinking reagent. Thus, examples of crosslinkers can include:

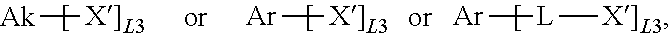

in which Ak is an optionally substituted aliphatic or an optionally substituted alkylene, Ar is an optionally substituted aromatic or an optionally substituted arylene, L is a linking moiety (e.g., any herein, such as a covalent bond, optionally substituted alkylene, optionally substituted aliphatic, etc.), L3 is an integer that is 2 or more (e.g., 2, 3, 4, 5, 6, or more), and X′ is a reacted form of X. In some embodiments, X′ is absent, —O—, —NR^{N1}—, —C(O)—, or -Ak-, in which R^{N1} is H or optionally substituted alkyl, and Ak is optionally substituted alkylene, optionally substituted heteroalkylene, optionally substituted aliphatic, or optionally substituted heteroaliphatic.

### Electroactive Moieties

By “electroactive moiety” is meant an agent which undergoes oxidation or reduction upon exposure to an electrical potential in an electrochemical cell. The electroactive moiety is one capable of bonding with or binding to a target gas when the electroactive moiety is in a particular oxidation state, such as a reduced state, and releasing the target gas when the electroactive moiety is in a second oxidation state, such as an oxidized state. The electroactive moiety is a structural unit that reversibly reacts with a Lewis acidic gas. In some embodiments, the Lewis acidic gas is carbon dioxide, carbon monoxide, nitrogen dioxide, nitric oxide, sulfur dioxide, or sulfur trioxide.

The electroactive moiety can be a redox species which is any molecule or compound or portion thereof (such as a molecular or functional moiety of a compound or molecule) that can be oxidized and/or reduced during or upon electrical stimulation including during or upon application of an electrical potential, or that can undergo a Faradaic reaction. The electroactive moiety is a part of a compound which may include an electroactive group.

In some embodiments, the electroactive moiety is a CO₂ absorbing moiety, which can reversibly bind and release CO₂ upon exposure to different electrical potentials. For example, the electroactive group may be a quinone, which reacts with CO₂ at cathodic or more negative potentials to form carbonate moieties, and releases CO₂ at anodic or more positive potentials.

The compositions herein can include one or more electroactive moieties. The electroactive moieties can be provided in the composition in any useful way. In one embodiment, at least one of the first and second polymers, independently, includes one or more electroactive moieties. In another embodiment, both the first and second polymers, independently, include one or more electroactive moieties.

The electroactive groups herein can be connected to the parent structure by way of one or more linking moieties, forming electroactive moieties. Furthermore, an electroactive group can be extended from a single linking moiety.

In some instances, a linker is attached to two or more electroactive groups. In some embodiments, the electroactive moiety can be -L^{A}-(L^{A′}-X)_{L2}, in which L^{A} and L^{A′} are linking moieties and X is an electroactive group. In one instance, L^{A} provides one, two, or three linkages.

Other moieties can include -L^{A}-L^{A′}-X, in which L^{A} is or includes optionally substituted aromatic, optionally substituted arylene, optionally substituted heterocycle, or optionally substituted heterocyclyl (e.g., optionally substituted phenylene or optionally substituted aryleneoxy); L^{A′} is or includes optionally substituted aliphatic, optionally substituted alkylene, optionally substituted heteroaliphatic, or optionally substituted heteroalkylene (e.g., optionally substituted C₁₋₆ alkylene or optionally substituted C₁₋₆ heteroalkylene); and X is or includes an electroactive group

Yet other moieties can include -L^{A}-X, in which L^{A} is a covalent bond (including a spirocyclic bond), optionally substituted aliphatic, optionally substituted alkylene, optionally substituted heteroaliphatic, optionally substituted heteroalkylene, optionally substituted aromatic, optionally substituted arylene, optionally substituted heterocycle, or optionally substituted heterocyclyl (e.g., optionally substituted C₁₋₆ alkylene, optionally substituted C₁₋₆ heteroalkylene, optionally substituted phenylene, or optionally substituted aryleneoxy); and X is or includes an electroactive group.

### Arylene Groups

Particular moieties herein (e.g., monomeric units, linking moieties, and others) can include an optionally substituted arylene. Such arylene groups include any multivalent (e.g., bivalent, trivalent, tetravalent, etc.) groups having one or more aromatic groups, which can include heteroaromatic groups. Non-limiting aromatic groups can include any of the following:

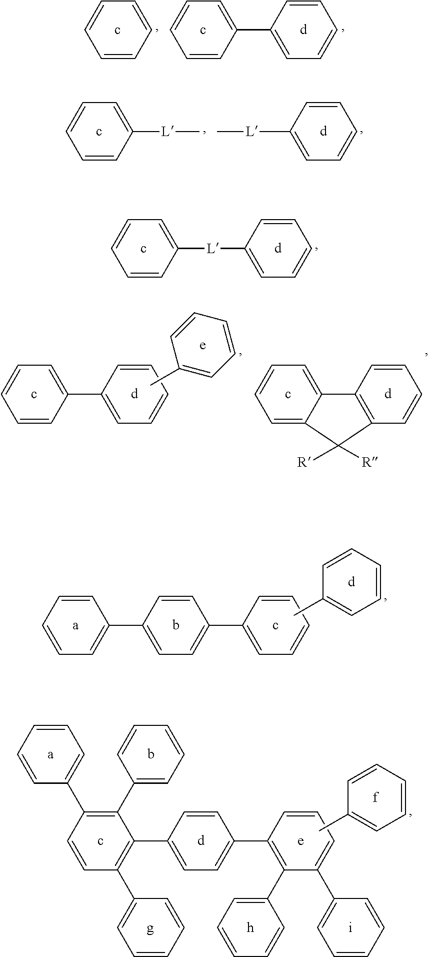

in which each of rings a-i can be optionally substituted (e.g., with any optional substituents described herein for alkyl or aryl; or with any electroactive moiety described herein); L′ is a linking moiety (e.g., any described herein); and each of R′ and R″ is, independently, H, optionally substituted alkyl, optionally substituted aryl, or an ionic moiety, as described herein. Non-limiting substituents for rings a-i include one or more described herein for aryl, such as alkyl, alkoxy, alkoxyalkyl, amino, aminoalkyl, aryl, arylalkylene, aryloyl, aryloxy, arylalkoxy, cyano, hydroxy, hydroxyalkyl, nitro, halo, and haloalkyl. In some embodiments, L′ is a covalent bond, —O—, —NR^{N1}—, —C(O)—, optionally substituted alkylene, optionally substituted heteroalkylene, or optionally substituted arylene.

Yet other non-limiting arylene can include phenylene (e.g., 1,4-phenylene, 1,3-phenylene, etc.), biphenylene (e.g., 4,4′-biphenylene, 3,3′-biphenylene, 3,4′-biphenylene, etc.), terphenylene (e.g., 4,4′-terphenylene), 9,10-anthracene, naphthalene (e.g., 1,5-naphthalene, 1,4-naphthalene, 2,6-naphthalene, 2,7-naphthalene, etc.), tetrafluorophenylene (e.g., 1,4-tetrafluorophenylene, 1,3-tetrafluorophenylene), and the like.

Non-limiting examples of linking moieties for arylene include any herein. In some embodiments, L′ is substituted one or more ionizable or ionic moieties described herein. In particular embodiments, L′ is optionally substituted alkylene. Non-limiting substitutions for L′ can include -L^{A}-X, in which L^{A} is a linking moiety (e.g., any described herein, such as, -Ak-, —O-Ak-, -Ak-O—, —Ar—, —O—Ar—, or —Ar—O—, in which Ak is optionally substituted alkylene and Ar is optionally substituted arylene), and X is an electroactive group.

### Linking Moieties

Particular chemical functionalities herein can include a linking moiety, either between the parent structure and another moiety (e.g., an ionic moiety) or between two (or more) other moieties. Linking moieties (e.g., L, L¹, L², L³, L⁴, L^{A}, L^{A′}, L^{A″}, L^{B′}, L^{B″}, L^{8A}, and others) can be any useful multivalent group, such as multivalent forms of optionally substituted aliphatic, optionally substituted heteroaliphatic, optionally substituted aromatic, or optionally substituted heteroaromatic.

Non-limiting linking moieties (e.g., L) include a covalent bond, a spirocyclic bond, —O—, —NR^{N1}—, —C(O)—, —C(O)—, —C(O)—, —SO₂—, optionally substituted alkylene, optionally substituted alkyleneoxy, optionally substituted haloalkylene, optionally substituted heteroalkylene, optionally substituted arylene, optionally substituted aryleneoxy, optionally substituted heterocyclyldiyl, —SO₂—NR^{N1}-Ak-, —(O-Ak)_{L1}-SO₂—NR^{N1}-Ak-, -Ak-, -Ak-(O-Ak)_{L1}-, —(O-Ak)_{L1}-, -(Ak-0)_{L1}-, —C(O)O-Ak-, —Ar—, or —Ar—O—, as well as combinations thereof. In particular embodiments, Ak is an optionally substituted aliphatic, optionally substituted alkylene, or optionally substituted haloalkylene; R^{N1} is H or optionally substituted alkyl or optionally substituted aryl; Ar is an optionally substituted aromatic or optionally substituted arylene; and L1 is an integer from 1 to 3.

In some embodiments, the linking moiety is —(CH₂)_{L1}—, —O(CH₂)_{L1}—, —(CF₂)_{L1}—, —O(CF₂)_{L1}—, or —S(CF₂)_{L1}— in which L1 is an integer from 1 to 3. In other embodiments, the linking moiety is -Ak-O—Ar-Ak-O-Ak- or -Ak-O—Ar—, in which Ak is optionally substituted alkylene or optionally substituted haloalkylene, and Ar is an optionally substituted arylene. Non-limiting substituted for Ar includes —SO₂-Ph, in which Ph can be unsubstituted or substituted with one or more halo.

### Methods of Making a Polymer

The present disclosure also encompasses methods of making electroactive polymers. One non-limiting reaction scheme is illustrated in Scheme 1 below. In this Scheme, each R may independently represent a cyano, halo, aliphatic (such as t-butyl), amino (such as dimethylamino) or an ester substituent. In some embodiments, all three R groups may be the same substituent. In some embodiments, two of the R groups may be the same substituent. In this Scheme, n is an integer of at least one.

However, other useful synthetic schemes may be employed to provide polymers having electroactive moieties.

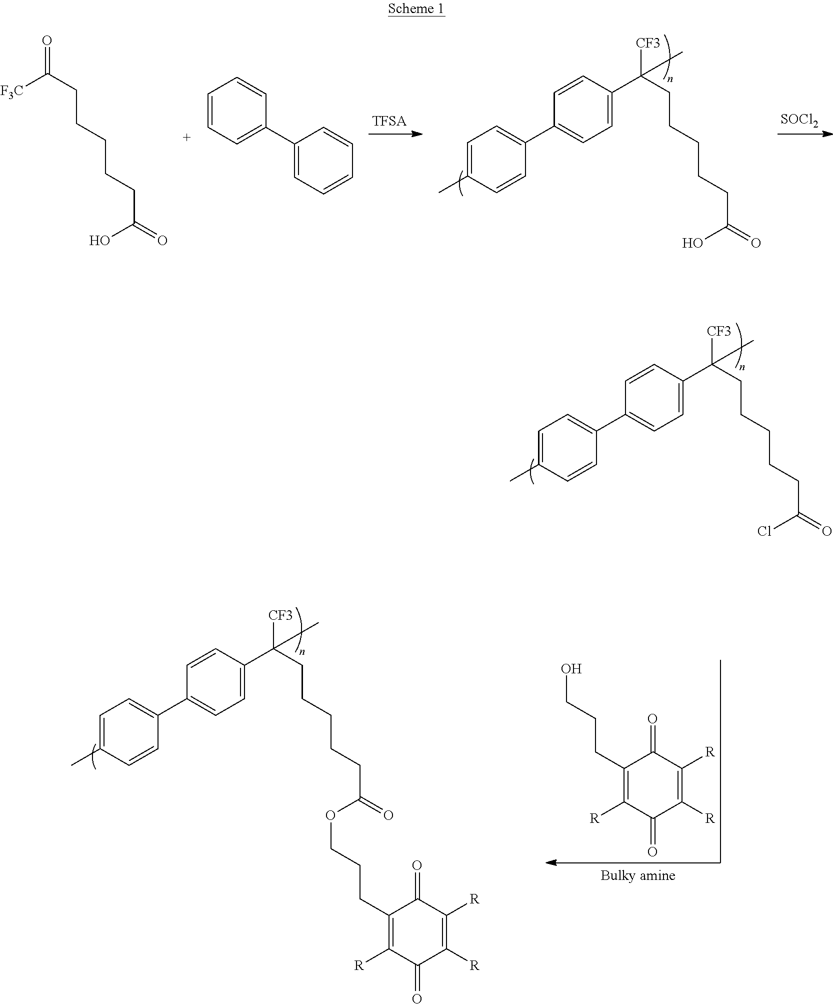

### Uses

The compositions herein can be employed to form a material, such as a film, a membrane (e.g., an ion exchange membrane), or a crosslinked polymeric matrix. The composition and material thereof can be employed within a device or apparatus, such as an electrochemical cell. In one embodiment, the electrochemical cell includes an anode, a cathode, and a polymer electrolyte membrane (PEM) disposed between the anode and the cathode. The PEM (or a component thereof) can include any composition or material described herein.

Systems Integrating CO₂ purifiers and CO₂ Electrolyzers

Some systems employ one or more CO₂ purifiers integrated with one or more CO₂ electrolyzers. As indicated, a CO₂ purifier may employ immobilized moieties that capture and release CO₂ in response to swings in electrical potential and/or current.

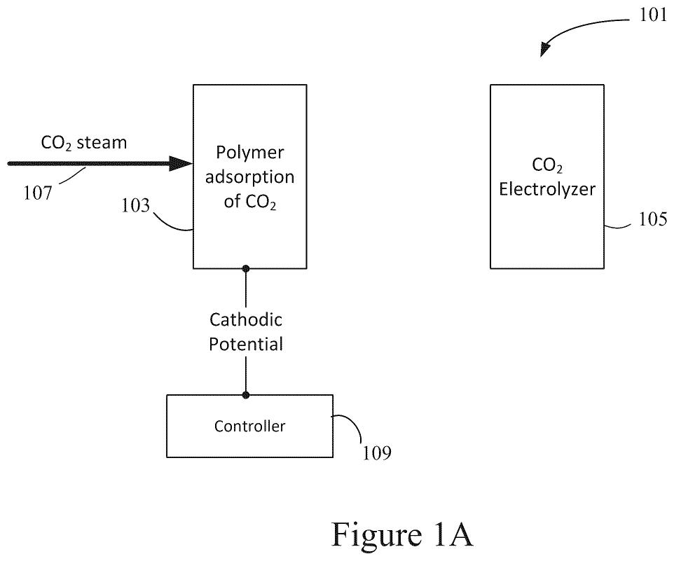

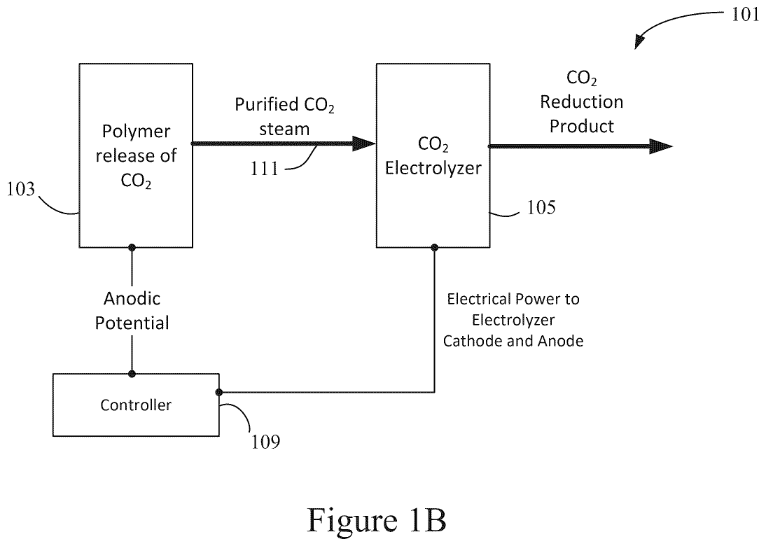

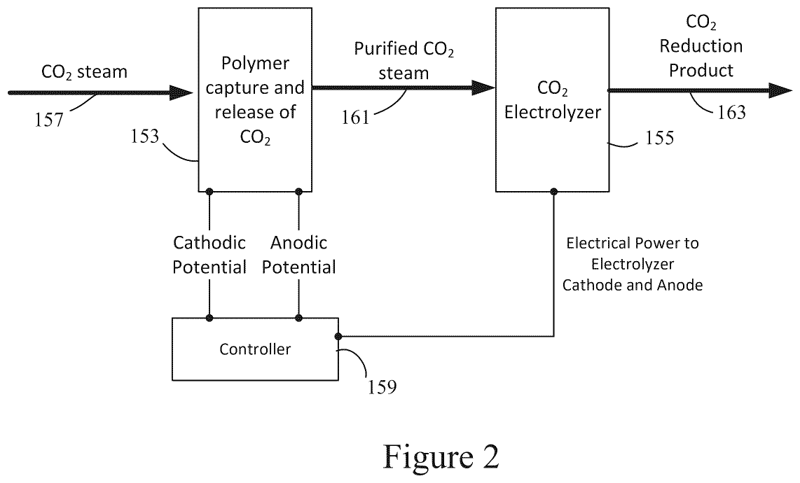

FIGS. 1A, 1B, and 2 depict embodiments that may be performed with a CO₂ purifier that employs a polymer comprising CO₂-binding electroactive moieties. As explained, these moieties may selectively react with carbon dioxide to form carbonate moieties when exposed to an electrochemical reducing environment and selectively release carbon dioxide when exposed to an electrochemical oxidizing environment.

As depicted in FIG. 1A, an integrated system 101 includes a CO₂ purifier 103 and a CO₂ electrolyzer 105. In FIG. 1A, integrated system 101 is in a CO₂ binding phase. As such, a cathodic potential or current is applied to an electrode in purifier 103, which electrode has immobilized CO₂-binding moieties. Thus, when carbon dioxide from a CO₂ stream 107 contacts the electrode in purifier 103, the carbon dioxide in the stream selectively reacts with the electroactive moieties. As a consequence, CO₂ is selectively removed from CO₂ stream 107. In some embodiments, these moieties are provided in a polymer such as those described herein.

As depicted, integrated system 101 includes a controller 109. In certain embodiments, controller 109 is configured to alternately provide cathodic and anodic potentials to the CO₂-binding electrode in CO₂ purifier 103.

In the CO₂ binding phase, electrolyzer 105 may sit idle. Although, this need not be the case because a separate CO₂ stream may be fed to the electrolyzer to allow the electrolyzer to make use of the time while the purifier 103 is removing CO₂ from stream 107.

As depicted in FIG. 1B, integrated system 101 is operating in a phase or mode where CO₂ is released from CO₂ purifier 103 and supplied to CO₂ electrolyzer 105, where it may be reduced to form a different carbon containing compounds such as carbon monoxide or ethylene.

In the CO₂ release mode, the CO₂-binding moieties in purifier 103 are exposed to an anodic potential that oxidizes the moieties to release the carbon dioxide. Because these moieties have not bound other components beside CO₂ in the inlet stream 107 (Not shown in FIG. 1B), the CO₂ released from the purifier has increased purity compared with the carbon dioxide in the inlet stream 107. As depicted in FIG. 1B, CO₂ released from purifier 103 is provided in a purified CO₂ stream 111 and provided to electrolyzer 105.

In a CO₂ release phase depicted in FIG. 1B, controller 109 applies an anodic potential or current to the electrode containing the CO₂-binding moieties in purifier 103 and may provide anodic and cathodic potentials to the anode and cathode of electrolyzer 105. It should be understood that while single controller is shown in FIG. 1B for controlling both purifier 103 and electrolyzer 105, the disclosure is not limited to this configuration. For example, a first controller may be employed to control electrolyzer 105 and a second controller may be used to control purifier 103.

FIG. 2 depicts an embodiment in which a CO₂ purifier 153 may operate continuously to provide purified carbon dioxide to a CO₂ electrolyzer 155. As an example, CO₂ purifier 153 may include multiple purifier cells, in which electrodes containing CO₂-binding moieties in first cells are held at an anodic potential while electrodes, also including the CO₂-binding moieties, in second cells are held in the cathodic potential. In this approach, the electrodes in the first cells release purified CO₂ while the electrodes in the second cells remove it from the stream.

Alternatively, the CO₂ inlet stream 157 may be sequentially directed between two purifiers, which are operating in opposite electrical polarities at any instant in time. In this manner, the CO₂ inlet stream 157 is always directed to one or more purifiers in which the CO₂-binding moieties are being held in the cathodic potential.

In the depicted embodiment, a controller 159 is configured to power both the CO₂ purifier 153 and the CO₂ electrolyzer 155. Also in the depicted embodiment, a purified CO₂ stream 161 flows continuously or intermittently from CO₂ purifier 153 to CO₂ electrolyzer 155. CO₂ electrolyzer 155 reduces the CO₂ it receives to form a carbon-containing reduction product in an output stream 163.

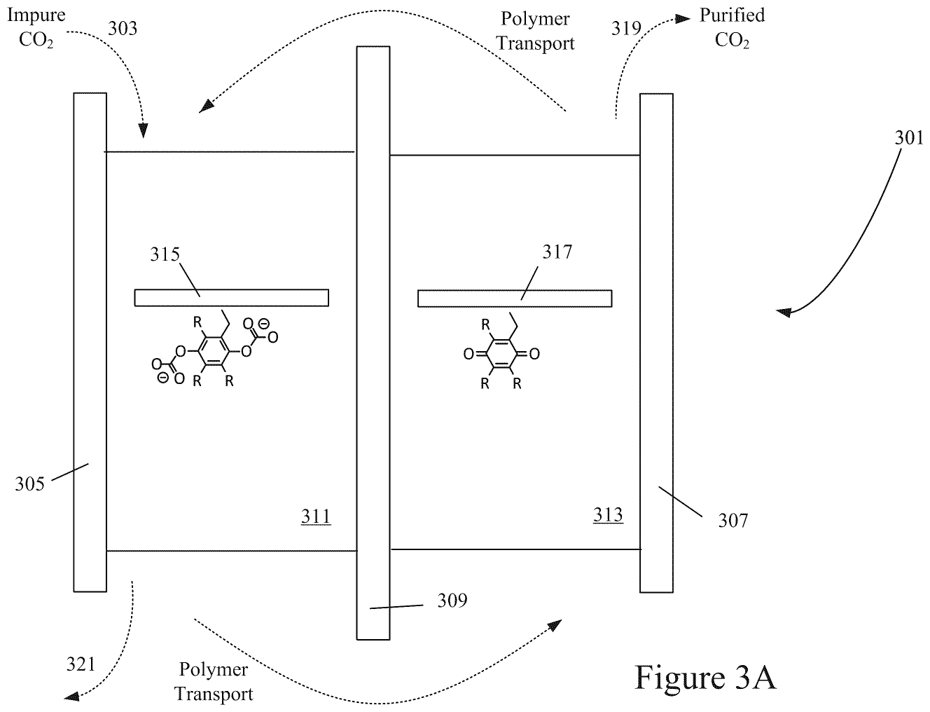

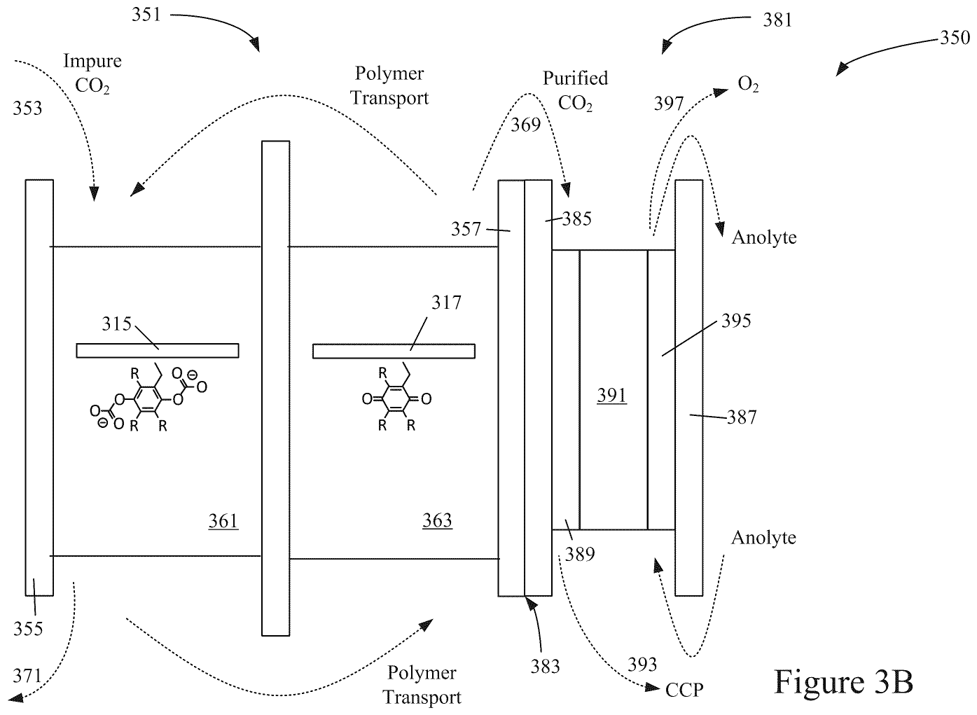

FIG. 3A presents an embodiment of a CO₂ purifier 301 configured for continuous purification of CO₂ from an impure input stream 303. The depicted CO₂ purifier includes a cathode 305, an anode 307, and an electronically insulating, ionically conducting separator 309. In this embodiment, separator 309 divides purifier 301 into a cathode compartment 311 and a cathode compartment 313. Both compartments contain a polymer with CO₂-absorbing electroactive moieties such as quinone moieties. The polymer undergoes a reduction reaction with CO₂ in cathode compartment 311 to produce carbonate moieties. The polymer undergoes an oxidation reaction in anode compartment 313 to convert carbonate moieties to free CO₂. The polymer having carbonate moieties is depicted as 315 and the polymer having quinone moieties is depicted as 317. Each R substituent on the quinone moiety depicted may independently represent a cyano, halo, aliphatic (such as t-butyl), amino (such as dimethylamino) or an ester substituent. In some embodiments, all three R groups may be the same substituent. In some embodiments, two of the R groups may be the same substituent.

This embodiment presents an example of a non-swing type purifier. Rather than swinging the potential an electrode during CO₂ purification, it employs a cathode that maintains a cathodic potential and an anode that maintains an anodic potential. Purified CO₂ may be continuously generated, rather than only during periods when previously charged CO₂-absorbing electroactive moieties are exposed to anodic conditions.

In operation, CO₂ purifier 301 receives impure CO₂ stream 303 via an inlet such as a conduit (not shown). In various embodiments, CO₂ stream 303 enters cathode compartment 311 where it contacts the polymer (with CO₂-absorbing electroactive moieties relatively free of absorbed CO₂) in proximity to cathode 305. The contact may take any of various forms such as by bubbling, countercurrent flow, etc. During contact between the CO₂ from stream 303 and the polymer in a cathodic environment, the polymer is converted to form 315. Unreacted CO₂ and other components of impure stream CO₂ 303 may exit purifier 301 as a waste gas stream 321 via a conduit or other outlet.

The polymer having CO₂-absorbing electroactive moieties flows or is otherwise transported between anode chamber 313 and cathode chamber 311. The polymer transport may be driven by any of various mechanisms such as by a pump and associated conduit(s). The polymer may be in a flowable state such as in a liquid state (e.g., as a melt or dissolved in a solvent).

Upon entry into cathode chamber 311, the polymer may be substantially or relatively free of CO₂ (e.g., polymer form 317). But while contacting the CO₂ in the input stream under cathodic conditions, the polymer absorbs or otherwise reacts with CO₂ to form a polymer in a form such as carbonate-containing polymer 315.

Polymer 315 containing absorbed CO₂ is transported from cathode chamber 311 to anode chamber 313 via any of various mechanisms such as by a pump and associated conduit(s).

Once in anode chamber 313, polymer 315 is exposed to anodic conditions, under which it releases CO₂ and reverts to form 317. The released CO₂ is purified in comparison to the impure CO₂ stream 303. The released CO₂ forms a purified CO₂ stream 319 that may exit the purifier via an outlet such as a conduit (not shown).

FIG. 3B presents an integrated system 350 that includes a continuous CO₂ purifier 351 electrically integrated with a CO₂ electrolyzer 381. The electrical integration is provided via a bipolar electrode 383 that provides an anodic surface 357 for CO₂ purifier 351 and a cathodic surface 385 for CO₂ electrolyzer 381. CO₂ Purifier 351 and CO₂ electrolyzer 381 of system 350 share a cathode 355 and an anode 387.

CO₂ purifier 351 functions similarly to purifier 301 depicted in FIG. 3A. A polymer comprising CO₂-absorbing electroactive moieties flows or is otherwise transported between anode chamber 363 and cathode chamber 361. Each R substituent on the quinone moiety depicted may independently represent a cyano, halo, aliphatic (such as t-butyl), amino (such as dimethylamino) or an ester substituent. In some embodiments, all three R groups may be the same substituent. In some embodiments, two of the R groups may be the same substituent.

In cathode chamber 361, under cathodic conditions, polymer in form 315 reacts with CO₂ from stream 353 to produce polymer in form 317 (with CO₂ reacted to form carbonate moieties). A waste gas stream 371 depleted of CO₂ by reaction with polymer form 315 may be eliminated from cathode chamber 361.

Polymer transported to anode chamber 363 is exposed to anodic conditions (due to the presence of anode surface 357), under which it reacts to release CO₂ a purified CO₂ stream 369.

On the electrolyzer side (381), purified CO₂ stream 369 enters a flow field, gas diffusion membrane 389 or the like to allow it to contact a cathode MEA 391 and produce a carbon containing product (CCP) 393, which exits system 351 via an electrolyzer cathode outlet such as a conduit (not shown).

Electrolyzer 381 also includes an anode contact element 395 (e.g., a solid porous structure) configured to receive a reactant such as water, an aqueous solution, or other anolyte that and contact it with an anode of MEA 391 where it is oxidized. Unreacted anolyte and an anolyte oxidation product (e.g., O₂) 397 exit electrolyzer 381 via one or more outlets.

While FIGS. 3A and 3B depict systems that use polymers having quinone moieties, the concepts depicted in these figures extend to embodiments that employ non-quinone CO₂-absorbing electroactive moieties such as thiolates, di-pyridinium species, and the like.

In addition to the CO₂ purifier and electrolyzer, an integrated system may include components for capturing, conveying, and/or storing impure CO₂ that is to be provided to the purifier. Similarly, any such components may be provided for purified CO₂ produced by the CO₂ purifier. Alternatively, or in addition, an integrated system may include components for capturing, conveying, and/or storing one or more outputs of a CO₂ electrolyzer.

In some embodiments, purified CO₂ produced by a CO₂ purifier is provided directly from an output of the purifier to an input of a CO₂ electrolyzer. In some embodiments, purified CO₂ produced by a CO₂ purifier is first provided to pressure adjusting component, a temperature adjusting component, and/or or a humidifier before it is provided as an input of a CO₂ electrolyzer. In some embodiments, purified CO₂ produced by a CO₂ purifier is first provided to storage vessel before it is provided as an input of a CO₂ electrolyzer. A “storage device” is a container or containment region that can hold a material such as purified CO₂, or mixture containing purified CO₂ and one or more other components. In some embodiments, a storage device is a vessel configured to hold a gas or liquid at a pressure higher than ambient or local pressure. A storage device may contain a metal or ceramic wall or chamber. In some embodiments, a storage device includes a natural or geological structure such as a salt dome or a depleted oil or gas field.

In some embodiments, an integrated system includes one or more components for using or converting CO₂ reduction products from the CO₂ electrolyzer. Such components may be employed downstream of the electrolyzer. Examples are presented in US Patent Application Publication No. 20220136119 filed Aug. 3, 2021, which is incorporated herein by reference in its entirety.

### CO₂ Sources

A carbon dioxide purifier may receive impure CO₂ that originates from any of various sources. Examples include air or other ambient gas, combustion output gases, and factory output such as output from a cement plant or a steelmaking plant. Combustion may occur in, for example, a turbine, engine, or other device that may be provided in stationary structure (e.g., a powerplant) or a mobile structure (e.g., a transportation vehicle). In certain embodiments, impure CO₂ is from tailpipe exhaust. Typically, though not necessarily, the CO₂ is provided to purifier in gaseous form.

A source of CO₂ may be connected directly to an input of a CO₂ purifier. In some embodiments, the carbon dioxide serves as the input to an electrode comprising CO₂-absorbing moieties via, e.g., a cathode flow field and/or gas diffusion layer, etc. In some embodiments, the CO₂ is provided to a purifier after being compressed by, e.g., a gas compression system. In some embodiments, CO₂ provided to a CO₂ purifier may be recycled from a chemical reaction of a carbon-containing product of the CO₂ electrolyzer.

The CO₂ provided as input to a carbon dioxide purifier integrated with a carbon dioxide electrolyzer may have a range of concentrations. In certain embodiments, carbon dioxide provided to a carbon dioxide purifier has a concentration of about 20% or less, or about 0.01% to about 70% by volume or molar. In certain embodiments, carbon dioxide provided to a carbon dioxide purifier has a concentration of about 0.04% to about 70% by volume or molar. The CO₂ provided as input to a CO₂ purifier integrated with a CO₂ electrolyzer may be or comprise air.

### CO₂ Purifiers

As explained, a CO₂ purifier may contain electroactive CO₂-absorbing moieties that capture CO₂ at a first potential and release it at a second potential. In various embodiments, the first potential is more cathodic than the second potential.

In certain embodiments, one or more electroactive CO₂-absorbing moieties are provided on a chemical compound. In certain embodiments, the one or more electroactive CO₂-absorbing moieties are provided on a polymer. In some cases, the one or more CO₂-absorbing moieties are pendant to a backbone of the polymer. In some cases, the one or more CO₂-absorbing moieties comprise quinone moieties.

The CO₂-absorbing moieties may be immobilized on or near an electrode. In such embodiments, the CO₂-absorbing moieties may be part of a polymer or part of a smaller molecule immobilized on or near the electrode. In some embodiments, the electrode and immobilized CO₂-absorbing moieties are all in the solid phase. Examples of solid phase CO₂ purifiers are presented in Voskian and Hatton, “Faradaic electro-swing reactive adsorption for CO₂ capture”; Energy and Environmental Science, 2019, 12, 3530, which is incorporated herein by reference in its entirety.

A polymer, such as one of those disclosed herein, comprising CO₂-absorbing moieties and immobilized on an electrode may comprise one or more additives to impart electronic and/or ionic conductivity. In some embodiments, a CO₂-absorbing polymer is mixed with electronically conductive particles such as carbon particles such as nanostructured carbon particles (e.g., nanotubes). In some embodiments, a CO₂-absorbing polymer is mixed with an ionically conducting polymer such as any of the polymers described in PCT Application No. PCT/US2021/055902 filed Oct. 20, 2021, which is incorporated herein by reference in its entirety. In some embodiments, the CO₂-absorbing polymer itself comprises positively charged groups (e.g., quaternary ammonium groups and/or certain heterocyclic nitrogen containing groups) and/or negatively charged groups (e.g., sulfonic acid groups). Such charged groups may facilitate conduction of ions within the CO₂-absorbing polymer.

The CO₂-absorbing moieties may be part of a transportable medium that moves between electrodes (e.g., between a cathode chamber and an anode chamber). Such embodiments may employ CO₂-absorbing moieties on a polymer. In some embodiments a polymer is in the form of a liquid. For example, the polymer be a melt or be dissolved in a solution. One example of a CO₂ purifier that employs a flowable polymer is illustrated in FIG. 3A.

FIG. 3A presents an embodiment of a CO₂ purifier 301 configured for continuous purification of CO₂ from an impure input stream 303. The depicted CO₂ purifier includes a cathode 305, an anode 307, and an electronically insulating, ionically conducting separator 309. In this embodiment, separator 309 divides purifier 301 into a cathode compartment 311 and a cathode compartment 313. Both compartments contain a polymer with CO₂ absorbing electroactive moieties such as quinone moieties. The polymer undergoes a reduction reaction with CO₂ in cathode compartment 311 to produce carbonate moieties. The polymer undergoes an oxidation reaction in anode compartment 313 to convert carbonate moieties to free CO₂. The polymer having carbonate moieties is depicted as 315 and the polymer having quinone moieties is depicted as 317.

This embodiment presents an example of a non-swing type purifier. Rather than swinging the potential an electrode during CO₂ purification, it employs a cathode that maintains a cathodic potential and an anode that maintains an anodic potential.

FIG. 3B presents a system 350 that includes a continuous CO₂ purifier 351 electrically integrated with a CO₂ electrolyzer 381. The electrical integration is provided via a bipolar electrode 383 that provides an anodic surface 357 for CO₂ purifier 351 and a cathodic surface 385 for CO₂ electrolyzer 381. CO₂ Purifier 351 and CO₂ electrolyzer 381 of system 350 share a cathode 355 and an anode 387.

### Output of Purifier

In certain embodiments, carbon dioxide output from a purifier and provided to a carbon dioxide electrolyzer has a concentration of at least about 20 volume or mole percent, or at least about 40 volume or mole percent, or at least about 75 volume or mole percent, or at least about 90 volume or mole percent. In certain embodiments, carbon dioxide provided to a carbon dioxide reduction reactor has a concentration of about 40 to 60 volume or mole percent.

### CO₂ Electrolyzer Outputs

A CO₂ purifier and electrolyzer integrated system may output one or more chemically reduced CO₂ products from the electrolyzer's cathode. Such outputs may include one or more carbon-containing products such as carbon monoxide, one or more hydrocarbons (e.g., methane, ethene, and/or ethane), one or more alcohols (e.g., methanol, ethanol, n-propanol, and/or ethylene glycol), one or more aldehydes (e.g., glycolaldehyde, acetaldehyde, glyoxal, and/or propionaldehyde), one or more ketones (e.g., acetone and/or hydroxyacetone), one or more carboxylic acids (e.g., formic acid and/or acetic acid), and any combination thereof. The electrolyzer's cathode may also produce H₂. A CO₂ purifier and electrolyzer integrated system may output one or more chemically oxidized H₂O products such as oxygen. Additional outputs of an electrolyzer may include unreacted CO₂ and/or unreacted H₂O.

A carbon dioxide electrolyzer of the disclosure may be directly connected (e.g., via the cathode flow field and/or gas diffusion layer) to a downstream system, and/or the carbon dioxide reactor output may be connected to a purification system; a gas compression system; or both a purification system and a gas compression system, in either order; which then optionally connect to an input of a downstream system and/or to one or more storage devices. Multiple purification systems and/or gas compression systems may be employed. In various embodiments, a carbon-containing product and/or oxygen produced by a carbon oxide electrolyzer is provided to a storage vessel for the carbon-containing product and/or a storage vessel for the oxygen.

A CO₂ electrolyzer integrated with a CO₂ purifier may be configured, designed, and/or controlled in a manner that allows the electrolyzer to produce one or more carbon dioxide electrolysis products in a quantity, concentration, and/or ratio suitable for any of various downstream processes such as producing valuable carbon-containing products such as plastics and/or producing fuels such as syngas or naphtha. In certain embodiments, a CO₂ electrolyzer is configured to produce a hydrocarbon such as methane or ethene which may be combusted and/or utilized by fuel-cell to generate electrical energy.

Different CO₂ electrolyzers (e.g., including different layer stacks, catalysts and/or catalyst layers, PEMs, flow fields, gas diffusion layers, cell compression configurations, and/or any other suitable aspects, etc.) can be used to produce different reduction products; however, different reduction products can additionally or alternatively be produced by adjusting the operation parameters, and/or be otherwise achieved.

An integrated CO₂ purifier and electrolyzer system may include a connection between a CO₂ containing output of a device such as an energy conversion device (e.g., a combustion turbine or fuel cell) and an input of a CO₂ electrolyzer. The CO₂ containing output of such device may be connected to a gas compression system and/or other system, which then connects to an input of a CO₂ purifier of the disclosure. Multiple CO₂ generating devices and/or gas compression systems may be connected to a CO₂ purifier. The carbon dioxide containing output may be stored in a storage vessel.

### CO₂ Electrolyzers

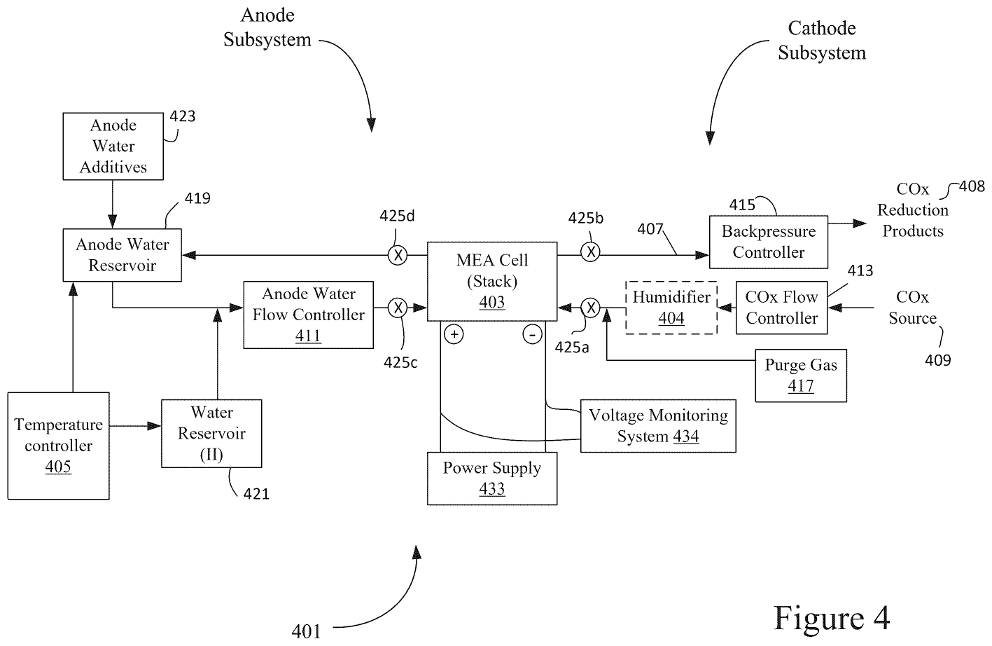

FIG. 4 depicts an example system 401 for a carbon oxide reduction reactor 403 (often referred to as an electrolyzer herein) that may include a cell comprising a MEA (membrane electrode assembly). The reactor may contain multiple cells or MEAs arranged in a stack. System 401 includes an anode subsystem that interfaces with an anode of reduction reactor 403 and a cathode subsystem that interfaces with a cathode of reduction reactor 403. System 401 is an example of a system that may be used with or to implement any of the methods or operating conditions described above.

As depicted, the cathode subsystem includes a carbon oxide source 409 configured to provide a feed stream of carbon oxide to the cathode of reduction reactor 403, which, during operation, may generate an output stream that includes product(s) of a reduction reaction at the cathode. The product stream may also include unreacted carbon oxide and/or hydrogen. See 408.

The carbon oxide source 409 is coupled to a carbon oxide flow controller 413 configured to control the volumetric or mass flow rate of carbon oxide to reduction reactor 403. One or more other components may be disposed on a flow path from flow carbon oxide source 409 to the cathode of reduction reactor 403. For example, an optional humidifier 404 may be provided on the path and configured to humidify the carbon oxide feed stream. Humidified carbon oxide may moisten one or more polymer layers of an MEA and thereby avoid drying such layers. Another component that may be disposed on the flow path is a purge gas inlet coupled to a purge gas source 417. In certain embodiments, purge gas source 417 is configured to provide purge gas during periods when current is paused to the cell(s) of reduction reactor 403. In some implementations, flowing a purge gas over an MEA cathode facilitates recovery of catalyst activity and/or selectivity. Examples of purge gases include carbon dioxide, carbon monoxide, hydrogen, nitrogen, argon, helium, oxygen, and mixtures of any two or more of these.

In various embodiments, a CO₂ purifier (not shown in FIG. 4) as described herein is provided upstream of source 409. Such CO₂ purifier may be considered to be part of the cathode subsystem.

During operation, the output stream from the cathode flows via a conduit 407 that connects to a backpressure controller 415 configured to maintain pressure at the cathode side of the cell within a defined range (e.g., about 50 to 800 psig, depending on the system configuration). The output stream may provide the reaction products 408 to one or more components (not shown) for separation and/or concentration.

In certain embodiments, the cathode subsystem is configured to controllably recycle unreacted carbon oxide from the outlet stream back to the cathode of reduction reactor 403. In some implementations, the output stream is processed to remove reduction product(s) and/or hydrogen before recycling the carbon oxide. Depending upon the MEA configuration and operating parameters, the reduction product(s) may be carbon monoxide, hydrogen, hydrocarbons such as methane and/or ethylene, oxygen-containing organic compounds such as formic acid, acetic acid, and any combinations thereof. In certain embodiments, one or more components, not shown, for removing water from the product stream are disposed downstream form the cathode outlet. Examples of such components include a phase separator configured to remove liquid water from the product gas stream and/or a condenser configured to cool the product stream gas and thereby provide a dry gas to, e.g., a downstream process when needed. In some implementations, recycled carbon oxide may mix with fresh carbon oxide from source 409 upstream of the cathode. Not shown in FIG. 4 are one or more optional separation components that may be provided on the path of the cathode outlet stream and configured to concentrate, separate, and/or store the reduction product from the reduction product stream.

As depicted in FIG. 4, an anode subsystem is configured to provide an anode feed stream to an anode side of the carbon oxide reduction reactor 403. In certain embodiments, the anode subsystem includes an anode water source, not shown, configured to provide fresh anode water to a recirculation loop that includes an anode water reservoir 419 and an anode water flow controller 411. The anode water flow controller 411 is configured to control the flow rate of anode water to or from the anode of reduction reactor 403. In the depicted embodiment, the anode water recirculation loop is coupled to components for adjusting the composition of the anode water. These may include a water reservoir 421 and/or an anode water additives source 423. Water reservoir 421 is configured to supply water having a composition that is different from that in anode water reservoir 419 (and circulating in the anode water recirculation loop). In one example, the water in water reservoir 421 is pure water that can dilute solutes or other components in the circulating anode water. Pure water may be conventional deionized water even ultrapure water having a resistivity of, e.g., at least about 15 MOhm-cm or over 18.0 MOhm-cm. Anode water additives source 423 is configured to supply solutes such as salts and/or other components to the circulating anode water.

During operation, the anode subsystem may provide water or other reactant to the anode of reactor 403, where it at least partially reacts to produce an oxidation product such as oxygen. The product along with unreacted anode feed material is provided in a reduction reactor outlet stream. Not shown in FIG. 4 are one or more optional separation components that may be provided on the path of the anode outlet stream and configured to concentrate, separate, and/or store the oxidation product from the anode product stream.

Other control features may be included in system 401. For example, a temperature controller may be configured to heat and/or cool the carbon oxide reduction reactor 403 at appropriate points during its operation. In the depicted embodiment, a temperature controller 405 is configured to heat and/or cool anode water provided to the anode water recirculation loop. For example, the temperature controller 405 may include or be coupled to a heater and/or cooler that may heat or cool water in anode water reservoir 419 and/or water in reservoir 421. In some embodiments, system 401 includes a temperature controller configured to directly heat and/or cool a component other than an anode water component. Examples of such other components in the cell or stack and the carbon oxide flowing to the cathode.

In certain embodiments, system 401 is configured to adjust the flow rate of carbon oxide to the cathode and/or the flow rate of anode feed material to the anode of reactor 403. Components that may be controlled for this purpose may include carbon oxide flow controller 413 and anode water controller 411.

Certain components of system 401 may operate to control the composition of the carbon oxide feed stream and/or the anode feed stream. For example, water reservoir 421 and/or anode water additives source 423 may be controlled to adjust the composition of the anode feed stream. In some cases, additives source 423 may be configured to adjust the concentration of one or more solutes such as one or more salts in an aqueous anode feed stream.

In some cases, a temperature controller such controller 405 is configured to adjust the temperature of one or more components of system 401 based on a phase of operation. For example, the temperature of cell 403 may be increased or decreased during break-in, a current pause in normal operation, and/or storage.

In some embodiments, a carbon oxide electrolytic reduction system is configured to facilitate removal of a reduction cell from other system components. This may be useful with the cell needs to be removed for storage, maintenance, refurbishment, etc. In the depicted embodiments, isolation valves 425a and 425b are configured to block fluidic communication of cell 403 to a source of carbon oxide to the cathode and backpressure controller 415, respectively. Additionally, isolation valves 425c and 425d are configured to block fluidic communication of cell 403 to anode water inlet and outlet, respectively.

The carbon oxide reduction reactor 403 may also operate under the control of one or more electrical power sources and associated controllers (block 433). Electrical power source and controller 433 may be programmed or otherwise configured to control current supplied to and/or to control voltage applied to the electrodes in reduction reactor 403. Any of the current profiles described herein may be programmed into power source and controller 433.

In certain embodiments, electric power source and controller 433 performs some but not all the operations necessary to implement control profiles of the carbon oxide reduction reactor 403. A system operator or other responsible individual may act in conjunction with electrical power source and controller 433 to fully define the schedules and/or profiles of current applied to reduction reactor 403. In certain embodiments, electric power source and controller 433 controls operation of a carbon oxide purifier disposed upstream of carbon oxide source 409.

In certain embodiments, the electrical power source and controller acts in concert with one or more other controllers or control mechanisms associated with other components of system 401. For example, electrical power source and controller 433 may act in concert with controllers for controlling the purification of carbon oxide, the delivery of carbon oxide to the cathode, the delivery of anode water to the anode, the addition of pure water or additives to the anode water, and any combination of these features. In some implementations, one or more controllers are configured to control or operate in concert to control any combination of the following functions: applying current and/or voltage to reduction cell 403, controlling backpressure (e.g., via backpressure controller 415), supplying purge gas (e.g., using purge gas component 417), delivering carbon oxide (e.g., via carbon oxide flow controller 413), humidifying carbon oxide in a cathode feed stream (e.g., via humidifier 404), flow of anode water to and/or from the anode (e.g., via anode water flow controller 411), and anode water composition (e.g., via anode water source 405, pure water reservoir 421, and/or anode water additives component 423).

In the depicted embodiment, a voltage monitoring system 434 is employed to determine the voltage across an anode and cathode of an MEA cell or across any two electrodes of a cell stack, e.g., determining the voltage across all cells in a multi-cell stack. In certain embodiments, voltage monitoring system 434 is configured to work in concert with power supply 433 to cause reduction cell 403 to remain within a specified voltage range. If, for example the cell's voltage deviates from a defined range (as determined by voltage monitoring system 434), power supply may be configured to apply current or voltage to the electrodes to maintain the cell voltage within the specified range.

An electrolytic carbon oxide reduction system such as that depicted in FIG. 4 may employ a control system that includes one or more controllers and one or more controllable components such as pumps, sensors, dispensers, valves, and power supplies. Examples of sensors include pressure sensors, temperature sensors, flow sensors, conductivity sensors, voltmeters, ammeters, electrolyte composition sensors including electrochemical instrumentation, chromatography systems, optical sensors such as absorbance measuring tools, and the like. Such sensors may be coupled to inlets and/or outlets of an MEA cell (e.g., in a flow field), in a reservoir for holding anode water, pure water, salt solution, etc., and/or other components of an electrolytic carbon oxide reduction system.

Among the various functions that may be controlled by one or more controllers are: applying current and/or voltage to a carbon oxide reduction cell, controlling backpressure on an outlet from a cathode on such cell, supplying purge gas to a cathode inlet, delivering carbon oxide to the cathode inlet, humidifying carbon oxide in a cathode feed stream, flowing anode water to and/or from the anode, and controller anode feed composition. Any one or more of these functions may have a dedicated controller for controlling its function alone. Any two or more of these functions may share a controller. In some embodiments, a hierarchy of controllers is employed, with at least one master controller providing instructions to two or more component controllers. For example, a system may comprise a master controller configured to provide high level control instructions to (i) a power supply to a carbon oxide reduction cell, (ii) a cathode feed stream flow controller, and (iii) an anode feed stream flow controller. For example, a programmable logic controller (PLC) may be used to control individual components of the system.

A controller may be integrated with electronics for controlling operation the electrolytic cell before, during, and after reducing a carbon oxide. The controller may control various components or subparts of one or multiple electrolytic carbon oxide reduction systems. The controller, depending on the processing requirements and/or the type of system, may be programmed to control any of the processes disclosed herein, such as delivery of gases, temperature settings (e.g., heating and/or cooling), pressure settings, power settings (e.g., electrical voltage and/or current delivered to electrodes of an MEA cell), liquid flow rate settings, fluid delivery settings, and dosing of purified water and/or salt solution. These controlled processes may be connected to or interfaced with one or more systems that work in concert with the electrolytic carbon oxide reduction system.

A controller may include any number of processors and/or memory devices. The controller may contain control logic such software or firmware and/or may execute instructions provided from another source. In various embodiments, a controller comprises electronics having various integrated circuits, logic, memory, and/or software that receive instructions, issue instructions, control operations described herein. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated to the controller in the form of various individual settings (or program files), defining operational parameters for carrying out a process on one or more components of an electrolytic carbon oxide reduction system. The operational parameters may, in some embodiments, be part of a recipe defined by process engineers to accomplish one or more processing steps during generation of a particular reduction product such as carbon monoxide, hydrocarbons, and/or other organic compounds.

The controller, in some implementations, may be a part of or coupled to a computer that is integrated with, coupled to the system, otherwise networked to the system, or a combination thereof. For example, the controller may utilize instructions stored remotely (e.g., in the “cloud”) and/or execute remotely. The computer may enable remote access to the system to monitor current progress of electrolysis operations, examine a history of past electrolysis operations, examine trends or performance metrics from a plurality of electrolysis operations, to change parameters of current processing, to set processing steps to follow a current processing, or to start a new process. In some examples, a remote computer (e.g., a server) can provide process recipes to a system over a network, which may include a local network or the internet. The remote computer may include a user interface that enables entry or programming of parameters and/or settings, which are then communicated to the system from the remote computer. In some examples, the controller receives instructions in the form of data, which specify parameters for each of the processing steps to be performed during one or more operations.

The controller may be distributed, such as by comprising one or more discrete controllers that are networked together and working towards a common purpose, such as applying current to an MEA cell and other process controls described herein. An example of a distributed control system for such purposes includes one or more processors on a system for electrolytically reducing a carbon oxide and one or more processors located remotely (such as at the platform level or as part of a remote computer) that combine to control a process.

Controllers and any of various associated computational elements including processors, memory, instructions, routines, models, or other components are sometimes described or claimed as “configured to” perform a task or tasks. In such contexts, the phrase “configured to” is used to denote structure by indicating that the component includes structure (e.g., stored instructions, circuitry, etc.) that performs a task or tasks during operation. As such, a controller and/or associated component can be said to be configured to perform the task even when the specified component is not necessarily currently operational (e.g., is not on).

Controllers and other components that are “configured to” perform an operation may be implemented as hardware—for example, circuits, memory storing program instructions executable to implement the operation, etc. Additionally, controllers and other components “configured to” perform an operation may be implemented as hardware that is manipulated by software and/or firmware (e.g., an FPGA or a general-purpose processor executing software) to operate in manner that is capable of performing the recited task(s). Additionally, “configured to” can refer to one or more memories or memory elements storing computer executable instructions for performing the recited task(s). Such memory elements may include memory on a computer chip having processing logic.

Non-computation elements such as reactors such electrolyzers, membrane assemblies, layers, and catalyst particles may also be “configured” to perform certain functions. In such contexts, the phrase “configured to” indicate that the referenced structure has one or more features that allow the function to be performed. Examples of such features include physical and/or chemical properties such as dimensions, composition, porosity, etc.

### MEA Embodiments

### MEA Overview

In various embodiments, an MEA contains an anode layer, a cathode layer, electrolyte, and optionally one or more other layers. The layers may be solids and/or gels. The layers may include polymers such as ion-conducting polymers.

When in use, the cathode of an MEA promotes electrochemical reduction of COₓ by combining three inputs: COₓ, ions (e.g., protons or hydroxide ions) that chemically react with COₓ, and electrons. The reduction reaction may produce CO, hydrocarbons, and/or hydrogen and oxygen-containing organic compounds such as methanol, ethanol, and acetic acid. When in use, the anode of an MEA promotes an electrochemical oxidation reaction such as electrolysis of water to produce elemental oxygen and protons. The cathode and anode may each contain catalysts to facilitate their respective reactions.

During operation of an MEA, ions move between an anode and a cathode, through one or more ion conducting layers, sometimes called a polymer-electrolyte, while electrons flow from the anode, through an external circuit, and to the cathode. In some embodiments, liquids and/or gas move through or permeates the MEA layers. This process may be facilitated by pores in the MEA.

The compositions and arrangements of layers in the MEA may promote high yield of a COₓ reduction products. To this end, the MEA may facilitate any one or more of the following conditions: (a) minimal parasitic reduction reactions (non-COₓ reduction reactions) at the cathode; (b) low loss of COₓ reactants to the anode or elsewhere in the MEA; (c) physical integrity of the MEA during the reaction (e.g., the MEA layers remain affixed to one another); (d) prevent COₓ reduction product cross-over; (e) prevent oxidation product (e.g., O₂) cross-over; (f) a suitable environment at the cathode for the reduction reaction; (g) a pathway for desired ions to travel between cathode and anode while blocking undesired ions; and (h) low voltage operation.

### COₓ Reduction Considerations

Polymer-based membrane assemblies such as MEAs have been used in various electrolytic systems such as water electrolyzers and in various galvanic systems such as fuel cells. However, COₓ reduction presents problems not encountered, or encountered to a lesser extent, in water electrolyzers and fuel cells.

For example, for many applications, an MEA for COₓ reduction requires a lifetime on the order of about 50,000 hours or longer (approximately five years of continuous operation), which is significantly longer than the expected lifespan of a fuel cell for automotive applications; e.g., on the order of 5,000 hours. And for various applications, an MEA for COₓ reduction employs electrodes having a relatively large surface area by comparison to MEAs used for fuel cells in automotive applications. For example, MEAs for COₓ reduction may employ electrodes having surface areas (without considering pores and other nonplanar features) of at least about 500 cm².

COₓ reduction reactions may be implemented in operating environments that facilitate mass transport of particular reactant and product species, as well as to suppress parasitic reactions. Fuel cell and water electrolyzer MEAs often cannot produce such operating environments. For example, such MEAs may promote undesirable parasitic reactions such as gaseous hydrogen evolution at the cathode and/or gaseous CO₂ production at the anode.

In some systems, the rate of a COₓ reduction reaction is limited by the availability of gaseous COₓ reactant at the cathode. By contrast, the rate of water electrolysis is not significantly limited by the availability of reactant: liquid water tends to be easily accessible to the cathode and anode, and electrolyzers can operate close to the highest current density possible.

### MEA Configurations

In certain embodiments, an MEA has a cathode layer, an anode layer, and a polymer electrolyte membrane (PEM) between the anode layer and the cathode layer. The polymer electrolyte membrane provides ionic communication between the anode layer and the cathode layer, while preventing electronic communication, which would produce a short circuit. The cathode layer includes a reduction catalyst and, optionally, an ion-conducting polymer (sometimes called an ionomer). The cathode layer may also include an electron conductor and/or an additional ion conductor. The anode layer includes an oxidation catalyst and, optionally, an ion-conducting polymer. The anode layer may also include an electron conductor and/or an additional ion conductor. The PEM also includes an ion-conducting polymer. In certain embodiments, the MEA has a cathode buffer layer between the cathode layer and the polymer electrolyte membrane. The cathode buffer also includes an ion-conducting polymer.

The ion-conducting polymers in the PEM, the cathode, the anode, and the cathode buffer layer, if present, may each be different from one another in composition, conductivity, molecular weight, or other property. In some cases, two or more of these polymers are identical. For example, the ion-conducting polymer in the cathode and cathode buffer layer may be identical.

In certain embodiments, the MEA has an anode buffer layer between the anode layer and the polymer electrolyte membrane. The anode buffer also includes an ion-conducting polymer, which may have the same properties as any of the other ion-conducting polymers (e.g., the ion-conducting polymer in the anode). Or, the ion-conducting layer of the anode may be different from every other ion-conducting layer in the MEA.

In connection with certain MEA designs, there are three available classes of ion-conducting polymers: anion-conductors, cation-conductors, and mixed cation-and-anion-conductors. In certain embodiments, at least two of the first, second, third, fourth, and fifth ion-conducting polymers are from different classes of ion-conducting polymers.

### Ion-Conducting Polymers for MEA Layers

The term “ion-conducting polymer” or “ionomer” is used herein to describe a polymer that conducts ions (anions and/or cations) is to say that the material is an ion-conducting material or ionomer. In certain embodiments, an MEA contains one or more ion-conducting polymers having a specific conductivity of about 1 mS/cm or greater for anions and/or cations. The term “anion-conductor” describes an ion-conducting polymer that conducts anions primarily (although there will still be some small amount of cation conduction) and has a transference number for anions greater than about 0.85 at around 100 micrometers thickness. The terms “cation-conductor” and/or “cation-conducting polymer” describe an ion-conducting polymer that conducts cations primarily (e.g., there can still be an incidental amount of anion conduction) and has a transference number for cations greater than approximately 0.85 at about 100 micrometers thickness. For an ion-conducting polymer that is described as conducting both anions and cations (a “cation-and-anion-conductor”), neither the anions nor the cations have a transference number greater than approximately 0.85 or less than approximately 0.15 at about 100 micrometers thickness. Examples of ion-conducting polymers of each class are provided in the below Table 1.

Ion-Conducting Polymers

| Class | Description | Common Features | Examples |
|---|---|---|---|
| A. | Greater than approximately | Positively charged | aminated tetramethyl |
| Anion- | 1 mS/cm specific conductivity | functional groups | polyphenylene; |
| conducting | for anions, which have a | are covalently | poly(ethylene-co- |
| | transference number greater | bound to the | tetrafluoroethylene)- |
| | than approximately 0.85 at | polymer backbone | based quaternary |
| | around 100 micron thickness | | ammonium polymer; |
| | | | quaternized polysulfone |
| B. | Greater than approximately | Salt is soluble | polyethylene oxide; |
| Conducts both | 1 mS/cm conductivity for | may be the | polyethylene glycol; |
| anions and | ions (including both cations | polymer and the | poly(vinylidene |
| cations | and anions), which have a | salt ions may | fluoride); polyurethane |
| | transference number | move through the | |
| | between approximately | polymer material | |
| | 0.15 and 0.85 at around | | |
| | 100 micron thickness | | |
| C. | Greater than approximately | Negatively | perfluorosulfonic acid |
| Cation- | 1 mS/cm specific conductivity | charged functional | polytetrafluoroethylene |
| conducting | for cations, which have a | groups are | co-polymer; |
| | transference number greater | covalently bound | sulfonated poly(ether |
| | than approximately 0.85 at | to the polymer | ketone); poly(styrene |
| | around 100 micron thickness | backbone | sulfonic acid-co- |
| | | | maleic acid) |

### Ionomer Structures

Examples of polymeric structures that can include an ionizable moiety or an ionic moiety and be used as ion-conducting polymers (ionomers) in the MEAs described here are provided below. The ion-conducting polymers may be used as appropriate in any of the MEA layers. Charge conduction through the material can be controlled by the type and amount of charge (e.g., anionic and/or cationic charge on the polymeric structure) provided by the ionizable/ionic moieties. In addition, the composition can include a polymer, a homopolymer, a copolymer, a block copolymer, a polymeric blend, other polymer-based forms, or other useful combinations of repeating monomeric units. As described below, an ion conducting polymer layer may include one or more of crosslinks, linking moieties, and arylene groups according to various embodiments. In some embodiments, two or more ion conducting polymers (e.g., in two or more ion conducting polymer layers of the MEA) may be crosslinked. Ionic groups that impart ionic conductivity may be provided in groups pendant to a polymer backbone and/or ionic groups may be provided in the polymer backbone itself.

Non-limiting monomeric units can include one or more of the following:

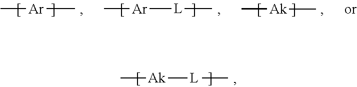

in which Ar is an optionally substituted arylene or aromatic; Ak is an optionally substituted alkylene, haloalkylene, aliphatic, heteroalkylene, or heteroaliphatic; and L is a linking moiety (e.g., any described herein) or can be —C(R⁷)(R′)—. Yet other non-limiting monomeric units can include optionally substituted arylene, aryleneoxy, alkylene, or combinations thereof, such as optionally substituted (aryl)(alkyl)ene (e.g., -Ak-Ar—or -Ak-Ar-Ak- or —Ar-Ak-, in which Ar is an optionally substituted arylene and Ak is an optionally substituted alkylene). One or more monomeric units can be optionally substituted with one or more ionizable or ionic moieties (e.g., as described herein).

One or more monomeric units can be combined to form a polymeric unit. Non-limiting polymeric units include any of the following:

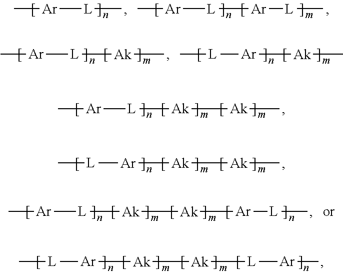

in which Ar, Ak, L, n, and m can be any described herein. In some embodiments, each m is independently 0 or an integer of 1 or more. In other embodiments, Ar can include two or more arylene or aromatic groups.

Other alternative configurations are also encompassed by the compositions herein, such as branched configurations, diblock copolymers, triblock copolymers, random or statistical copolymers, stereoblock copolymers, gradient copolymers, graft copolymers, and combinations of any blocks or regions described herein.

In some cases, alternative backbone structures are used with the electroactive moieties described herein. In some embodiments, the backbone does not include an aryl moiety. In some embodiments, the backbone does not include any aromatic moieties. In some embodiments, the backbone comprises only carbon-carbon linkages that are methylene and/or substituted methylene moieties. In some embodiments, the backbone comprises one or more styrene moieties. In an example, the backbone comprises styrene moieties, butylene moieties, and ethylene moieties, all linked via non-aromatic carbon-carbon bonds. Any of these moieties may be unsubstituted or substituted. In another example, the backbone comprises styrene moieties and conjugated or unconjugated heterocyclic groups all linked via non-aromatic carbon-carbon bonds. Any of these moieties may be unsubstituted or substituted. In all such examples, the polymer includes one or more types of pendant electroactive moiety as described herein. Further, in all examples, the polymer is optionally a copolymer. And, in all examples, the polymer is optionally crosslinked.

Examples of types of positively charged ionizable moieties include various nitrogen-containing groups and phosphonium groups. Nitrogen-containing positively charged groups may include quaternary ammonium groups, amines, guanidinium groups, and uronium groups. Some nitrogen-containing positively charged groups are present in heterocyclic ring structures. Such ring structures include both conjugated and non-conjugated heterocycles. Examples include imidazolium groups, pyridinium groups, and piperidinium groups. Examples of types of negatively charged ionizable moieties include sulfonic acid groups, acetic acid, triflourosulfonic groups, and triflouroacetic acid.

In one embodiment, the MW of the ion-conducting polymer is a weight-average molecular weight (MW) of at least 10,000 g/mol; or from about 5,000 to 2,500,000 g/mol. In another embodiment, the MW is a number average molecular weight (Mn) of at least 20,000 g/mol; or from about 2,000 to 2,500,000 g/mol.

In any embodiment herein, each of n, n1, n2, n3, n4, m, m1, m2, or m3 is, independently, 1 or more, 20 or more, 50 or more, 100 or more; as well as from 1 to 1,000,000, such as from 10 to 1,000,000, from 100 to 1,000,000, from 200 to 1,000,000, from 500 to 1,000,000, or from 1,000 to 1,000,000.

### Bipolar MEA for COₓ Reduction

In certain embodiments, the MEA includes a bipolar interface having an anion-conducting polymer on the cathode side of the MEA and an interfacing cation-conducting polymer on the anode side of the MEA. In some implementations, the cathode contains a first catalyst and an anion-conducting polymer. In certain embodiments, the anode contains a second catalyst and a cation-conducting polymer. In some implementations, a cathode buffer layer, located between the cathode and PEM, contains an anion-conducting polymer. In some embodiments, an anode buffer layer, located between the anode and PEM, contains a cation-conducting polymer.

In embodiments employing an anion-conducting polymer in the cathode and/or in a cathode buffer layer, the MEA can decrease or block unwanted reactions that produce undesired products and decrease the overall efficiency of the cell. In embodiments employing a cation-conducting polymer in the anode and/or in an anode buffer layer can decrease or block unwanted reactions that reduce desired product production and reduce the overall efficiency of the cell.

For example, at levels of electrical potential used for cathodic reduction of CO₂, hydrogen ions may be reduced to hydrogen gas. This is a parasitic reaction; current that could be used to reduce CO₂ is used instead to reduce hydrogen ions. Hydrogen ions may be produced by various oxidation reactions performed at the anode in a CO₂ reduction reactor and may move across the MEA and reach the cathode where they can be reduced to produce hydrogen gas. The extent to which this parasitic reaction can proceed is a function of the concentration of hydrogen ions present at the cathode. Therefore, an MEA may employ an anion-conducting material in the cathode layer and/or in a cathode buffer layer. The anion-conducting material at least partially blocks hydrogen ions from reaching catalytic sites on the cathode. As a result, parasitic production of hydrogen gas decreases and the rate of production of CO or other carbon-containing product increases.

Another reaction that may be avoided is reaction of carbonate or bicarbonate ions at the anode to produce CO₂. Aqueous carbonate or bicarbonate ions may be produced from CO₂ at the cathode. If such ions reach the anode, they may react with hydrogen ions to produce and release gaseous CO₂. The result is net movement of CO₂ from the cathode to the anode, where it does not get reduced and is lost with oxidation products. To prevent the carbonate and bicarbonate ion produced at the cathode from reaching the anode, the anode and/or an anode buffer layer may include a cation-conducting polymer, which at least partially blocks the transport of negative ions such as bicarbonate ions to the anode.

Thus, in some designs, a bipolar membrane structure raises the pH at the cathode to facilitate CO₂ reduction while a cation-conducting polymer such as a proton-exchange layer prevents the passage of significant amounts of CO₂ and CO₂ reduction products (e.g., bicarbonate) to the anode side of the cell.

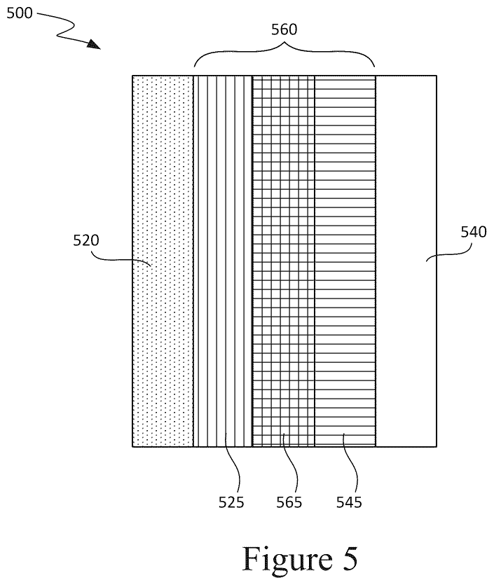

An example MEA 500 for use in COₓ reduction is shown in FIG. 5. The MEA 500 has a cathode layer 520 and an anode layer 540 separated by an ion-conducting polymer layer 560 that provides a path for ions to travel between the cathode layer 520 and the anode layer 540. In certain embodiments, the cathode layer 520 includes an anion-conducting polymer and/or the anode layer 540 includes a cation-conducting polymer. In certain embodiments, the cathode layer and/or the anode layer of the MEA are porous. The pores may facilitate gas and/or fluid transport and may increase the amount of catalyst surface area that is available for reaction.

The ion-conducting layer 560 may include two or three sublayers: a polymer electrolyte membrane (PEM) 565, an optional cathode buffer layer 525, and/or an optional anode buffer layer 545. One or more layers in the ion-conducting layer may be porous. In certain embodiments, at least one layer is nonporous so that reactants and products of the cathode cannot pass via gas and/or liquid transport to the anode and vice versa. In certain embodiments, the PEM layer 565 is nonporous. Example characteristics of anode buffer layers and cathode buffer layers are provided elsewhere herein. In certain embodiments, the ion-conducting layer includes only a single layer or two sublayers.

In some embodiments, a carbon oxide electrolyzer anode contains a blend of oxidation catalyst and an ion-conducting polymer. There are a variety of oxidation reactions that can occur at the anode depending on the reactant that is fed to the anode and the anode catalyst(s). In one arrangement, the oxidation catalyst is selected from the group consisting of metals and oxides of Ir, Pt, Ni, Ru, Pd, Au, and alloys thereof, IrRu, PtIr, Ni, NiFe, stainless steel, and combinations thereof. The oxidation catalyst can further contain conductive support particles such as carbon, boron-doped diamond, titanium, and any combination thereof.

As examples, the oxidation catalyst can be in the form of a structured mesh or can be in the form of particles. If the oxidation catalyst is in the form of particles, the particles can be supported by electronically conductive support particles. The conductive support particles can be nanoparticles. The conductive support particles may be compatible with the chemicals that are present in an electrolyzer anode when the electrolyzer is operating and are oxidatively stable so that they do not participate in any electrochemical reactions. It is especially useful if the conductive support particles are chosen with the voltage and the reactants at the anode in mind. In some arrangements, the conductive support particles are titanium, which is well-suited for high voltages. In other arrangements, the conductive support particles are carbon, which can be most useful at low voltages. In some embodiments, such conductive support particles are larger than the oxidation catalyst particles, and each conductive support particle can support one or more oxidation catalyst particles. In one arrangement, the oxidation catalyst is iridium ruthenium oxide. Examples of other materials that can be used for the oxidation catalyst include, but are not limited to, those listed above. It should be understood that many of these metal catalysts can be in the form of oxides, especially under reaction conditions.

As mentioned, in some embodiments, an anode layer of an MEA includes an ion-conducting polymer. In some cases, this polymer contains one or more covalently bound, negatively charged functional groups configured to transport mobile positively charged ions. Examples of the second ion-conducting polymer include ethanesulfonyl fluoride, 2-[1-[difluoro-[(trifluoroethenyl)oxy]methyl]-1,2,2,2-tetrafluoroethoxy]-1,1,2,2,-tetrafluoro-, with tetrafluoroethylene, tetrafluoroethylene-perfluoro-3,6-dioxa-4-methyl-7-octenesulfonic acid copolymer, other perfluorosulfonic acid polymers and blends thereof. Commercially available examples of cation-conducting polymers include e.g., Nafion 115, Nafion 117, and/or Nafion 211. Other examples of cationic conductive ionomers described above are suitable for use in anode layers.

There may be tradeoffs in choosing the amount of ion-conducting polymer in the anode. For example, an anode may include enough anode ion-conducting polymer to provide sufficient ionic conductivity, while being porous so that reactants and products can move through it easily. An anode may also be fabricated to maximize the amount of catalyst surface area that is available for reaction. In various arrangements, the ion-conducting polymer in the anode makes up about 10 and 90 wt %, or about 20 and 80 wt %, or about 25 and 70 wt % of the total anode mass. As an example, the ion-conducting polymer may make up about 5 and 20 wt % of the anode. In certain embodiments, the anode may be configured to tolerate relatively high voltages, such as voltages above about 1.2 V vs. a reversible hydrogen electrode. In some embodiments, an anode is porous in order to maximize the amount of catalyst surface area available for reaction and to facilitate gas and liquid transport.

In some embodiments, the MEA and/or the associated cathode layer is designed or configured to accommodate gas generated in situ. Such gas may be generated via various mechanisms. For example, carbon dioxide may be generated when carbonate or bicarbonate ions moving from the cathode toward the anode encounter hydrogen ions moving from the anode toward the cathode. This encounter may occur, for example, at the interface of anionic and cationic conductive ionomers in a bipolar MEA. Alternatively, or in addition, such contact may occur at the interface of a cathode layer and a polymer electrolyte membrane. For example, the polymer electrolyte membrane may contain a cationic conductive ionomer that allows transport of protons generated at the anode. The cathode layer may include an anion conductive ionomer.

Left unchecked, the generation of carbon dioxide or other gas may cause the MEA to delaminate or otherwise be damaged. It may also prevent a fraction of the reactant gas from being reduced at the anode.

The location within or adjacent to an MEA where a gas such as carbon dioxide is generated in situ may contain one or more structures designed to accommodate such gas and, optionally, prevent the gas from reaching the anode, where it would be otherwise unavailable to react.

In certain embodiments, pockets or voids are provided at a location where the gas is generated. These pockets or voids may have associated pathways that allow the generated gas to exit from the MEA, optionally to the cathode where, for example, carbon dioxide can be electrochemically reduced. In certain embodiments, an MEA includes discontinuities at an interface of anionic and cationic conductive ionomer layers such as at such interface in a bipolar MEA. In some embodiments, a cathode structure is constructed in a way that includes pores or voids that allow carbon dioxide generated at or proximate to the cathode to evacuate into the cathode.

In some embodiments, such discontinuities or void regions are prepared by fabricating in MEA in a way that separately fabricates anode and cathode structures, and then sandwiches to the two separately fabricated structures together in a way that produces the discontinuities or voids.

In some embodiments, and MEA structure is fabricated by depositing copper or other catalytic material onto a porous or fibrous matrix such as a fluorocarbon polymer and then coating the resulting structure with an anionic conductive ionomer. In some embodiments, the coated structure is then attached to the remaining MEA structure, which may include an anode and a polymer electrolyte membrane such as a cationic conductive membrane.

In some embodiments, a cathode has a porous structure and the/or an associated cathode buffer layer that has a porous structure. The pores may be present in an open cell format that allows generated carbon dioxide or other gas to find its way to the cathode.

In some MEAs, an interface between an anion conducting layer and a cation conducting layer (e.g., the interface of a cathode buffer layer and a PEM) includes a feature that resists delamination caused by carbon dioxide, water, or other material that may form at the interface. In some embodiments, the feature provides void space for the generated material to occupy until as it escapes from an MEA. In some examples, natural porosity of a layer such as an anion conducting layer provides the necessary void space. An interconnected network of pores may provide an escape route for carbon dioxide or other gas generated at the interface. In some embodiments, an MEA contains interlocking structures (physical or chemical) at the interface. In some embodiments, an MEA contains discontinuities at the interface. In some embodiments, an MEA contains of a fibrous structure in one layer adjacent the interface. A further discussion of interfacial structures between anion and cation conducting layers of MEAs is contained in Published PCT Application No. 2021/108446, published Jun. 3, 2021, and titled “MEMBRANE ELECTRODE ASSEMBLY FOR COₓ REDUCTION,” which is incorporated herein by reference in its entirety.

### Cathode Catalyst Layer

A function of the cathode catalyst layer is to provide a catalyst for COₓ reduction. An example reaction is:

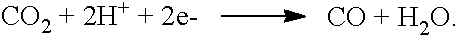

The cathode catalyst layer may also have other functions that facilitate COₓ conversion. These include water management, gas transport, reactant delivery to the metal catalyst, product removal, stabilizing the particulate structure of the metal catalyst, electronic and ionic conduction to the metal catalyst, and mechanical stability within the MEA.

Certain functions and challenges are particular to carbon oxide electrolyzers and are not found in MEA assemblies for other applications such as fuel cells or water electrolyzers. These challenges include that the cathode catalyst layer of the MEA transports gas (e.g., CO₂ or CO) in and gas (e.g., ethylene, methane, CO) or liquid (e.g., ethanol) out. The cathode catalyst layer may be designed or configured to prevent accumulation of water that can block gas transport. Further, catalysts for COₓ reduction are sometimes less stable than catalysts like platinum that can be used in hydrogen fuel cells. These functions, their particular challenges, and how they can be addressed are described below.

### Water Management (Cathode Catalyst Layer)

The cathode catalyst layer facilitates movement of water to prevent it from being trapped in the cathode catalyst layer. Trapped water can hinder access of COₓ to the catalyst and/or hinder movement of reaction product out of the cathode catalyst layer.

Water management challenges are in many respects unique to COₓ electrolyzers. For example, compared to a PEM fuel cell's oxygen electrode, a COₓ electrolyzer uses a much lower gas flow rate. A COₓ electrolyzer also may use a lower flow rate to achieve a high utilization of the input COₓ. Vapor phase water removal is determined by the volumetric gas flow, thus much less vapor phase water removal is carried out in a COₓ electrolyzer. A COₓ electrolyzer may also operate at higher pressure (e.g., 100 psi-450 psi) than a fuel cell; at higher pressure the same molar flow results in lower volumetric flow and lower vapor phase water removal. For some MEAs, the ability to remove vapor phase water is further limited by temperature limits not present in fuel cells. For example, CO₂ to CO reduction may be performed at about 50° C. and ethylene and methane production may be performed at 20° C.-25° C. This is compared to typical operating temperatures of 80° C. to 120° C. for fuel cells. As a result, there is even more liquid phase water to remove.

Properties that affect ability of the cathode catalyst layer to remove water include porosity; pore size; distribution of pore sizes; hydrophobicity; the relative amounts of ion conducting polymer, metal catalyst particles, and electronically-conductive support; the thickness of the layer; the distribution of the catalyst throughout the layer; and the distribution of the ion conducting polymer through the layer and around the catalyst.

A porous layer allows an egress path for water. In some embodiments, the cathode catalyst layer has a pore size distribution that includes some pores having sizes of about 1 nm-100 nm and other pores having sizes of at least about 1 micron. This size distribution can aid in water removal. The porous structures could be formed by one or more of: pores within the carbon supporting structures (e.g., support particles); stacking pores between stacked carbon nanoparticles; secondary stacking pores between agglomerated carbon spheres (micrometer scale); or inert filler (e.g., PTFE) introduced pores with the interface between the PTFE and carbon also creating irregular pores ranging from hundreds of nm to micrometers.

The thickness of cathode catalyst layer may contribute to water management. Using a thicker layer allows the catalyst and thus the reaction to be distributed in a larger volume. This spreads out the water distribution and makes it easier to manage. In certain embodiments, the cathode layer thickness is about 80 nm-300 μm.

Ion-conducting polymers having non-polar, hydrophobic backbones may be used in the cathode catalyst layer. In some embodiments, the cathode catalyst layer may include a hydrophobic polymer such as PTFE in addition to the ion-conducting polymer. In some embodiments, the ion-conducting polymer may be a component of a co-polymer that also includes a hydrophobic polymer. In some embodiments, the ion-conducting polymer has hydrophobic and hydrophilic regions. The hydrophilic regions can support water movement and the hydrophobic regions can support gas movement.

### Gas Transport (Cathode Catalyst Layer)

The cathode catalyst layer is structured for gas transport. Specifically, COₓ is transported to the catalyst and gas phase reaction products (e.g., CO, ethylene, methane, etc.) is transported out of the catalyst layer.

Certain challenges associated with gas transport are unique to COₓ electrolyzers. Gas is transported both in and out of the cathode catalyst layer—COₓ in and products such as CO, ethylene, and methane out. In a PEM fuel cell, gas (O₂ or H₂) is transported in but nothing or product water comes out. And in a PEM water electrolyzer, water is the reactant with O₂ and H₂ gas products.

Operating conditions including pressures, temperature, and flow rate through the reactor affect the gas transport. Properties of the cathode catalyst layer that affect gas transport include porosity; pore size and distribution; layer thickness; and ionomer distribution. Example values of these parameters are provided elsewhere herein.

In some embodiments, the ionomer-catalyst contact is minimized. For example, the ionomer may form a continuous network along the surface of the carbon with minimal contact with the catalyst. The ionomer, support, and catalyst may be designed such that the ionomer has a higher affinity for the support surface than the catalyst surface. This can facilitate gas transport to and from the catalyst without being blocked by the ionomer, while allowing the ionomer to conduct ions to and from the catalyst.

### Ionomer (Cathode Catalyst Layer)

The ionomer may have multiple functions including holding particles of the catalyst layer together and allowing movement of ions through the cathode catalyst layer. In some cases, the interaction of the ionomer and the catalyst surface may create an environment favorable for COₓ reduction, increasing selectivity to a desired product and/or decreasing the voltage required for the reaction. Importantly, the ionomer is an ion-conducting polymer that allows the movement of ions through the cathode catalyst layer. Hydroxide, bicarbonate, and carbonate ions, for example, are moved away from the catalyst surface where the COₓ reduction occurs.

In certain embodiments, an ion-conducting polymer of a cathode comprises at least one ion-conducting polymer that is an anion-conductor. This can be advantageous because it raises the pH compared to a proton conductor.

Various anion-conducting polymers are described above. Some of these have aryl groups in their backbones. Such ionomers may be used in cathode catalyst layers as described herein. In some embodiments, an ion-conducting polymer can comprise one or more covalently bound, positively charged functional groups configured to transport mobile negatively charged ions.

In some embodiments, an ion-conducting polymer in a cathode comprises at least one ion-conducting polymer that is a cation and an anion-conductor. Examples of such ion-conducting polymer include polyethers that can transport cations and anions and polyesters that can transport cations and anions. Further examples of such ion-conducting polymer include polyethylene oxide, polyethylene glycol, polyvinylidene fluoride, and polyurethane.

During use in an electrolyzer, a cation and anion conductor may raise the local pH (compared to a pure cation conductor.) Further, in some embodiments, it may be advantageous to use a cation and anion conductor to promote acid base recombination in a larger volume instead of at a 2D interface of anion-conducting polymer and cation conducting polymer. This can spread out water and CO₂ formation, heat generation, and potentially lower the resistance of the membrane by decreasing the barrier to the acid-base reaction. All of these may be advantageous in helping avoid the buildup of products, heat, and lowering resistive losses in the MEA leading to a lower cell voltage.

In certain embodiments, an anion-conducting polymer has a polymer backbone with covalently bound positively charged functional groups appended. These may include positively charged nitrogen groups in some embodiments. In some embodiments, the polymer backbone is non-polar, as described above. The polymer may have any appropriate molecular weight, e.g., 25,000 g/mol-150,000 g/mol, though it will be understood that polymers outside this range may be used.

According to various embodiments, the ion-conducting polymer may have a bicarbonate ionic conductivity of at least 6 mS/cm, or in some embodiments at least 12 mS/cm, is chemically and mechanically stable at temperatures 80° C. and lower, and soluble in organic solvents used during fabrication such as methanol, ethanol, and isopropanol. The ion-conducting polymer is stable (chemically and has stable solubility) in the presence of the COₓ reduction products. The ion-conducting polymer may also be characterized by its ion exchange capacity, the total of active sites or functional groups responsible for ion exchange, which may range from 2.1 mmol/g-2.6 mmol/g in some embodiments. In some embodiments, ion-conducting polymers having lower IECs such as greater than 1 or 1.5 mmol/g may be used.

Examples of anion-conducting polymers are given above in above table as Class A ion-conducting polymers.

The as-received polymer may be prepared by exchanging the anion (e.g., I—, Br—, etc.) with bicarbonate.

Also, as indicated above, in certain embodiments the ionomer may be a cation-and-anion-conducting polymer. Examples are given in the above table as Class B ion-conducting polymers.

There are tradeoffs in choosing the amount of ion-conducting polymer in the cathode. A cathode may include enough cathode ion-conducting polymer to provide sufficient ionic conductivity but be sufficiently porous so that reactants and products can move through it easily and to maximize the amount of catalyst surface area that is available for reaction. In various arrangements, the cathode ion-conducting polymer makes up about 10 to 90 wt %, about 20 to 80 wt %, or about 30 to 70 wt % of the material in the cathode layer.

### Metal Catalyst (Cathode Catalyst Layer)

In certain embodiments, metal catalysts have one or more of the properties presented above. In general, a metal catalyst catalyzes one or more COₓ reduction reactions. The metal catalyst may be in the form of nanoparticles, but larger particles, films, and nanostructured surfaces may be used in some embodiments. The specific morphology of the nanoparticles may expose and stabilize active sites that have greater activity.

Examples of materials that can be used for the reduction catalyst particles include, but are not limited, to transition metals such as V, Cr, Mn, Fe, Co, Ni, Cu, Zr, Nb, Mo, Au, Ru, Rh, Pd, Ag, Cd, Hf, Ta, W, Re, Ir, Pt, and Hg, and combinations thereof, and/or any other suitable materials. Other catalyst materials can include alkali metals, alkaline earth metals, lanthanides, actinides, and post transition metals, such as Sn, Si, Ga, Pb, Al, Tl, Sb, Te, Bi, Sm, Tb, Ce, Nd and In or combinations thereof, and/or any other suitable catalyst materials. The choice of catalyst depends on the reaction performed at the cathode of the COₓ electrolyzer.

The metal catalyst may be composed of pure metals (e.g., Cu, Au, Ag), but alloys or bimetallic systems may be used for certain reactions. In some embodiments, a metal catalyst comprises a dopant. Examples of dopants include boron, nitrogen, and hydrogen. In some cases, the metal catalyst comprises boron-doped copper. The concentration of dopant may be substantially uniform throughout the metal particle or it may vary as a function of distance from particle surface. For example, the dopant concentration may decrease with distance from the particle surface.

The choice of catalyst may be guided by the desired reaction. For example, for CO production, Au may be used; for methane and ethylene production, Cu may be used. CO₂ reduction has a high overpotential compared to other well-known electrochemical reactions such as hydrogen evolution and oxygen evolution on known catalysts. Small amounts of contaminants can poison catalysts for CO₂ conversion.

Different metal catalyst materials may be chosen at least in part based on the desired product and MEA operation. For example, the 1D nanowire may have a higher selectivity for ethylene production while triangular Cu nanoplates may have higher selectivity for methane. Nanocubes may show good selectivity for ethylene in an AEM MEA.

### Support (Cathode Catalyst Layer)

As explained above, support structures may be particles. But more generally, they may have many different shapes such as spheres, polygons (e.g., triangles), nanotubes, and sheets (e.g., graphene)). Structures having high surface area to volume are useful to provide sites for catalyst particles to attach. Support structures may also be characterized by their porosity, surface area per volume, electrical conductivity, functional groups (N-doped, O-doped, etc), and the like. Various characteristics of particulate support structures are presented above.

If present, a support of the cathode catalyst particles may have any of various functions. It may stabilize metal nanoparticles to prevent them from agglomerating and distribute the catalytic sites throughout the catalyst layer volume to spread out loss of reactants and formation of products. A support may also provide an electrically conductive pathway to metal nanoparticles. Carbon particles, for example, pack together such that contacting carbon particles provide the electrically conductive pathway. Void space between the particles forms a porous network that gas and liquids can travel through.

The support may be hydrophobic and have affinity to the metal nanoparticle.

In many cases, the conductive support particles are compatible with the chemicals that are present in the cathode during operation, are reductively stable, and have a high hydrogen production overpotential so that they do not participate in any electrochemical reactions. In certain embodiments, conductive support particles are larger than the reduction catalyst particles, and each conductive support particle can support many reduction catalyst particles.

Examples of carbon blacks that can be used include:
Vulcan XC-72R—Density of 256 mg/cm², 30-50 nm
Ketjen Black—Hollow structure, Density of 100-120 mg/cm², 30-50 nm
Printex Carbon, 20-30 nm

### Properties of the Cathode Catalyst Layer

In certain embodiments, a cathode layer has a porosity of about 15 to 75%. Porosity of the cathode layer may be determined by various techniques. In one method, the loading of each component (e.g., catalyst, support, and polymer) is multiplied by its respective density. These are added together to determine the thickness the components take up in the material. This is then divided by the total known thickness to obtain the percentage of the layer that is occupied by the material. The resulting percentage is then subtracted from 1 to obtain the percentage of the layer assumed to be void space (e.g., filled with air or other gas or a vacuum), which is the porosity. In some embodiments, porosity is determined directly by a method such as mercury porosimetry or image analysis of TEM images.

The cathode layer may also be characterized by its roughness. The surface characteristics of the cathode layer can impact the resistances across the membrane electrode assembly. Excessively rough cathode layers can potentially lead to interfacial gaps between the catalyst and a current collectors or other electronically conductive support layer such as a microporous layer. These gaps hinder electron transfer from the current collector to the catalytic area, thus, increasing contact resistances. Interfacial gaps may also serve as locations for water accumulation that is detrimental to mass transport of reactants and products. On the other hand, extremely smooth surfaces may suffer from poor adhesion between layers. Cathode layer roughness may influence electrical contact resistances and concentration polarization losses. Surface roughness can be measured using different techniques (e.g. mechanical stylus method, optical profilometry, or atomic force microscopy) and is defined as the high-frequency, short wavelength component of a real surface. Arithmetic mean height, Sa, is a parameter that is commonly used to evaluate the surface roughness. Numerically, it is calculated by integrating the absolute height of valleys and peaks on the surface relative to the mean plane over the entire geometric area of the sample. Cathode layer Sa values between 0.50-1.10 μm or 0.70-0.90 μm may be used in some embodiments.

Examples of cathode catalyst layer characteristics for CO, methane, and ethylene/ethanol productions:
CO production: Au nanoparticles 4 nm in diameter supported on Vulcan XC72R carbon and mixed with TM1 anion exchange polymer electrolyte from Orion. Layer is about 15 μm thick, Au/(Au+C)=30%, TM1 to catalyst mass ratio of 0.32, mass loading of 1.4-1.6 mg/cm², estimated porosity of 0.47
Methane production: Cu nanoparticles of 20-30 nm size supported on Vulcan XC72R carbon, mixed with FAA-3 anion exchange solid polymer electrolyte from Fumatech. FAA-3 to catalyst mass ratio of 0.18. Estimated Cu nanoparticle loading of ˜7.1 μg/cm², within a wider range of 1-100 μg/cm²
Ethylene/ethanol production: Cu nanoparticles of 25-80 nm size, mixed with FAA-3 anion exchange solid polymer electrolyte from Fumatech. FAA-3 to catalyst mass ratio of 0.10. Deposited either on Sigracet 39BC GDE for pure AEM or onto the polymer-electrolyte membrane. Estimated Cu nanoparticle loading of 270 μg/cm².
Bipolar MEA for methane production: The catalyst ink is made up of 20 nm Cu nanoparticles supported by Vulcan carbon (Premetek 40% Cu/Vulcan XC-72) mixed with FAA-3 anion exchange solid polymer electrolyte (Fumatech), FAA-3 to catalyst mass ratio of 0.18. The cathode is formed by the ultrasonic spray deposition of the catalyst ink onto a bipolar membrane including FAA-3 anion exchange solid polymer electrolyte spray-coated on Nafion (PFSA) 212 (Fuel Cell Etc) membrane. The anode is composed of IrRuOx which is spray-coated onto the opposite side of the bipolar membrane, at a loading of 3 mg/cm². A porous carbon gas diffusion layer (Sigracet 39BB) is sandwiched to the Cu catalyst-coated bipolar membrane to compose the MEA.
Bipolar MEA for ethylene production: The catalyst ink is made up of pure 80 nm Cu nanoparticles (Sigma Aldrich) mixed with FAA-3 anion exchange solid polymer electrolyte (Fumatech), FAA-3 to catalyst mass ratio of 0.09. The cathode is formed by the ultrasonic spray deposition of the catalyst ink onto a bipolar membrane including FAA-3 anion exchange solid polymer electrolyte spray-coated on Nafion (PFSA) 115 (Fuel Cell Etc) membrane. The anode is composed of IrRuOx which is spray-coated onto the opposite side of the bipolar membrane, at a loading of 3 mg/cm². A porous carbon gas diffusion layer (Sigracet 39BB) is sandwiched to the Cu catalyst-coated bipolar membrane to compose the MEA.
CO production: Au nanoparticles 4 nm in diameter supported on Vulcan XC72R carbon and mixed with TM1 anion exchange polymer electrolyte from Orion. Layer is about 14 micron thick, Au/(Au+C)=20%. TM1 to catalyst mass ratio of 0.32, mass loading of 1.4-1.6 mg/cm², estimated porosity of 0.54 in the catalyst layer.
CO production: Au nanoparticles 45 nm in diameter supported on Vulcan XC72R carbon and mixed with TM1 anion exchange polymer electrolyte from Orion. Layer is about 11 micron thick, Au/(Au+C)=60%. TM1 to catalyst mass ratio of 0.16, mass loading of 1.1-1.5 mg/cm², estimated porosity of 0.41 in the catalyst layer.
CO production: Au nanoparticles 4 nm in diameter supported on Vulcan XC72R carbon and mixed with TM1 anion exchange polymer electrolyte from Orion. Layer is about 25 micron thick, Au/(Au+C)=20%. TM1 to catalyst mass ratio of 0.32, mass loading of 1.4-1.6 mg/cm², estimated porosity of 0.54 in the catalyst layer.

### PEM

MEAs may include a polymer electrolyte membrane (PEM) disposed between and conductively coupled to the anode catalyst layer and the cathode catalyst layer. In certain embodiments, a polymer electrolyte membrane has high ionic conductivity (e.g., greater than about 1 mS/cm) and is mechanically stable. Mechanical stability can be evidenced in a variety of ways such as through high tensile strength, modulus of elasticity, elongation to break, and tear resistance. Many commercially available membranes can be used for the polymer electrolyte membrane. Examples include, but are not limited to, various Nafion® formulations, GORE-SELECT, FumaPEM® (PFSA) (FuMA-Tech GmbH), and Aquivion® (PFSA) (Solvay).

In one arrangement, the PEM comprises at least one ion-conducting polymer that is a cation-conductor. The third ion-conducting polymer can comprise one or more covalently-bound, negatively-charged functional groups configured to transport mobile positively-charged ions. The third ion-conducting polymer can be selected from the group consisting of ethanesulfonyl fluoride, 2-[1-[difluoro-[(trifluoroethenyl)oxy]methyl]-1,2,2,2-tetrafluoroethoxy]-1,1,2,2,-tetrafluoro-, with tetrafluoroethylene, tetrafluoroethylene-perfluoro-3,6-dioxa-4-methyl-7-octenesulfonic acid copolymer, other perfluorosulfonic acid polymers and blends thereof.

### Cathode Buffer Layer

When the polymer electrolyte membrane is a cation conductor (e.g., it conducts protons), it may contain a high concentration of protons during operation of the CRR, while a cathode may operate better when a low concentration of protons is present. A cathode buffer layer may be provided between the polymer electrolyte membrane and the cathode to provide a region of transition from a high concentration of protons to a low concentration of protons. In one arrangement, a cathode buffer layer is an ion-conducting polymer with many of the same properties as the ion-conducting polymer in the cathode. A cathode buffer layer may provide a region for the proton concentration to transition from a polymer electrolyte membrane, which has a high concentration of protons, to the cathode, which has a low proton concentration. Within the cathode buffer layer, protons from the polymer electrolyte membrane may encounter anions from the cathode, and they may neutralize one another. The cathode buffer layer may help ensure that a deleterious number of protons from the polymer electrolyte membrane does not reach the cathode and raise the proton concentration. If the proton concentration of the cathode is too high, COₓ reduction does not occur. A high proton concentration may be a concentration in the range of about 10 to 0.1 molar and low proton concentration may be a concentration of less than about 0.01 molar.

A cathode buffer layer can include a single polymer or multiple polymers. If the cathode buffer layer includes multiple polymers, the multiple polymers can be mixed together or can be arranged in separate, adjacent layers. Examples of materials that can be used for the cathode buffer layer include, but are not limited to, FumaSep FAA-3, Tokuyama anion exchange membrane material, and polyether-based polymers, such as polyethylene oxide (PEO), and blends thereof. Further examples are given above in the discussion of the cathode catalyst layer.

The thickness of the cathode buffer layer is chosen to be sufficient that COₓ reduction activity is high due to the proton concentration being low. This sufficiency can be different for different cathode buffer layer materials. In general, the thickness of the cathode buffer layer is between approximately 200 nm and 100 μm, between 300 nm and 75 μm, between 500 nm and 50 μm, or any suitable range.

In some embodiments, the cathode buffer layer is less than 50 μm, for example between 1-25 μm such between 1-5 μm, 5-15 μm, or 10-25 μm. By using a cathode buffer layer in this range of thicknesses, the proton concentration in the cathode can be reduced while maintaining the overall conductivity of the cell. In some embodiments, an ultra-thin layer (100 nm-1 μm and in some embodiments, sub-micron) may be used. And as discussed above, in some embodiments, the MEA does not have a cathode buffer layer. In some such embodiments, anion-conducting polymer in the cathode catalyst layer is sufficient. The thickness of the cathode buffer layer may be characterized relative to that of the PEM.

Water and CO₂ formed at the interface of a cathode buffer layer and a PEM can delaminate the MEA where the polymer layers connect. The delamination problem can be addressed by employing a cathode buffer layer having inert filler particles and associated pores. One possible explanation of its effectiveness is that the pores create paths for the gaseous carbon dioxide to escape back to the cathode where it can be reduced.

Materials that are suitable as inert filler particles include, but are not limited to, TiO₂, silica, PTFE, zirconia, and alumina. In various arrangements, the size of the inert filler particles is between 5 nm and 500 μm, between 10 nm and 100 μm, or any suitable size range. The particles may be generally spherical.

If PTFE (or other filler) volume is too high, it will dilute the polymer electrolyte to the point where ionic conductivity is low. Too much polymer electrolyte volume will dilute the PTFE to the point where it does not help with porosity. In many embodiments a mass ratio of polymer electrolyte/PTFE is 0.25 to 2, and more particularly, 0.5 to 1. A volume ratio polymer electrolyte/PTFE (or, more generally, polymer electrolyte/inert filler) may be 0.25 to 3, 0.5 to 2, 0.75 to 1.5, or 1.0 to 1.5.

In other arrangements, porosity is achieved by using particular processing methods when the layers are formed. One example of such a processing method is laser ablation, where nano to micro-sized channels are formed in the layers. Another example is mechanically puncturing a layer to form channels through it.

In one arrangement, the cathode buffer layer has a porosity between 0.01% and 95% (e.g., approximately between, by weight, by volume, by mass, etc.). However, in other arrangements, the cathode buffer layer can have any suitable porosity (e.g., between 0.01-95%, 0.1-95%, 0.01-75%, 1-95%, 1-90%). In some embodiments, the porosity is 50% or less, e.g., 0.1-50%, 5-50%, 20-50%, 5-40%, 10-40%, 20-40%, or 25%-40%. In some embodiments, the porosity is 20% or below, e.g. 0.1-20%, 1-10%, or 5-10%.

Porosity may be measured as described above with respect to the catalyst layer, including using mass loadings and thicknesses of the components, by methods such as mercury porosimetry, x-ray diffraction (SAXS or WAXS), and image processing on TEM images to calculate filled space vs. empty space. Porosity is measured when the MEA is completely dry as the materials swell to varying degrees when exposed to water during operation.

Porosity in layers of the MEA, including the cathode buffer layer, is described further below.

### Anode Buffer Layer

In some CRR reactions, bicarbonate is produced at the cathode. It can be useful if there is a polymer that blocks bicarbonate transport somewhere between the cathode and the anode, to prevent migration of bicarbonate away from the cathode. It can be that bicarbonate takes some CO₂ with it as it migrates, which decreases the amount of CO₂ available for reaction at the cathode. In some MEAs, the polymer electrolyte membrane includes a polymer that blocks bicarbonate transport. Examples of such polymers include, but are not limited to, Nafion® formulations, GORE-SELECT, FumaPEM® (PFSA) (FuMA-Tech GmbH), and Aquivion® (PFSA) (Solvay). In some MEAs, there is an anode buffer layer between the polymer electrolyte membrane and the anode, which blocks transport of bicarbonate. If the polymer electrolyte membrane is an anion-conductor, or does not block bicarbonate transport, then an additional anode buffer layer to prevent bicarbonate transport can be useful. Materials that can be used to block bicarbonate transport include, but are not limited to Nafion® formulations, GORE-SELECT, FumaPEM® (PFSA) (FuMA-Tech GmbH), and Aquivion® (PFSA) (Solvay). Of course, including a bicarbonate blocking feature in the ion-exchange layer is not particularly desirable if there is no bicarbonate in the CRR.

In certain embodiments, an anode buffer layer provides a region for proton concentration to transition between the polymer electrolyte membrane to the anode. The concentration of protons in the polymer electrolyte membrane depends both on its composition and the ion it is conducting. For example, a Nafion polymer electrolyte membrane conducting protons has a high proton concentration. A FumaSep FAA-3 polymer electrolyte membrane conducting hydroxide has a low proton concentration. For example, if the desired proton concentration at the anode is more than 3 orders of magnitude different from the polymer electrolyte membrane, then an anode buffer layer can be useful to affect the transition from the proton concentration of the polymer electrolyte membrane to the desired proton concentration of the anode. The anode buffer layer can include a single polymer or multiple polymers. If the anode buffer layer includes multiple polymers, the multiple polymers can be mixed together or can be arranged in separate, adjacent layers. Materials that can be useful in providing a region for the pH transition include, but are not limited to, Nafion, FumaSep FAA-3, Sustainion®, Tokuyama anion exchange polymer, and polyether-based polymers, such as polyethylene oxide (PEO), blends thereof, and/or any other suitable materials. High proton concentration is considered to be in the range of approximately 10 to 0.1 molar and low concentration is considered to be less than approximately 0.01 molar. Ion-conducting polymers can be placed in different classes based on the type(s) of ions they conduct. This has been discussed in more detail above. There are three classes of ion-conducting polymers described in Table 1 above. In one embodiment of the invention, at least one of the ion-conducting polymers in the cathode, anode, polymer electrolyte membrane, cathode buffer layer, and anode buffer layer is from a class that is different from at least one of the others.

### Layer Porosity

It can be useful if some or all of the following layers are porous: the cathode, the cathode buffer layer, the anode and the anode buffer layer. In some arrangements, porosity is achieved by combining inert filler particles with the polymers in these layers. Materials that are suitable as inert filler particles include, but are not limited to, TiO₂, silica, PTFE, zirconia, and alumina. In various arrangements, the size of the inert filler particles is between 5 nm and 500 μm, between 10 nm and 100 μm, or any suitable size range. In other arrangements, porosity is achieved by using particular processing methods when the layers are formed. One example of such a processing method is laser ablation, where nano to micro-sized channels are formed in the layers. Laser ablation can additionally or alternatively achieve porosity in a layer by subsurface ablation. Subsurface ablation can form voids within a layer, upon focusing the beam at a point within the layer, and thereby vaporizing the layer material in the vicinity of the point. This process can be repeated to form voids throughout the layer, and thereby achieving porosity in the layer. The volume of a void is preferably determined by the laser power (e.g., higher laser power corresponds to a greater void volume) but can additionally or alternatively be determined by the focal size of the beam, or any other suitable laser parameter. Another example is mechanically puncturing a layer to form channels through the layer. The porosity can have any suitable distribution in the layer (e.g., uniform, an increasing porosity gradient through the layer, a random porosity gradient, a decreasing porosity gradient through the layer, a periodic porosity, etc.).

The porosities (e.g., of the cathode buffer layer, of the anode buffer layer, of the membrane layer, of the cathode layer, of the anode layer, of other suitable layers, etc.) of the examples described above and other examples and variations preferably have a uniform distribution, but can additionally or alternatively have any suitable distribution (e.g., a randomized distribution, an increasing gradient of pore size through or across the layer, a decreasing gradient of pore size through or across the layer, etc.). The porosity can be formed by any suitable mechanism, such as inert filler particles (e.g., diamond particles, boron-doped diamond particles, polyvinylidene difluoride/PVDF particles, polytetrafluoroethylene/PTFE particles, etc.) and any other suitable mechanism for forming substantially non-reactive regions within a polymer layer. The inert filler particles can have any suitable size, such as a minimum of about 10 nanometers and a maximum of about 200 nanometers, and/or any other suitable dimension or distribution of dimensions.

As discussed above, the cathode buffer layer preferably has a porosity between about 1 and 90 percent by volume but can additionally or alternatively have any suitable porosity (including, e.g., no porosity). However, in other arrangements and examples, the cathode buffer layer can have any suitable porosity (e.g., between 0.01-95%, 0.1-95%, 0.01-75%, 1-95%, 1-90%, etc.). in some embodiments, the porosity is 20% or below, e.g., 0.1-20%, 1-10%, or 5-10%.

In some embodiments, the cathode buffer layer is porous but at least one layer between the cathode layer and the anode layer is nonporous. This can prevent the passage of gases and/or bulk liquid between the cathode and anode layers while still preventing delamination. For example, the nonporous layer can prevent the direct passage of water from the anode to the cathode.

### OTHER EMBODIMENTS AND CONCLUSION

Although omitted for conciseness, embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

1.-15. (canceled)

16. An electrochemical system, comprising:
an electrochemical cell, the electrochemical cell comprising:
an anode;
a cathode; and
a polymer electrolyte membrane disposed between the anode and the cathode,
wherein the polymer electrolyte membrane comprises a polymeric composition of at least one polymer,
wherein each polymer of the at least one polymer comprises a moiety of Formula (I), Formula (II), Formula (III), Formula (IV), or Formula (V): 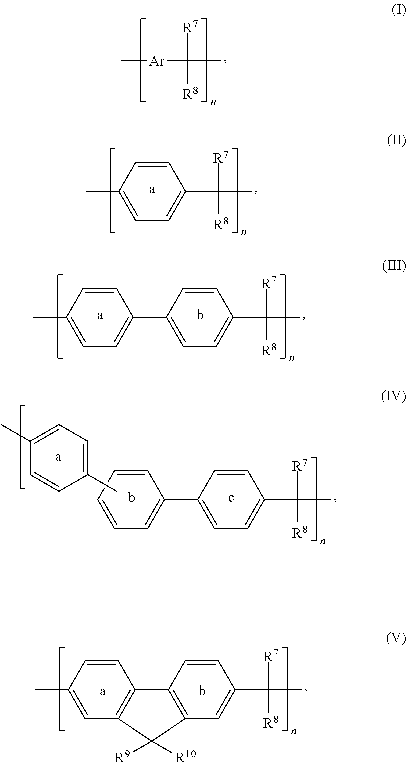
wherein each of R⁷ and R⁸ is independently an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, and
wherein at least one of R⁷ or R⁸ comprises the electron-withdrawing moiety;
each of R⁹ and R¹⁰ is independently H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R⁹ and R¹⁰ are taken together to form an optionally substituted cyclic group;
Ar is an optionally substituted aromatic or optionally substituted arylene;
n is an integer of 1 or more;
each of ring a, ring b, and ring c is independently optionally substituted; and
one or more of R⁷, R⁸, R⁹, and R¹⁰ comprises an electroactive moiety,
wherein the electroactive moiety comprises an electroactive group and one or more optional linking moieties,
wherein the electroactive group is a group that reversibly reacts with a Lewis acidic gas,
wherein the Lewis acidic gas comprises carbon dioxide, carbon monoxide, nitrogen dioxide, nitric oxide, sulfur dioxide, or sulfur trioxide, and
wherein the electroactive group comprises an optionally substituted quinonyl group, an optionally substituted dipyridyl group, or an optionally substituted thiolate group.

17. The electrochemical system of claim 16, wherein the electroactive group comprises the optionally substituted quinonyl group.

18. The electrochemical system of claim 17, wherein the optionally substituted quinonyl group comprises optionally substituted 1,4-benzoquinonyl, optionally substituted 1,2-benzoquinonyl, optionally substituted naphthoquinonyl, optionally substituted anthraquinonyl, optionally substituted phenanthrenequinonyl, optionally substituted benzanthraquinonyl, optionally substituted dibenzoanthraquinonyl, or optionally substituted 4,5,9,10-pyrenetetronyl.

19. The electrochemical system of claim 16, wherein the electroactive group comprises the optionally substituted dipyridyl group.

20. The electrochemical system of claim 19, wherein the optionally substituted dipyridyl group comprises 4,4′-dipyridinyl.

21. The electrochemical system of claim 16, wherein the electroactive group comprises the optionally substituted thiolate group.

22. The electrochemical system of claim 16,
wherein the electrochemical cell further comprises an inlet for receiving the Lewis acidic gas from an impure source of Lewis acidic gas and an outlet for outputting purified Lewis acidic gas, and
wherein the electrochemical system is configured to apply at least one of an electrical current and a voltage to the anode or the cathode of the electrochemical cell and cause the at least one polymer to reversibly react with the Lewis acidic gas from the impure source of Lewis acidic gas and release the purified Lewis acidic gas.

23. The electrochemical system of claim 16, wherein the Lewis acidic gas comprises carbon dioxide, and wherein the electrochemical cell is a CO₂ purifier comprising an inlet for receiving impure CO₂ and an outlet for outputting purified CO₂.

24. The electrochemical system of claim 23, further comprising a CO₂ electrolyzer coupled to the electrochemical cell, wherein the CO₂ electrolyzer is configured to receive the purified CO₂ from the electrochemical cell, and wherein the CO₂ electrolyzer comprises a cathode configured to electrochemically reduce CO₂ to produce a carbon-containing product.

25. The electrochemical system of claim 16, wherein the electrochemical system further comprises a controller configured to apply at least one of an electrical current and a voltage to the anode or the cathode of the electrochemical cell and cause the at least one polymer to reversibly react with the Lewis acidic gas from an impure source of Lewis acidic gas and release a purified Lewis acidic gas.

26. The electrochemical system of claim 25, wherein the Lewis acidic gas comprises carbon dioxide, and wherein the purified Lewis acidic gas is purified carbon dioxide.

27. The electrochemical system of claim 16, wherein the electron-withdrawing moiety is an optionally substituted haloalkyl, cyano, phosphate, sulfate, sulfonic acid, sulfonyl, difluoroboranyl, borono, or thiocyanato.

28. The electrochemical system of claim 16, wherein R⁷ is the electron-withdrawing moiety, and wherein R⁸ comprises the electroactive moiety.

29. The electrochemical system of claim 16, wherein the electroactive moiety comprises -L^{A}-X, -L^{A}-(L^{A′}-X)_{L2} or -L^{A}-L^{A′}-L^{A″}-X,
wherein each L^{A}, L^{A′}, and L^{A″} is independently the one or more optional linking moieties;
X comprises the electroactive group; and
L2 is an integer of 1, 2 or 3.

30. The electrochemical system of claim 16, wherein each linking moiety of the one or more optional linking moieties is independently selected from the group consisting of —O—, —SO₂—, —NH—, —C(O)—, —C(O)O—, —OC(O)—, optionally substituted alkyl, optionally substituted alkylene, optionally substituted haloalkylene, optionally substituted hydroxyalkylene, optionally substituted alkyleneoxy, optionally substituted heteroalkylene, optionally substituted arylene, optionally substituted aryleneoxy, and optionally substituted heterocyclyldiyl.

31. The electrochemical system of claim 16, wherein each Ar, ring a, ring b, and ring c are independently substituted with one or more substituents, and wherein each substituent of the one or more substituents is selected from the group consisting of alkyl, alkoxy, alkoxyalkyl, amino, aminoalkyl, aryl, arylalkylene, aryloyl, aryloxy, arylalkoxy, cyano, hydroxy, hydroxyalkyl, nitro, halo, and haloalkyl.

32. The electrochemical system of claim 16, wherein the at least one polymer comprises the moiety of Formula (III),
wherein ring a and ring b are each optionally substituted aryl,
R⁷ is trifluoromethyl,
n is an integer of 4 or more, and
R⁸ is the electroactive moiety, wherein the electroactive moiety comprises -L^{A}-L^{A′}-L^{A}-X, wherein each of L^{A} and L^{A′} is optionally substituted alkyl, L^{A′} is —C(O)O—, X is the electroactive group, and, wherein the electroactive group is optionally substituted 1,4-benzoquinonyl.

33. An electrochemical method, comprising:
(a) providing the electrochemical system of claim 23;
(b) passing the Lewis acidic gas through the electrochemical cell whereby the carbon dioxide is captured by the polymer electrolyte membrane when the polymer electrolyte membrane is exposed to at least one of a electrical current and a voltage; and
(c) releasing purified carbon dioxide from the polymer electrolyte membrane.

34. A polymeric composition, comprising:
at least one polymer, wherein each polymer of the at least one polymer comprises a moiety of Formula (I), Formula (II), Formula (III), Formula (IV), or Formula (V): 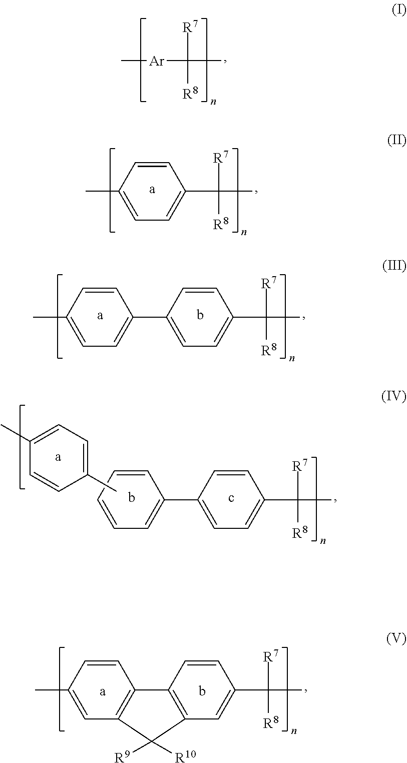
wherein each of R⁷ and R⁸ is independently an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, and
wherein at least one of R⁷ or R⁸ comprises the electron-withdrawing moiety;
each of R⁹ and R¹⁰ is independently H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R⁹ and R¹⁰ are taken together to form an optionally substituted cyclic group;
Ar is an optionally substituted aromatic or optionally substituted arylene;
n is an integer of 1 or more;
each of ring a, ring b, and ring c is independently optionally substituted; and
one or more of R⁷, R⁸, R⁹, and R¹⁰ comprises an electroactive moiety,
wherein the electroactive moiety comprises an electroactive group and one or more optional linking moieties,
wherein the electroactive group is a group that reversibly reacts with a Lewis acidic gas,
wherein the Lewis acidic gas comprises carbon dioxide, carbon monoxide, nitrogen dioxide, nitric oxide, sulfur dioxide, or sulfur trioxide, and
wherein the electroactive group comprise an optionally substituted quinonyl group, an optionally substituted dipyridyl group, or an optionally substituted thiolate group.

35. The polymeric composition of claim 34, wherein the polymeric composition forms a part of a polymer electrolyte membrane of an electrochemical cell.
